(19) United States
(12) Patent Application Publication
(10) Pub. No.: US 2026/0062995 A1
(43) Pub. Date: Mar. 5, 2026

(54) SOLAR-POWERED MOTORIZED WINDOW TREATMENT

(71) Applicant: Lutron Technology Company LLC, Coopersburg, PA (US)

(72) Inventors: Edward J. Blair, Telford, PA (US); John H. Bull, Slatington, PA (US); Stuart W. DeJonge, Riegelsville, PA (US); Jeremy M. Fallis, JR., Bethlehem, PA (US); Charles Fiebig, Frenchtown, NJ (US); David A. Kirby, Zionsville, PA (US); Galen Edgar Knode, Macungie, PA (US); Brent Protzman, Easton, PA (US); William Taylor Shivell, Breinigsville, PA (US)

(73) Assignee: Lutron Technology Company LLC, Coopersburg, PA (US)

(21) Appl. No.: 19/319,519

(22) Filed: Sep. 4, 2025

Related U.S. Application Data
(60) Provisional application No. 63/690,698, filed on Sep. 4, 2024.
(60) Provisional application No. 63/693,644, filed on Sep. 11, 2024.

(51) Int. Cl. E06B 9/72; E06B 9/24; E06B 9/42

(52) U.S. Cl. CPC E06B 9/72; E06B 9/42; E06B 2009/2476

(57) ABSTRACT

A motorized window treatment may include first and second mounting brackets and a window treatment assembly that includes a covering material and a bottom bar attached to the bottom end of the covering material. The bottom bar may include at least one solar cell attached to the bottom bar and a first energy storage element electrically coupled to the solar cell. The motorized window treatment may include a dock configured to be electrically coupled to a motor drive unit of the window treatment assembly, and the dock may be supported by the first mounting bracket. The bottom bar may be configured to be positioned adjacent to the dock when the covering material is in a raised position, such that the first energy storage element of the bottom bar is configured to discharge through the dock into a second energy storage element of the motor drive unit.

### CROSS-REFERENCE TO RELATED APPLICATIONS

This application claims the benefit of Provisional U.S. Patent Application No. 63/690,698, filed Sep. 4, 2024, and Provisional U.S. Patent Application No. 63/693,644, filed Sep. 11, 2024, the entire disclosures of which are hereby incorporated by reference herein in their entireties.

### BACKGROUND

A user environment, such as a residence or an office building for example, may be configured using various types of load control systems. A lighting control system may be used to control the lighting loads in the user environment. A motorized window treatment control system may be used to control the natural light provided to the user environment. A heating, ventilation, and cooling (HVAC) system may be used to control the temperature in the user environment. Each load control system may include various control devices, including control-source devices and control-target devices. The control-target devices may receive messages (e.g., digital messages), which may include load control instructions, for controlling an electrical load from one or more of the control-source devices. The control-target devices may be capable of directly controlling an electrical load. The control-source devices may be capable of indirectly controlling the electrical load via the control-target device. Examples of control-target devices may include lighting control devices (e.g., a dimmer switch, an electronic switch, a ballast, or a light-emitting diode (LED) driver), a motorized window treatment, a temperature control device (e.g., a thermostat), a plug-in load control device, and/or the like. Examples of control-source devices may include remote control devices, occupancy sensors, daylight sensors, temperature sensors, and/or the like.

A window treatment may be mounted in front of one or more windows, for example to prevent sunlight from entering a space and/or to provide privacy. Window treatments may include, for example, roller shades, roman shades, venetian blinds, or draperies. A roller shade may include a flexible shade fabric wound onto an elongated roller tube. Such a roller shade may include a weighted hembar located at a lower end of the shade fabric. The hembar may cause the shade fabric to hang in front of one or more windows over which the roller shade is mounted.

A window treatment may be mounted to a structure surrounding a window, such as a window frame. Such a window treatment may include at least one bracket, for example two brackets at opposed ends thereof. The brackets may be configured to operably support a roller tube, such that the flexible material may be raised and lowered. For example, the brackets may be configured to support respective ends of the roller tube. The brackets may be attached to a structure, such as a wall, ceiling, window frame, or other structure. Such a window treatment may be motorized.

### SUMMARY

As described herein, a motorized window treatment that configured to be mounted to a structure in front of an opening, such as a window, may be powered from (e.g., entirely powered from) solar energy. The motorized window treatment may be mounted to a structure. The motorized window treatment may include first and second mounting brackets configured to be mounted to the structure. The motorized window treatment may include a window treatment assembly supported by the first and second mounting brackets. The window treatment assembly may include a covering material that extends from a top end to a bottom end and is operable between a raised position and a lowered position. The window treatment assembly may include a bottom bar attached to the bottom end of the covering material. The bottom bar may include at least one solar cell attached to the bottom bar and a first energy storage element electrically coupled to the solar cell. The motorized window treatment may include a motor drive unit comprising a motor configured to adjust (e.g., rotate) the covering material between the raised position and the lowered position. The motorized window treatment may include a dock configured to be electrically coupled to the motor drive unit, the dock supported by the first mounting bracket. The bottom bar may be configured to be positioned adjacent to the dock when the covering material is in the raised position, such that the first energy storage element of the bottom bar is configured to discharge through the dock into a second energy storage element of the motor drive unit.

The first mounting bracket may include two or more electrical contacts configured to electrically connect the motor drive unit to the dock. The first mounting bracket may include the dock (e.g., the dock may be integral with the first mounting bracket). The dock may include first and second electrical contacts and the bottom bar comprises first and second electrical contacts, the first and second electrical contacts of the dock configured to be electrically connected to the first and second electrical contacts of the bottom bar, respectively, when the covering material is in the raised position. For example, the motor drive unit may include first and second electrical contacts, wherein the first and second electrical contacts of the dock each comprises a respective first end comprising a hook and a respective second end comprising a clip, and the hook of the first electrical contact of the dock may be configured to be electrically connected to the first electrical contact of the bottom bar when the covering material is in the raised position, and the hook of the second electrical contact of the dock may be configured to be electrically connected to the second electrical contact of the bottom bar when the covering material is in the raised position. Further, the first clip of the first electrical contact of the dock may be configured to be electrically connected to the first electrical contact of the motor drive unit, and the second clip of the second electrical contact of the dock may be configured to be electrically connected to the second electrical contact of the motor drive unit. The motor drive unit may include a printed circuit board comprising the first and second electrical contacts. The first electrical contact may include a first electrical pad and the second electrical contact may include a second electrical pad, and where the first clip of the first electrical contact of the dock is configured to be electrically connected to the first electrical pad of the motor drive unit, and the second clip of the second electrical contact of the dock is configured to be electrically connected to the second electrical pad of the motor drive unit.

The dock may include a first and second electrical contacts and the bottom bar may include an end cap that includes a first and second electrical contacts that are electrically connected to the first energy storage element. The first and second electrical contacts of the dock may be configured to be electrically connected to the first and second electrical contacts of the bottom bar when the covering material is in the raised position. The end cap may include an inner edge and an outer edge, where the first electrical contact of the of the end cap extends at least partially around the inner edge of the end cap and the second electrical contact of the end cap extends at least partially around the outer edge of the end cap. For example, the inner edge of the end cap and the outer edge of the end cap may remain exposed outside of a housing of the end cap when the end cap is installed at a first end of the bottom bar. The motor drive unit may include first and second electrical contacts, where the first and second electrical contacts of the dock each comprises a respective first end comprising a hook and a respective second end comprising a clip. The hook of the first electrical contact of the dock may be configured to be electrically connected to the first electrical contact of the bottom bar when the covering material is in the raised position, and the hook of the second electrical contact of the dock may be configured to be electrically connected to the second electrical contact of the bottom bar when the covering material is in the raised position.

The bottom bar may include a pocket. The dock may include a base portion that is configured to be disposed in the pocket and to be electrically coupled to the bottom bar when disposed in the pocket. In some examples, the base portion may be situation perpendicular (e.g., substantially perpendicular) to the arm. In some examples, the base portion may be configured to connect the bracket to the structure (e.g., the wall).

The base portion may include a face, where the dock comprises a first and second electrical contacts located on the face. The pocket may include a wall, where the bottom bar comprises first and second electrical contacts located on the wall, and where the first and second electrical contacts of the dock are configured to be electrically coupled to the first and second electrical contacts of the bottom bar when the base portion is disposed in the pocket. The face may include a flange portion that is tapered and the pocket comprises a guiding member configured to contact the flange portion and guide a contact surface toward the wall. The guiding member may have a first width, and the body may include an offset portion substantially perpendicular to the contact surface, where the offset portion has a second width. The first width may be larger than the second width. The first and second electrical contacts of the bottom bar may be electrically connected to the first energy storage element, and the first and second electrical contacts of the bottom bar may be configured to be electrically connected to the first and second electrical contacts of the dock when the covering material is in the raised position.

The dock may include an arm that extends from the first mounting bracket, and the base portion may include a face and an offset portion, where the offset portion offsets the face from the arm of the dock. The base portion may be configured to be adjustably coupled to the arm via one or more fasteners. The arm of the dock may include a slot, and where the base portion is configured to be coupled to the arm when the fastener is disposed in the slot. A position of the base portion of the dock may be configured to adjusted along the arm via the slot.

The bottom bar may include a plurality of support members, and the dock may include a plurality of slots, each of the plurality of support members configured to be disposed in a slot of the plurality of slots. The bottom bar may be configured to be electrically coupled to the dock when each of the plurality of support members is disposed in a respective slot of the plurality of slots. The dock may include a plurality of first electrical contacts, each electrical contact of the plurality of first electrical contacts disposed in at least one of the plurality of slots. The bottom bar may include a plurality of second electrical contacts, where each slot of the plurality of support members may include a second electrical contact of the plurality of second electrical contacts, each of the plurality of first electrical contacts may be configured to be electrically coupled to a respective second electrical contact of the plurality of second electrical contacts when the covering material is in the raised position. For example, each of the plurality of first electrical contacts may define a partial loop. The plurality of first electrical contacts of the dock may be biased outward away from a front surface of an arm of the dock. The plurality of first electrical contacts of the dock may be biased towards a rear surface of a base portion of the dock.

A first support member of the plurality of support members may be comprised in an end cap of the bottom bar, and one or more of the plurality of second electrical contacts may be comprised in the end cap of the bottom bar. For example, each of the plurality of slots may be at least partially defined by a flange portion comprising a taper configured to contact a respective support member of the plurality of support members and guide the support member of the plurality of support members into a respective slot of the plurality of slots.

The plurality of first electrical contacts may include four electrical contacts, and the plurality of second electrical contacts may include four electrical contacts. The bottom bar may include a plurality of support members, and the plurality of second electrical contacts of the bottom bar may be located on the plurality of support members. The plurality of support members may extend across a recess of a housing of the bottom bar.

The motorized window treatment may include a fastener, and the dock may include a slot, such that the fastener is configured to be disposed in the slot, and the dock is configured to move with respect to the first mounting bracket and the fastener is configured to move within the at least one slot. The dock may include a first plurality of electrical contacts and the bottom bar may include a second plurality of second electrical contacts, such that the first plurality of electrical contacts configured to be electrically connected to the second plurality of electrical contacts when the covering material is in the raised position. The dock may include an arm and a base portion connected to the arm, and the first plurality of electrical contacts may be disposed on the arm. The bottom bar may include an end cap comprising an inner edge, and at least one of the second plurality of electrical contacts may extend at least partially around the inner edge. The motor drive unit may be connected to the arm, the first plurality of electrical contacts may be disposed in a cavity of the arm, and the first plurality of electrical contacts may be configured to be electrically connected to the motor drive unit via a tunnel extending from the cavity to the motor drive unit. The dock may include an arm and a base portion connected to the arm, and wherein the first plurality of electrical contacts are disposed on the base portion. The bottom bar may include a housing comprising a first end and a second end, and the second plurality of electrical contacts may be disposed on the housing. The motor drive unit may be connected to the arm, and the first plurality of electrical contacts may be disposed in a cavity of the base portion, such that the first plurality of electrical contacts are configured to be electrically connected to the motor drive unit via a tunnel extending from the cavity to the motor drive unit. The base portion may include a base cover, and the cavity may be disposed in the base cover. The first plurality of electrical contacts may be disposed on a face of the base portion. The base portion may include an arm that extends from the first mounting bracket and an offset portion, such that the face is offset from the front surface of the arm by the offset portion.

A bracket for supporting a motorized window treatment may include an attachment member configured to support an end portion of the motor drive unit of the window treatment assembly of the motorized window treatment. The bracket may include a dock comprising a first pair of electrical contacts configured to be electrically coupled to a second pair of electrical contacts of the bottom bar of the window treatment assembly. The first pair of electrical contacts of the dock may be configured to be electrically coupled to the motor drive unit when the end portion of the motor drive unit is supported by the attachment member of the mounting bracket. For example, a first electrical contact of the first pair of electrical contacts may be configured to deliver power from the bottom bar to the motor drive unit, and a second electrical contact of the first pair of electrical contacts may be configured to communication between the bottom bar and the motor drive unit. In some examples, the first electrical contact of the first pair of electrical contacts may be configured to deliver power from the bottom bar to the motor drive unit via a power source the powers the motor drive unit.

The dock may include an arm and a base connected to the arm, and the first pair of electrical contacts may be disposed on the arm. Alternatively, the dock may include an arm extending from the bracket and a base portion connected to the arm, and the first pair of electrical contacts may be disposed on the base portion. The attachment member may be configured to extend from the bracket, the first pair of electrical contacts may be disposed within the attachment member, and the first pair of electrical contacts may be configured to be electrically connected to the motor drive unit via one or more channels extending through the bracket. In some examples, the first pair of electrical contacts may be disposed on the arm of the bracket, for example, in a location that is proximate to the attachment member, or alternatively, the first pair of electrical contacts may be disposed on the base portion (e.g., a foot) of the bracket, and the base portion may be configured to attach the bracket to a structure, such as a wall.

A motorized window treatment may include first and second mounting brackets configured to be mounted to the structure. The motorized window treatment may include a window treatment assembly supported by the first and second mounting brackets. The window treatment assembly may include a covering material that extends from top end to a bottom end and is operable between a raised position and a lowered position. The window treatment assembly may include a bottom bar attached to the bottom end of the covering material. The bottom bar may include a housing comprising a first end and a second end, an end cap located at the first end of the housing, and/or a first pair of electrical contacts disposed on the end cap at the first end of the housing. The motorized window treatment may include a motor drive unit that includes a motor configured to adjust the covering material between the raised position and the lowered position. The motorized window treatment may include a dock supported by the first mounting bracket, where the dock includes a second pair of electrical contacts configured to be electrically connected to the first pair of electrical contacts of the bottom bar when the covering material is in the raised position.

The bottom bar may include a first energy storage element, and the bottom bar may be configured to be positioned adjacent to the dock when the covering material is in the raised position, such that the first pair of electrical contacts of the bottom bar are electrically connected to the second pair of electrical contacts of the dock and the first energy storage element of the bottom bar is configured to discharge through the dock into a second energy storage element of the motor drive unit. The dock may include a base portion, and the second pair of electrical contacts may be located on the base portion. The end cap may include an inner edge and an outer edge, and a first one of the second pair electrical contacts may extend at least partially around the inner edge of the end cap and a second one of the second pair of electrical contacts may extend at least partially around the outer edge of the end cap. Further, in some examples, the window treatment assembly may include a fastener, the dock may include an arm with the fastener and base portion has a slot, and the fastener may be configured to be disposed in the slot such that the base is configured to move with respect to the first mounting bracket.

A motorized window treatment may include first and second mounting brackets configured to be mounted to the structure and a window treatment assembly supported by the first and second mounting brackets. The window treatment assembly may include a covering material that extends from top end to a bottom end and is operable between a raised position and a lowered position. The window treatment assembly may include a bottom bar attached to the bottom end of the covering material. The window treatment assembly may include a motor drive unit comprising a motor configured to adjust the covering material between the raised position and the lowered position. The window treatment assembly may include a dock configured to be electrically coupled to the motor drive unit, the dock supported to the first mounting bracket and configured to move with respect to the first mounting bracket. The bottom bar may be configured to be positioned adjacent to the base portion of the dock when the covering material is in the raised position. The window treatment assembly may include a fastener, the dock may include a slot, and the fastener may be configured to be disposed in the slot such that the dock is configured to move with respect to the first mounting bracket by way of the fastener being configured to move within the at least one slot. The bottom bar may include a first energy storage element, and the bottom bar may be configured to be positioned adjacent to the dock when the covering material is in the raised position, such that the first energy storage element of the bottom bar is configured to discharge through the dock into a second energy storage element of the motor drive unit. In some examples, the dock may be supported by the mounting bracket.

A motorized window treatment may include at least one solar cell. The motorized window treatment may include a window treatment assembly that includes a covering material that extends from a top end to a bottom end and is operable between a raised position and a lowered position. The motorized window treatment may include a bottom bar attached to the bottom end of the covering material. The bottom bar may include a first energy storage element electrically coupled to the solar cell. The bottom bar may include a first electrical contact and a second electrical contact that are electrically connected to the first energy storage element. The motor drive unit may include first and second electrical contacts and a motor, wherein the motor is configured to adjust the covering material between the raised position and the lowered position. The motorized window treatment may include a second energy storage element configured to power the motor. The motorized window treatment may include a dock configured to be electrically coupled to the motor drive unit, where the dock comprises first and second electrical contacts. The first electrical contact of the dock may include a first end comprising a first hook and a second end comprising a first clip, and the second electrical contact of the dock may include a first end comprising a second hook and a second end comprising a second clip. The first clip of the first electrical contact of the dock may be configured to be electrically connected to the first electrical contact of the motor drive unit, and the second clip of the second electrical contact of the dock may be configured to be electrically connected to the second electrical contact of the motor drive unit. The hook of the first electrical contact of the dock may be configured to be electrically connected to the first electrical contact of the bottom bar when the covering material is in the raised position, and the hook of the second electrical contact of the dock may be configured to be electrically connected to the second electrical contact of the bottom bar when the covering material is in the raised position, such that the first energy storage element of the bottom bar is configured to discharge through the dock into the second energy storage element.

A motorized window treatment may include at least one solar cell. The motorized window treatment may include a window treatment assembly that includes a covering material that extends from a top end to a bottom end and is operable between a raised position and a lowered position. The window treatment assembly may include a bottom bar attached to the bottom end of the covering material, the bottom bar comprising a first energy storage element electrically coupled to the solar cell. The motorized window treatment may include a motor drive unit comprising a motor configured to adjust the covering material between the raised position and the lowered position. The motorized window treatment may include a dock configured to be electrically coupled to the motor drive unit. The bottom bar may include a pocket, where the dock comprises a base portion that is configured to be disposed in the pocket, and where the base portion is configured to be electrically coupled to the bottom bar when the base portion is disposed in the pocket, such that the first energy storage element of the bottom bar is configured to discharge through the dock into a second energy storage element that is configured to power the motor drive unit.

A motorized window treatment may include at least one solar cell. The motorized window treatment may include a window treatment assembly that includes a covering material that extends from a top end to a bottom end and is operable between a raised position and a lowered position. The window treatment assembly may include a bottom bar attached to the bottom end of the covering material, the bottom bar including a first energy storage element electrically coupled to the solar cell. The motorized window treatment may include a motor drive unit comprising a motor configured to adjust the covering material between the raised position and the lowered position. The motorized window treatment may include a dock configured to be electrically coupled to the motor drive unit. The bottom bar may include a plurality of support members, wherein the dock comprises a plurality of slots, each of the plurality of support members configured to be disposed in a slot of the plurality of slots. The bottom bar may be configured to be electrically coupled to the dock when each of the plurality of support members is disposed in a respective slot of the plurality of slots, such that the first energy storage element of the bottom bar is configured to discharge through the dock into a second energy storage element configured to power the motor drive unit.

A motorized window treatment may include at least one solar cell. The motorized window treatment may include a window treatment assembly may include a covering material that extends from a top end to a bottom end and is operable between a raised position and a lowered position. The window treatment assembly may include a bottom bar attached to the bottom end of the covering material, the bottom bar includes a first energy storage element electrically coupled to the solar cell. The motorized window treatment may include a motor drive unit may include a motor configured to adjust the covering material between the raised position and the lowered position. The motorized window treatment may include a dock comprising a slot, where the dock is configured to be electrically coupled to the motor drive unit. The motorized window treatment may include a fastener configured to be disposed in the slot, and where the dock is configured to move with respect to a mounting bracket and the fastener is configured to move within the slot. The bottom bar may be configured to be positioned adjacent to the dock when the covering material is in the raised position, such that the first energy storage element of the bottom bar is configured to discharge through the dock into a second energy storage element configured to power the motor drive unit. The dock may be configured to move align the bottom bar with dock as the dock is raised.

A motorized window treatment may include a bracket configured to be mounted to the structure, the bracket including an arm that extends from the structure. The motorized window treatment may include at least one solar cell. The motorized window treatment may include a window treatment assembly supported by the arm of the mounting bracket. The window treatment assembly may include a covering material that extends from a top end to a bottom end and is operable between a raised position and a lowered position. The window treatment assembly may include a bottom bar attached to the bottom end of the covering material, the bottom bar comprising a first energy storage element electrically coupled to the solar cell. The motorized window treatment may include a motor drive unit may include a motor configured to adjust the covering material between the raised position and the lowered position. The motorized window treatment may include a dock located on the arm of the bracket and comprising a first plurality of electrical contacts disposed on the arm. The bottom bar comprises a second plurality of second electrical contacts, and wherein the first plurality of electrical contacts configured to be electrically connected to the second plurality of electrical contacts when the covering material is in the raised position, such that the first energy storage element of the bottom bar is configured to discharge through the dock into a second energy storage element configured to power the motor drive unit.

A motorized window treatment may include a bracket configured to be mounted to the structure, the bracket comprising an arm that extends from the structure and a base portion that extends at an angle from the arm. The motorized window treatment may include first and second mounting brackets configured to be mounted to the structure. The motorized window treatment may include at least one solar cell. The motorized window treatment may include a window treatment assembly supported by the arm of the mounting bracket, the window treatment assembly including a covering material that extends from a top end to a bottom end and is operable between a raised position and a lowered position, the window treatment assembly further comprising a bottom bar attached to the bottom end of the covering material, the bottom bar comprising a first energy storage element electrically coupled to the solar cell. The motorized window treatment may include a motor drive unit that includes a motor configured to adjust the covering material between the raised position and the lowered position. The motorized window treatment may include a dock located on the base of the bracket and comprising a first plurality of electrical contacts disposed on the base portion. The bottom bar may include a second plurality of second electrical contacts, and the first plurality of electrical contacts configured to be electrically connected to the second plurality of electrical contacts when the covering material is in the raised position, such that the first energy storage element of the bottom bar is configured to discharge through the dock into a second energy storage element that is configured to power the motor drive unit.

Finally, although the Summary is drafted from the perspective of an apparatus, such as a motorized treatment (e.g., a motorized window treatment) and/or a system controller, the concepts described herein may be captured as a method that is performed by one or more apparatuses and/or as one or more computer-readable storage medium that are located on one or more apparatuses.

### BRIEF DESCRIPTION OF THE DRAWINGS

FIG. 1 is a diagram of an example load control system.

FIG. 2 is a perspective view of an example motorized window treatment.

FIG. 3 is a rear perspective view of the motorized window treatment of FIG. 2.

FIG. 4 is a front perspective view of a window treatment assembly the motorized window treatment of FIG. 2.

FIG. 5 is a rear perspective view of the window treatment assembly of FIG. 4.

FIG. 6 is a left-side view of the window treatment assembly of FIG. 4.

FIG. 7 is a perspective view of a motor drive unit of the window treatment assembly of the motorized window treatment of FIG. 2.

FIG. 8 is a partial enlarged perspective view of the motor drive unit of FIG. 7.

FIG. 9 is a front view of the motor drive unit of FIG. 7.

FIG. 10 is a top view of the motor drive unit of FIG. 7.

FIG. 11 is a left-side view of the motor drive unit of FIG. 7.

FIG. 12 is a partial enlarged rear perspective view of a bottom bar of the window treatment assembly of the motorized window treatment of FIG. 2.

FIG. 13 is a left-side cross section view of the bottom bar of FIG. 12.

FIG. 14 is a partial enlarged perspective view of another example motor drive unit for use in a motorized window treatment.

FIG. 15 is a rear perspective view of another example motorized window treatment.

FIG. 16 is a partial enlarged perspective view of a motor drive unit of the motorized window treatment of FIG. 15.

FIG. 17 is a front perspective view of a mounting bracket and a portion of a bottom bar of another example motorized window treatment.

FIG. 18A is a perspective view of an example electrical contact structure of a dock of the motorized window treatment of FIG. 17.

FIG. 18B is a perspective view of an example motor drive unit of the motorized window treatment of FIG. 17.

FIG. 19 is a rear perspective view of the bottom bar of FIG. 17.

FIG. 20 is a front perspective view of a mounting bracket and a portion of a bottom bar of another example motorized window treatment.

FIG. 21 is a rear perspective view of the mounting bracket and the bottom bar of FIG. 20.

FIG. 22 is a front perspective view of a mounting bracket and a portion of a bottom bar of another example motorized window treatment.

FIG. 23 is a rear perspective view of the mounting bracket and the bottom bar of FIG. 22.

FIG. 24 is a rear perspective view of a dock that may be supported by the mounting bracket of FIG. 22.

FIG. 25 is a front perspective view of a mounting bracket and a portion of a bottom bar of another example motorized window treatment.

FIG. 26A is a partial enlarged perspective view of the bottom bar of FIG. 25.

FIG. 26B is a partial enlarged perspective view of the bottom bar of FIG. 25 with an end cap removed.

FIG. 27 is a side cross section view of the mounting bracket of FIG. 25.

FIG. 28 is a partial enlarged perspective view of a window treatment assembly of the motorized window treatment of FIG. 25.

FIG. 29 is a front perspective view of a mounting bracket and a portion of a bottom bar of another example motorized window treatment.

FIG. 30 is a rear perspective view of the mounting bracket and the bottom bar of FIG. 29.

FIG. 31 is a simplified block diagram of a motorized window treatment control system for controlling a motorized window treatment.

FIG. 32 is a flowchart of an example procedure for adjusting a present position of a covering material of a motorized window treatment.

FIG. 33 is a flowchart of an example procedure for determining when to dock a bottom bar of a motorized window treatment.

FIGS. 34A-34G are flowcharts of example procedures for determining when to dock a bottom bar of a motorized window treatment.

FIGS. 35A-35C are flowcharts of example procedures for docking a bottom bar of a motorized window treatment.

FIG. 36 is a flowchart of an example procedure for adjusting a present position of a covering material of a motorized window treatment in response to a solar power being received by one or more solar cells of the motorized window treatment.

### DETAILED DESCRIPTION

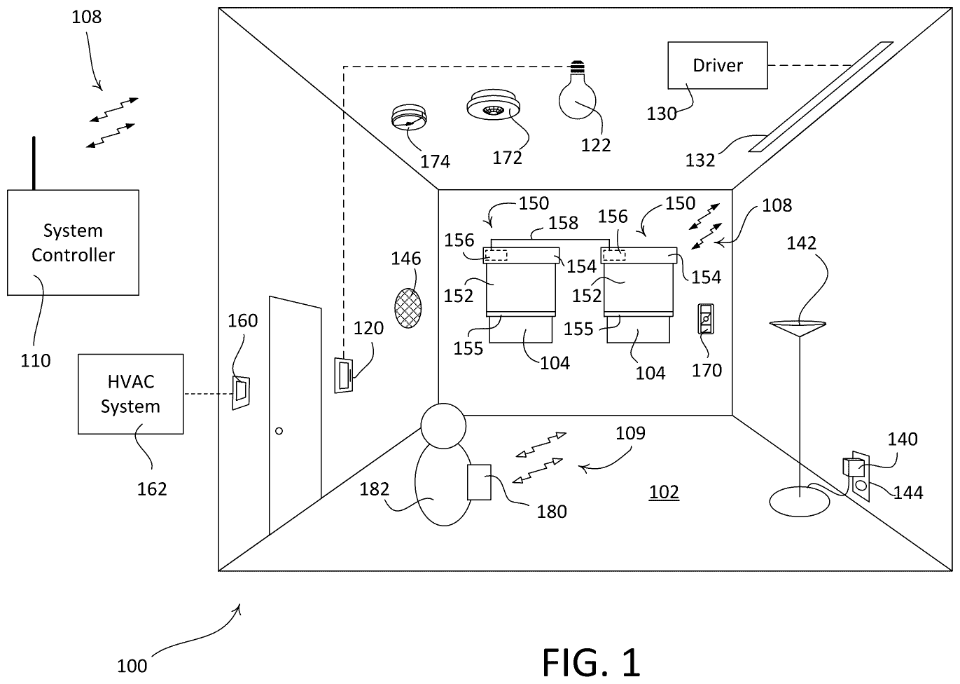

FIG. 1 is a diagram of an example load control system 100 for controlling an amount of power delivered from a power source (not shown), such as an alternating-current (AC) power source or a direct-current (DC) power source, to one or more electrical loads. The load control system 100 may be installed in a room 102 of a building. The load control system 100 may comprise a plurality of control devices configured to communicate with each other by transmitting and receiving messages (e.g., digital messages) via wireless signals, e.g., radio-frequency (RF) signals 108. Alternatively or additionally, the load control system 100 may comprise a wired digital communication link coupled to one or more of the control devices to provide for communication between the control devices. The control devices of the load control system 100 may comprise a number of control-source devices (e.g., input devices operable to transmit messages in response to user inputs, occupancy and/or vacancy conditions, changes in measured light intensity, etc.) and a number of control-target devices (e.g., load control devices operable to receive messages and control respective electrical loads in response to the received messages). A single control device of the load control system 100 may operate as both a control-source and a control-target device.

The control-source devices may be configured to transmit messages directly to the control-target devices. In addition, the load control system 100 may comprise a system controller 110 (e.g., a central processor or load controller) configured to communicate messages to and from the control devices (e.g., the control-source devices and/or the control-target devices). For example, the system controller 110 may be configured to receive messages from the control-source devices and transmit messages to the control-target devices in response to the messages received from the control-source devices.

The load control system 100 may comprise one or more load control devices, such as a dimmer switch 120 (e.g., a control-target device) for controlling a lighting load 122. The dimmer switch 120 may be configured to control an amount of power delivered from the AC power source to the lighting load to adjust an intensity level and/or a color (e.g., a color temperature) of the lighting load. The dimmer switch 120 may be adapted to be wall-mounted in a standard electrical wallbox. The dimmer switch 120 also comprise a tabletop or plug-in load control device. The dimmer switch 120 may comprise a toggle actuator (e.g., a button) and an intensity adjustment actuator (e.g., a rocker switch). Actuations (e.g., successive actuations) of the toggle actuator may toggle (e.g., turn off and on) the lighting load 122. Actuations of an upper portion or a lower portion of the intensity adjustment actuator may respectively increase or decrease the amount of power delivered to the lighting load 122 and thus increase or decrease the intensity of the receptive lighting load from a minimum intensity (e.g., approximately 1%) to a maximum intensity (e.g., approximately 100%). The dimmer switch 120 may comprise a plurality of visual indicators, e.g., light-emitting diodes (LEDs), which are arranged in a linear array and are illuminated to provide feedback of the intensity of the lighting load 122. Examples of wall-mounted dimmer switches are described in greater detail in U.S. Pat. No. 9,679,696, issue Jun. 13, 2017, entitled WIRELESS LOAD CONTROL DEVICE, the entire disclosure of which is hereby incorporated by reference.

The dimmer switch 120 may be configured to wirelessly receive messages via the RF signals 108 (e.g., from the system controller 110) and to control the lighting load 122 in response to the received messages. Examples of dimmer switches and other control devices configured to transmit and receive messages are described in greater detail in commonly-assigned U.S. Pat. No. 10,041,292, issued Aug. 7, 2018, entitled LOW-POWER RADIO-FREQUENCY RECEIVER, and U.S. Pat. No. 10,271,407, issued Apr. 23, 2019, entitled LOAD CONTROL DEVICE HAVING INTERNET CONNECTIVITY, the entire disclosures of which are hereby incorporated by reference.

The load control system 100 may comprise one or more remotely-located load control devices, such as a light-emitting diode (LED) driver 130 (e.g., a control-target device) for driving an LED light source 132 (e.g., an LED light engine). The LED driver 130 may be located remotely, for example, in or adjacent to the lighting fixture of the LED light source 132. The LED driver 130 may be configured to receive messages via the RF signals 108 (e.g., from the system controller 110) and to control the LED light source 132 in response to the received messages. The LED driver 130 may be configured to adjust the color temperature of the LED light source 132 in response to the received messages. The load control system 100 may further comprise other types of remotely-located load control devices, such as, for example, electronic dimming ballasts for driving fluorescent lamps.

The load control system 100 may comprise a plug-in load control device 140 (e.g., a control-target device) for controlling a plug-in electrical load, e.g., a plug-in lighting load (e.g., such as a floor lamp 142 or a table lamp) and/or an appliance (e.g., such as a television or a computer monitor). For example, the floor lamp 142 may be plugged into the plug-in load control device 140. The plug-in load control device 140 may be plugged into a standard electrical outlet 144 and thus may be coupled in series between the AC power source and the plug-in lighting load. The plug-in load control device 140 may be configured to receive messages via the RF signals 108 (e.g., from the system controller 110) and to turn on and off or adjust the intensity of the floor lamp 142 in response to the received messages. Alternatively or additionally, the load control system 100 may comprise controllable receptacles (e.g., control-target devices) for controlling plug-in electrical loads plugged into the receptacles. The load control system 100 may comprise one or more load control devices or appliances that are able to directly receive the wireless signals 108 from the system controller 110, such as a speaker 146 (e.g., part of an audio/visual or intercom system), which is able to generate audible sounds, such as alarms, music, intercom functionality, etc.

The load control system 100 may comprise one or more daylight control devices, e.g., motorized window treatments 150 (e.g., control-target devices), such as motorized roller shades, for controlling the amount of daylight entering the room 102. Each motorized window treatment 150 may comprise a covering material 152 (e.g., a window treatment fabric) hanging from a roller tube 154 in front of a respective window 104 with a respective bottom bar 155 connected to a bottom end of the respective covering material 152. The covering material 152 may be wound around and unwound from the roller tube 154 for respectively raising and lowering the covering material 152. Each motorized window treatment 150 may further comprise a motor drive unit 156 located inside of the roller tube 154 and having a motor for rotating the roller tube 154 to raise and lower the covering material 152 for controlling the amount of daylight entering the room 102. The motor drive units 156 may be configured to adjust a present position P_{PRES} of the respective covering material 152 between a raised position P_{RAISED} (e.g., a fully-raised position and/or a fully-open position) and a lowered position P_{LOWERED} (e.g., a fully-lowered position and/or a fully-closed position).

The motor drive units 156 of the motorized window treatments 150 may each be configured to communicate (e.g., transmit and/or receive) messages via the RF signals 108. For example, the motor drive units 156 of the motorized window treatments 150 may each be configured to receive messages (e.g., from the system controller 110) and adjust the present position P_{PRES} of the respective covering material 152 in response to the received messages. The motor drive unit 156 of each of the motorized window treatments 150 may be battery-powered or may be coupled to an external alternating-current (AC) or direct-current (DC) power source. The load control system 100 may comprise other types of daylight control devices, such as, for example, a cellular shade, a drapery, a Roman shade, a Venetian blind, a Persian blind, a pleated blind, a tensioned roller shade system, an electrochromic or smart window, and/or other suitable daylight control device. Further, the load controls system 100 is not limited to any particular window or environment, and for instance, may be adapted for various types of interior daylight control devices (e.g., shades, blinds, or drapery for interior windows, skylights in interior spaces, moonlights in automobiles, etc.) and/or exterior daylight control devices (e.g., exterior blinds or shades, awnings, etc.). Examples of battery-powered motorized window treatments are described in greater detail in U.S. Pat. No. 10,494,864, issued Dec. 3, 2019, entitled MOTORIZED WINDOW TREATMENT, the entire disclosure of which is hereby incorporated by reference.

The motor drive units 156 of the respective motorized window treatments 150 may be configured to rotate the respective roller tubes 154 at a respective rotational speed to move the covering materials 152 (e.g., bottom ends of the covering materials) at the same linear speed, such that the positions of the covering materials 152 may remained aligned even when the diameters of the respective roller tubes 154 are different (e.g., particularly when the motorized window treatment 150 are mounted adjacent to each other as shown in FIG. 1). For example, if the diameters of the respective roller tubes 154 are the same, the motor drive units 156 of the respective motorized window treatments 150 may rotate their respective roller tubes 154 at the same rotational speed to move the covering materials 152 (e.g., bottom ends of the covering materials) at the same linear speed. However, if diameters of the respective roller tubes 154 are different, the motor drive units 156 may rotate their respective roller tubes 154 at a rotational speed that is based on the diameter of their respective roller tube 154 to move the respective covering materials 152 (e.g., bottom ends of the covering materials) at the same linear speed. The linear speed of the covering material 152 of a motorized window treatments 150 may refer to the speed at which the bottom end of the covering material moves (e.g., vertically) toward or away from the roller tube 154. The linear speed v of the covering material 152 each of the motorized window treatments 150 may be a function of the rotational speed ω and the diameter d of the roller tube 154, e.g.,

v=½·d·ω.

Each of the motor drive units 156 of the motorized window treatments 150 may take into account the diameter d of the respective roller tube 154 and control the rotational speed ω of the respective motor, such that the linear speed v of the covering material 152 of each of the motorized window treatments 150 may be the same.

Each of the motor drive units 156 may also take into account an amount of the respective covering material 152 wrapped around each of the roller tubes 154 when determining the rotational speed ω at which to rotate the respective motor such that the linear speed v of the covering material 152 of each of the motorized window treatments 150 may be the same. For example, the linear speed v of the covering material 152 each of the motorized window treatments 150 may be a function of the rotational speed o, the diameter d of the roller tube 154, a thickness t of the covering material 152, and a number N of full rotations of the covering material 152 that are presently wound around the roller tube 154, e.g.,

v=½·[d+(2·t·N)]·ω.

Each of the motor drive units 156 may update the number N of full rotations of the covering material 152 that are wound around the roller tube 154 as the roller tube 154 is rotated to move the covering material 152 between the raised position P_{RAISED} and the lowered position P_{LOWERED}. Each of the motor drive units 156 may adjust the rotational speed ω of the respective roller tube 156 such that the linear speed v of the covering material may be constant between the raised position PRAISED and the lowered position P_{LOWERED} (e.g., the rotational speed ω is not constant between the raised position P_{RAISED} and the lowered position P_{LOWERED} and is a function of the number N of full rotations of the covering material 152 that are presently wound around the roller tube 154). Examples of motor drive units configured to the rotational speed of a motor while taking into account the diameter of the roller tube 154 and the amount of the covering material 152 wrapped around each of the roller tube 154 are described in greater detail in U.S. Pat. No. 7,281,565, issue Oct. 16, 2007, entitled SYSTEM FOR CONTROLLING ROLLER TUBE ROTATIONAL SPEED FOR CONSTANT LINEAR SHADE SPEED, the entire disclosure of which is hereby incorporated by reference.

Each of the motorized window treatments 150 may comprise one or more solar cells (e.g., photovoltaic cells) (not shown). For example, the one or more solar cells may be located on the bottom bars 155 of the motorized window treatments 150. The bottom bars 155 may each comprise an energy storage element configured to charge from the one or more solar cells. The motor drive units 156 may be configured to control the respective covering materials 152 to the raised position P_{RAISED} to allow the energy storage element in the bottom bar to discharge into an energy storage element of the respective motor drive unit 156 for producing a storage voltage across the energy storage element. The motor drive units 156 may each be configured to drive the respective motor from the storage voltage produced across the energy storage element in the respective motor drive unit.

The motor drive unit 156 of the motorized window treatments 150 may be coupled together via a power bus 158 (e.g., a DC power bus). The motor drive units 156 of one or more of the motorized window treatments 150 may be configured to charge the energy storage elements of the motor drive unit 156 of one or more of the other motorized window treatments 150 via the power bus 158. The power bus 158 may be electrically coupled to the motor drive units 156 in a daisy-chain configuration (e.g., with the motor drive units 156 coupled in parallel). The power bus 158 may comprise two electrical conductors (e.g., wires) across which the storage voltage of the energy storage element of the motor drive unit 156 of one or more of the motorized window treatments 150 may be coupled for charging the energy storage elements of the motor drive units 156 of the one or more other motorized window treatments 150.

The motor drive units 156 of the motorized window treatments 150 may each be configured to learn the magnitudes of the storage voltages of the energy storage elements of the other motor drive units 156. For example, the motor drive units 156 may each periodically transmit a message including an indication of the magnitude of the storage voltage of the respective energy storage element (e.g., via the RF signals 108). Each of the motor drive units 156 may be configured to determine whether or not to charge the respective energy storage elements of the other motorized window treatments 150 in response to the magnitude of the storage voltage of its energy storage element as well as the magnitudes of the storage voltages of the energy storages elements of the other motorized window treatments 150 received in the messages (e.g., via the RF signals 108).

When the one or more solar cells of a particular motorized window treatment 150 (e.g., the one or more solar cells on the respective bottom bar 155) are not able to receive solar power as efficiently as the solar cells of the other motorized window treatments 150, the motor drive unit 156 of that motorized window treatment 150 may not be able to properly drive its motor to move the covering material 152. The motor drive units 156 of the one or more motorized window treatments 150 may each be configured to charge the energy storage elements of one or more of the other motorized window treatments 150 in response to determining that the one or more of the other motorized window treatments needs to be charged.

The load control system 100 may comprise one or more temperature control devices, e.g., a thermostat 160 (e.g., a control-target device) for controlling a room temperature in the room 102. The thermostat 160 may be coupled to a heating, ventilation, and air conditioning (HVAC) system 162 via a control link (e.g., an analog control link or a wired digital communication link). The thermostat 160 may be configured to wirelessly communicate messages with a controller of the HVAC system 162. The thermostat 160 may comprise a temperature sensor for measuring the room temperature of the room 102 and may control the HVAC system 162 to adjust the temperature in the room to a setpoint temperature. The load control system 100 may comprise one or more wireless temperature sensors (not shown) located in the room 102 for measuring the room temperatures. For example, the thermostat 160 and the wireless temperature sensors may be battery-powered. The HVAC system 162 may be configured to turn a compressor on and off for cooling the room 102 and to turn a heating source on and off for heating the rooms in response to the control signals received from the thermostat 160. The HVAC system 162 may be configured to turn a fan of the HVAC system on and off in response to the control signals received from the thermostat 160. The thermostat 160 and/or the HVAC system 162 may be configured to control one or more controllable dampers to control the air flow in the room 102.

The load control system 100 may comprise one or more input devices (e.g., control-source devices), such as a remote control device 170, an occupancy sensor 172, and/or a daylight sensor 174. The input devices may be fixed or movable input devices. The remote control device 170, the occupancy sensor 172, and/or the daylight sensor 174 may be wireless control devices (e.g., RF transmitters) configured to transmit messages via the RF signals 108 to the system controller 110 (e.g., directly to the system controller). The system controller 110 may be configured to transmit one or more messages to the load control devices (e.g., the dimmer switch 120, the LED driver 130, the plug-in load control device 140, the motorized window treatments 150, and/or the thermostat 160) in response to the messages received from the remote control device 170, the occupancy sensor 172, and/or the daylight sensor 174. The remote control device 170, the occupancy sensor 172, and/or the daylight sensor 174 may also and/or alternatively be configured to transmit messages directly to the dimmer switch 120, the LED driver 130, the plug-in load control device 140, the motorized window treatments 150, and the temperature control device 160.

The remote control device 170 may be configured to transmit messages to the system controller 110 and/or a control-target device via the RF signals 108 in response to an actuation of one or more buttons of the remote control device. For example, the remote control device 170 may be battery-powered. Examples of remote control devices are described in greater detail in commonly-assigned U.S. Pat. No. 9,361,790, issued Jun. 7, 2016, entitled REMOTE CONTROL FOR A WIRELESS LOAD CONTROL SYSTEM, and U.S. Pat. No. 9,633,557, issued Apr. 25, 2017, entitled BATTERY-POWERED RETROFIT REMOTE CONTROL DEVICE, the entire disclosures of which are hereby incorporated by reference.

The occupancy sensor 172 may be configured to detect occupancy and vacancy conditions in the room 102 (e.g., the room in which the occupancy sensors are mounted). For example, the occupancy sensor 172 may be battery-powered. The occupancy sensor 172 may transmit digital messages to the system controller 110 and/or a control-target device via the RF signals 108 in response to detecting the occupancy or vacancy conditions. The system controller 110 may be configured to control load control devices (e.g., the dimmer switch 120, the LED driver 130, and/or the motorized window treatments 150) in response to receiving an occupied command and a vacant command from the occupancy sensor 172. In addition, the load control devices may be responsive to an occupied command and a vacant command received directly from the occupancy sensor 172. Examples of RF load control systems having occupancy and vacancy sensors are described in greater detail in commonly-assigned U.S. Pat. No. 8,009,042, issued Aug. 30, 2011, entitled RADIO-FREQUENCY LIGHTING CONTROL SYSTEM WITH OCCUPANCY SENSING, the entire disclosure of which is hereby incorporated by reference.

The daylight sensor 174 may be configured to measure a total light intensity in the room 102 (e.g., the room in which the daylight sensor is installed). For example, the daylight sensor 174 may be battery-powered. The daylight sensor 174 may transmit digital messages (e.g., including the measured light intensity) to the system controller 110 via the RF signals 108 for controlling the intensities of the lighting load 122 and/or the LED light source 132 in response to the measured light intensity. The system controller 110 may be configured to control the load control devices (e.g., the dimmer switch 120, the LED driver 130, and/or the motorized window treatments 150) in response to receiving a message including the measured light intensity from the daylight sensor 174. In addition, the load control devices may be responsive to a message including the measured light intensity received directly from the daylight sensor 174. Examples of RF load control systems having daylight sensors are described in greater detail in commonly-assigned U.S. Pat. No. 8,451,116, issued May 28, 2013, entitled WIRELESS BATTERY-POWERED DAYLIGHT SENSOR, the entire disclosure of which is hereby incorporated by reference.

Each of the input devices (e.g., the system controller 110, the remote control device 170, the occupancy sensor 172, and/or the daylight sensor 174) may be configured to transmit a message to the load control devices (e.g., the dimmer switch 120, the LED driver 130, the plug-in load control device 140, the motorized window treatments 150, and/or the thermostat 160) multiple times during a transmission event. For example, each of the messages of a transmission event may include the same command for controlling one or more of the load control devices. The input devices may be configured to transmit the messages periodically (e.g., at a transmission period T_{TX}) during the transmission event. The load control devices that are battery-powered (e.g., the motorized window treatments 150) may be configured to periodically wake up from a sleep state (e.g., at a wake-up period T_{WAKE-UP}) to determine if one of the multiple messages of the transmission event is being transmitted. The transmission period T_{TX} and the wake-up period T_{WAKE-UP} may be sized such that each of the load control devices (e.g., the motorized window treatments 150) may not receive each of the multiple messages of the transmission event, but such that most of the load control devices may have received at least one of the messages when a predetermined number of the multiple messages of the transmission event have been transmitted. Each of the motorized window treatments may wait until the predetermined number of the multiple messages of the transmission event have been transmitted before responding to the command. For example, the motorized window treatments may begin adjusting the present positions P_{PRES} of the respective covering materials at a time (e.g., a coordinated action time) that is based on the time at which the predetermined number of the multiple messages of the transmission event have been transmitted (e.g., immediately following when the predetermined number of the multiple messages of the transmission event have been transmitted).

The system controller 110 may be configured to be coupled to a network, such as a wireless or wired local area network (LAN), e.g., for access to the Internet. The system controller 110 may be wirelessly connected to the network. The system controller 110 may be coupled to the network via a network communication bus (e.g., an Ethernet communication link). The system controller 110 may be configured to communicate via the network with one or more network devices, e.g., a mobile device 180, such as, a personal computing device and/or a wearable wireless device. The mobile device 180 may be located on an occupant 182, for example, may be attached to the occupant's body or clothing or may be held by the occupant. The mobile device 180 may be characterized by a unique identifier (e.g., a serial number or address stored in memory) that uniquely identifies the mobile device 180 and thus the occupant 182. Examples of personal computing devices may include a smart phone, a laptop, and/or a tablet device. Examples of wearable wireless devices may include an activity tracking device, a smart watch, smart clothing, and/or smart glasses. In addition, the system controller 110 may be configured to communicate via the network with one or more other control systems (e.g., a building management system, a security system, etc.).

The mobile device 180 may be configured to transmit digital messages via RF signals 109 to the system controller 110 and/or the load control devices, for example, in one or more Internet Protocol packets. For example, the mobile device 180 may be configured to transmit digital messages to the system controller 110 over the LAN and/or via the Internet. The mobile device 180 may be configured to transmit digital messages over the internet to an external service, and then the digital messages may be received by the system controller 110. The load control system 100 may comprise other types of network devices coupled to the network, such as a desktop personal computer (PC), a wireless-communication-capable television, or any other suitable Internet-Protocol-enabled device.

The operation of the load control system 100 may be programmed and configured using, for example, the mobile device 180 or other network device (e.g., when the mobile device is a personal computing device). The mobile device 180 may execute a graphical user interface (GUI) configuration software for allowing a user to program how the load control system 100 will operate. For example, the configuration software may run as a PC application or a web interface. The configuration software and/or the system controller 110 (e.g., via instructions from the configuration software) may generate a load control database that defines the operation of the load control system 100. For example, the load control database may include information regarding the operational settings of different load control devices of the load control system (e.g., the dimmer switch 120, the LED driver 130, the plug-in load control device 140, the motorized window treatments 150, and/or the thermostat 160). The load control database may comprise information regarding associations between the load control devices and the input devices (e.g., the remote control device 170, the occupancy sensor 172, and/or the daylight sensor 174). The load control database may comprise information regarding how the load control devices respond to inputs received from the input devices. Examples of configuration procedures for load control systems are described in greater detail in commonly-assigned U.S. Pat. No. 10,027,127, issued Jul. 17, 2018, entitled COMMISSIONING LOAD CONTROL SYSTEMS, the entire disclosure of which is hereby incorporated by reference.

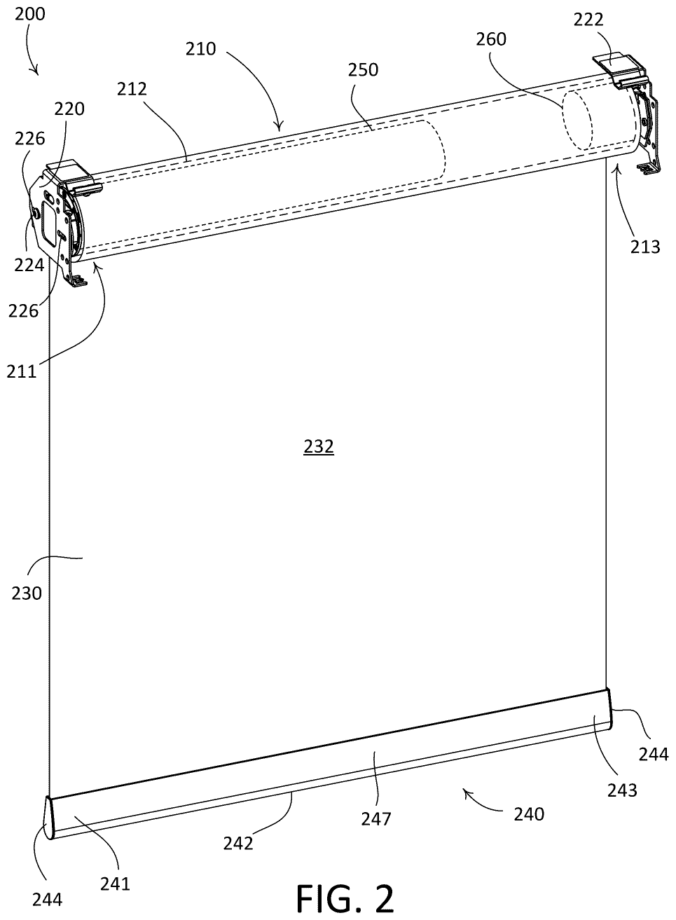

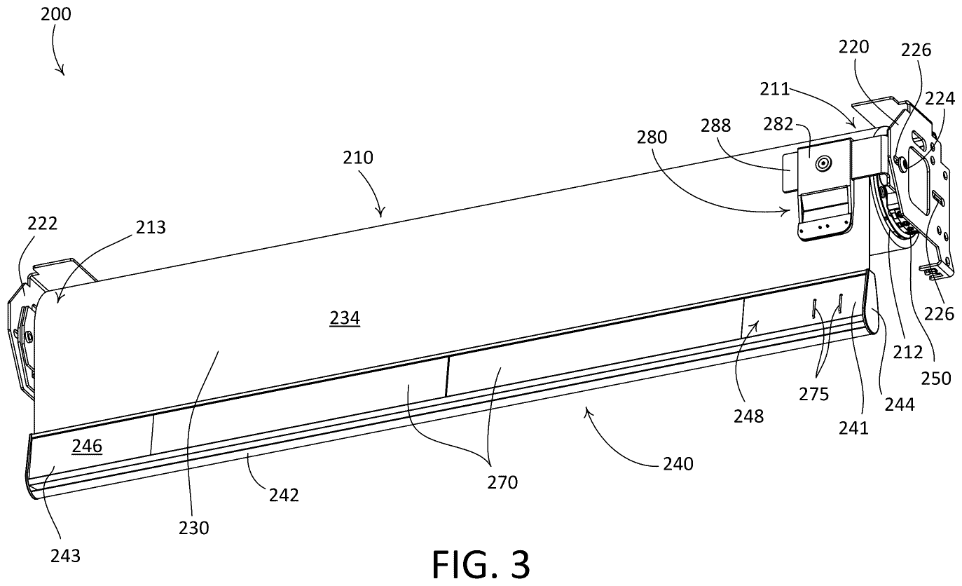

FIG. 2 is a front perspective view and FIG. 3 is a rear perspective view of an example motorized window treatment 200, which may be deployed as one or more of the motorized window treatments 150 of the load control system 100. The motorized window treatment 200 may comprise a window treatment assembly 210 and one or more mounting brackets, such as first and second mounting brackets 220, 222. The first and second mounting brackets 220, 222 may be configured to be coupled to or otherwise mounted to a structure. For example, each of the first and second mounting brackets 220, 222 may be configured to be mounted to (e.g., attached to) a window frame, a wall, or other structure of a building, such that the motorized window treatment 200 may be mounted proximate to an opening (e.g., over the opening or in the opening), such as a window for example. The first and second mounting brackets 220, 222 may be configured to be mounted to a vertical structure (e.g., wall-mounted to a wall) and/or mounted to a horizontal structure (e.g., ceiling-mounted to a ceiling). Further, although not illustrated as such, in some examples, the first and second mounting brackets 220, 222 may be connected, for example, by a bar that extends between the first and second mounting brackets 220, 222. Further, although not illustrated, in some examples, the first and second mounting brackets 220, 222 may be connected so that they form a single mounting bracket.

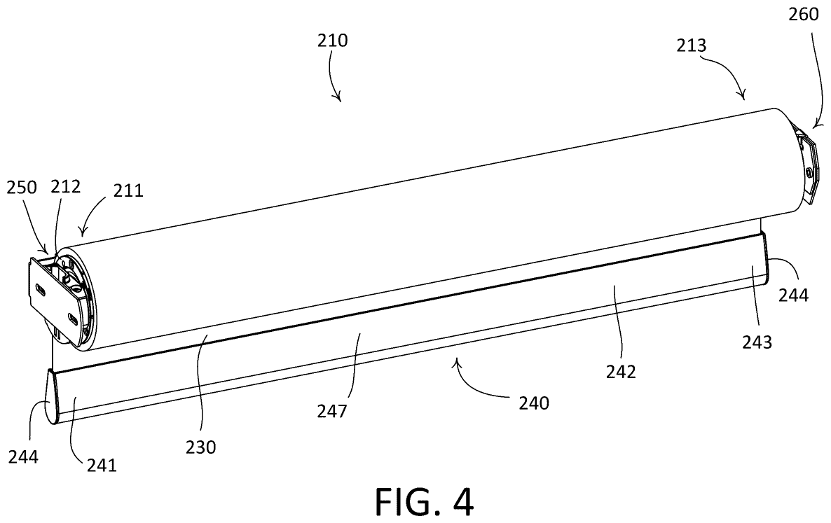

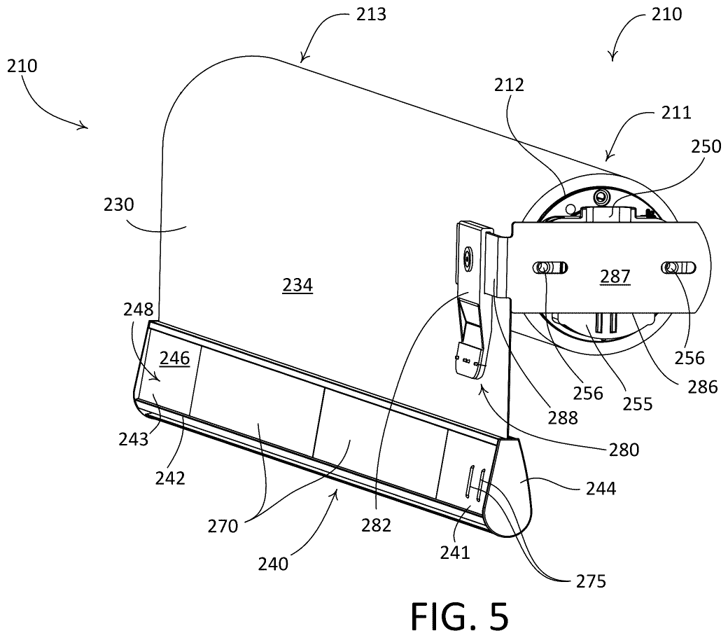

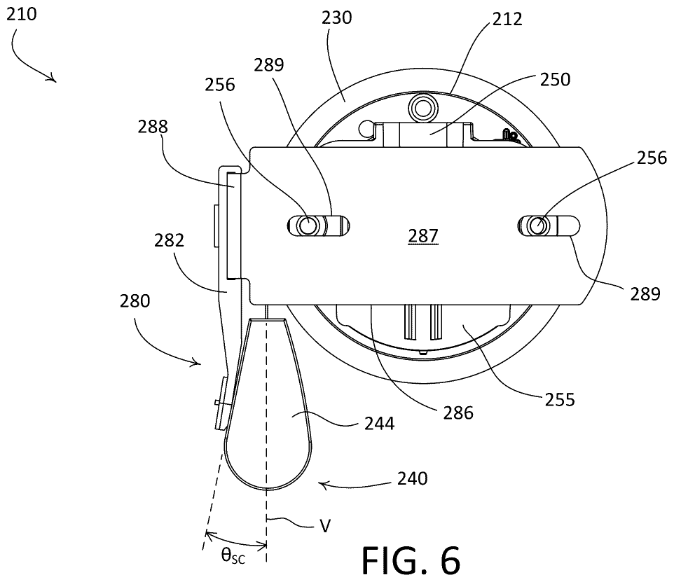

The window treatment assembly 210 may be coupled to (e.g., supported by) the first and second mounting bracket 220, 222. FIG. 4 is a front perspective view, FIG. 5 is a rear perspective view, and FIG. 6 is a left-side view of the window treatment assembly 210 detached from the first and second mounting brackets 220, 222. The window treatment assembly 210 may include a roller tube 212, a covering material 230 (e.g., a flexible material), a bottom bar 240 (e.g., a hembar), a motor drive unit 250 at a first end 211 of the roller tube 212, and an idler 260 at a second end 213 of the roller tube 212. The motor drive unit 250 may be coupled to (e.g., fixedly coupled to) the first mounting bracket 220 and be rotatably coupled to the roller tube 212 at the first end 211 of the roller tube 212. The idler 260 (FIG. 2) may be coupled to (e.g., fixedly coupled to) the second mounting bracket 222 and rotatably coupled to the roller tube 212 at the second end 213 of the roller tube 212. Other configurations of the motor drive unit 250 and idler 260 are possible. For example, the motor drive unit 250 may be located at the second end 213 of the roller tube 212 and the idler 260 may be located at the first end 211 of the roller tube 212.

The covering material 230 may be windingly attached to the roller tube 212. The covering material 230 may comprise a top end (not shown) attached to the roller tube 212 and a bottom end (not shown) attached to the bottom bar 240. The bottom bar 240 may comprise a housing 242 (e.g. a body) having first and second ends 241, 243. In some examples, the bottom end of the covering material 230 may be received within the housing 242 and secured to the bottom bar 240 inside the housing 242. The bottom bar 240 may also comprise, for example, end caps 244 connected to the first and second ends 241, 243 of the bottom bar 240. In addition, the bottom bar 240 (e.g., the housing 242) may be configured, for example weighted, to cause the covering material 230 to hang vertically. For example, the covering material 230 may be configured to cover the window that is proximate to the motorized window treatment 200. The covering material 230 may comprise a front surface 232 that faces the space in which the motorized window treatment 200 is mounted and a rear surface 234 that faces the window.

The roller tube 212 of the window treatment assembly 210 may operate as a rotational element of the motorized window treatment 200. The roller tube 212 of the window treatment assembly 210 may be rotatably mounted to (e.g., rotatably supported by) the first and second mounting brackets 220, 222. The first and second mounting brackets 220, 222 may extend from the structure to which the motorized window treatment 200 is mounted. The covering material 230 may be windingly attached to the roller tube 212, such that rotation of the roller tube 212 causes the covering material 230 to wind around or unwind from the roller tube 212. For example, rotation of the roller tube 212 may cause the covering material 230 (e.g., the bottom bar 240) to move between a raised position P_{RAISED} (e.g., a fully-raised position and/or a fully-open position as shown in FIG. 3) and a lowered position P_{LOWERED} (e.g., a fully-lowered position and/or a fully-closed position as shown in FIG. 2).

The covering material 230 may be any suitable material, or form any combination of materials. For example, the covering material 230 may be “scrim,” woven cloth, non-woven material, light-control film, screen, and/or mesh. The motorized window treatment 200 may be any type of window treatment. For example, the motorized window treatment 200 may be a roller shade as illustrated, a soft sheer shade, a drapery, a cellular shade, a Roman shade, or a Venetian blind. As shown, the covering material 230 may be a material suitable for use as a shade fabric, and may be alternatively referred to as a flexible material. The covering material 230 is not limited to shade fabric. For example, in accordance with an alternative implementation of the motorized window treatment 200 as a retractable projection screen, the covering material 230 may be a material suitable for displaying images projected onto the covering material. With all types of covering materials, the covering material 230 may have a bottom bar attached at a bottom end of the covering material 230.

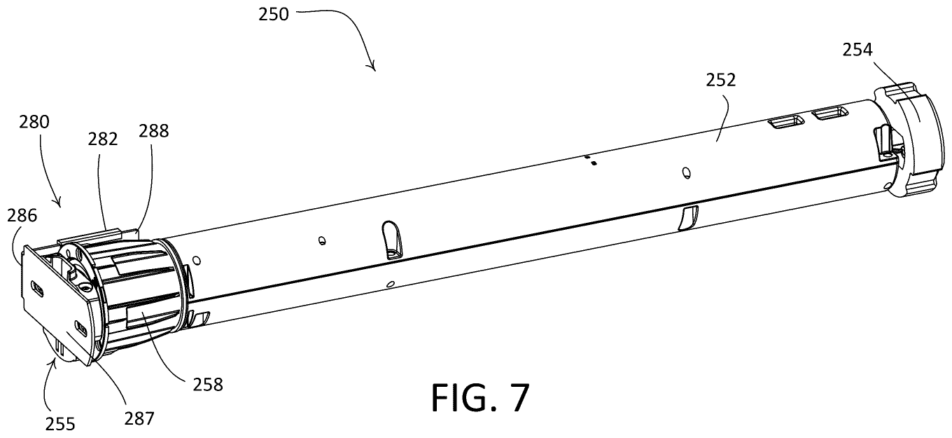

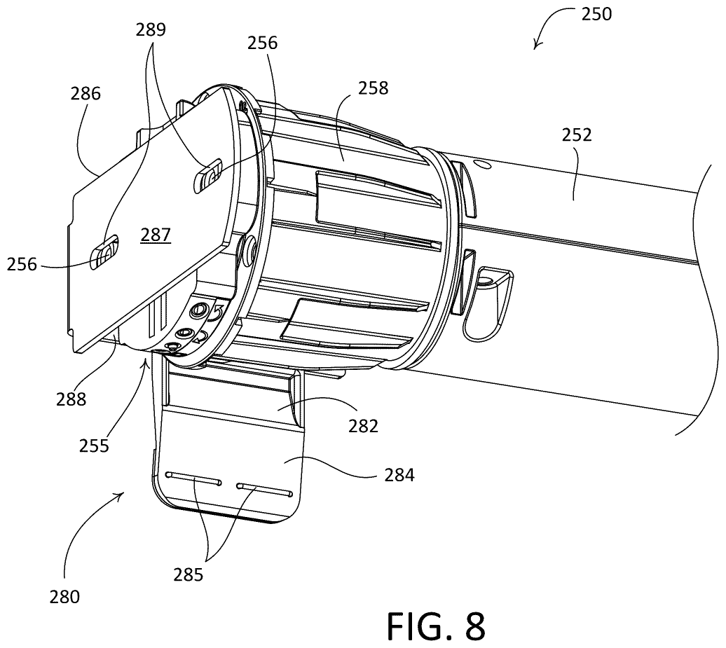

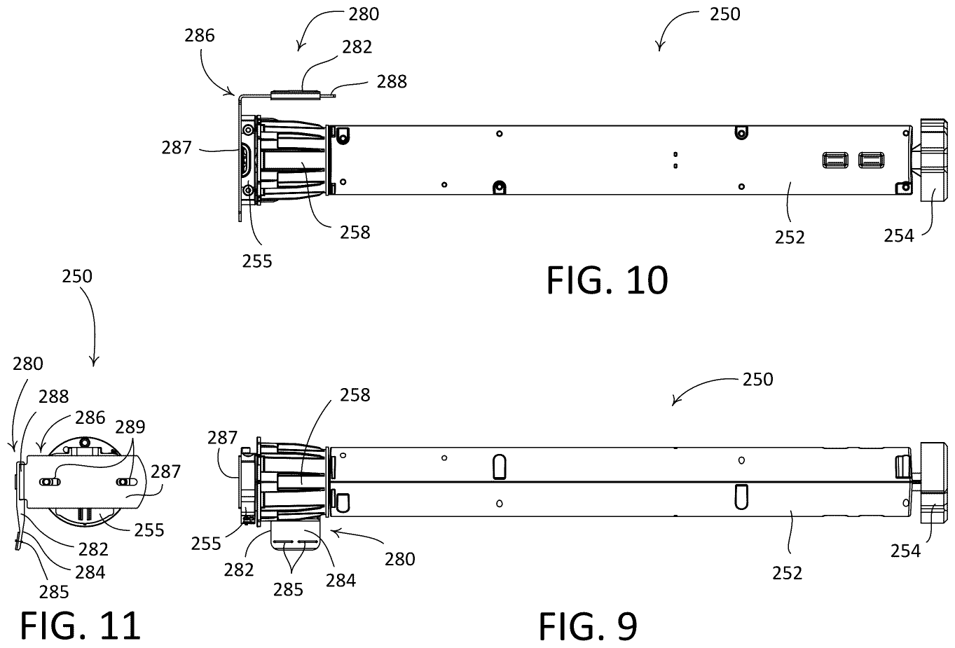

FIG. 7 is a perspective view of an example of the motor drive unit 250. FIG. 8 is a partial enlarged perspective view of the motor drive unit 250. FIG. 9 is a front view, FIG. 10 is a top view, and FIG. 11 is a left-side view of the motor drive unit 250. The motor drive unit 250 may include an enclosure 252 for housing an internal motor (not shown) that may be coupled to a drive coupler 254. The drive coupler 254 may be notched about its outer periphery to facilitate engagement between the drive coupler 254 and an interior surface of the roller tube 212 in which the motor drive unit 250 is received. The motor drive unit 250 may be configured to rotate the drive coupler 254 for rotatably driving the roller tube 212. The motor drive unit 250 may further comprise an end portion 255 that may be coupled to (e.g., supported by) the first mounting bracket 220. For example, the end portion 255 may comprise one or more openings 256 that are configured to receive respective fasteners 224 (e.g., screws as shown in FIGS. 2 and 3). The fasteners 224 may also be received though respective openings 226 in the first and second mounting brackets 220, 222. In some examples, the end portion 255 of the motor drive unit 250 may comprise additional openings (not shown) configured to allow the window treatment assembly 210 to be mounted to other mounting brackets (e.g., other than the first and second mounting brackets 220, 222. The openings 256 and the additional openings may be sized and/or located to allow the window treatment assembly 210 to be mounted to multiple types of mounting brackets (e.g., the first and second mounting brackets 220, 222 as well as other mounting brackets). The motor drive unit 250 may comprise a bearing assembly 258, which may be located adjacent to the end portion 255 and may be rotatably coupled to the roller tube 212 at the first end 211 of the roller tube 212.

The motor drive unit 250 may be responsive to messages (e.g., digital messages) transmitted by an external device, such as a remote control device, via wireless signals, such as radio-frequency (RF) signals. The motor drive unit 250 may comprise a communication circuit, such as a wireless communication circuit (e.g., an RF transceiver coupled to an antenna, an infrared (IR) receiver, etc.) and/or a wired communication circuit. For example, the antenna may be wrapped around the enclosure 252 of the motor drive unit 250 underneath the bearing assembly 258. The motor drive unit 250 may be configured to control the movement of the covering material 230 in response to a shade movement command received in messages from the remote control device. During a configuration procedure (e.g., an association procedure), the motor drive unit 250 may be associated with the remote control device, such that the motor drive unit 250 may be responsive to the messages transmitted by the remote control device (e.g., via wireless signals). Similarly, as described in more detail herein, the bottom bar 240 may include a communication circuit, such as a wireless communication circuit (e.g., an RF transceiver coupled to an antenna, an infrared (IR) receiver, etc.) and/or a wired communication circuit so that the bottom bar 240 may be configured to communication with the motor drive unit 250.

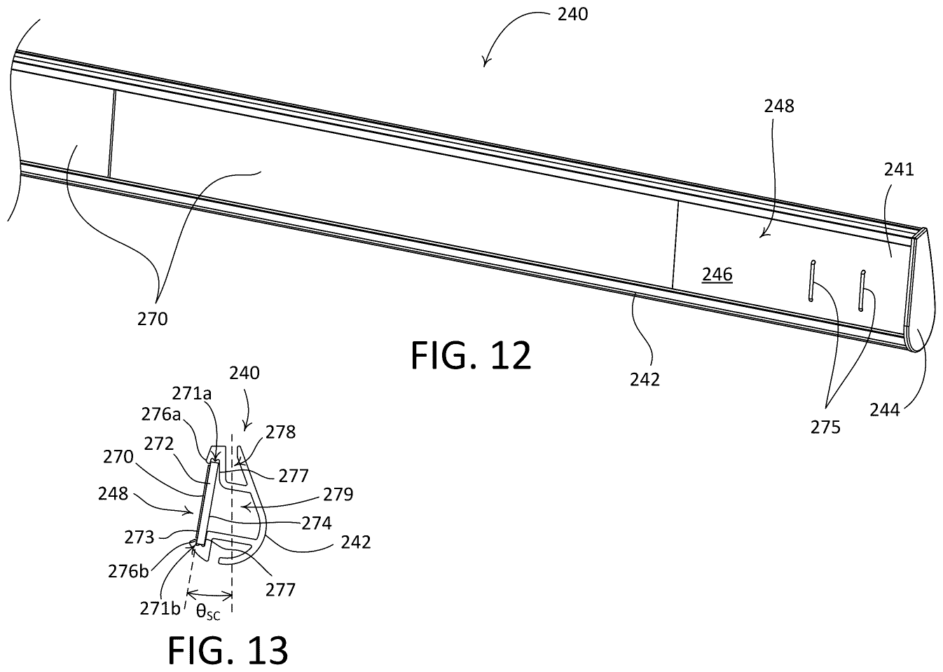

As shown in FIGS. 3 and 5, the bottom bar 240 may comprise one or more solar cells 270 (e.g., photovoltaic cells). FIG. 12 is an enlarged rear perspective view of the first end 241 of the bottom bar 240. The solar cells 270 may be attached to a rear surface 246 of the housing 242 of the bottom bar 240, such that the solar cells 270 face the window (e.g., that the covering material 230 is configured to cover) and are able to receive solar energy from outside the building (e.g., from the sun). For example, the solar cells 270 may be located within a recess 248 in the housing 242. The rear surface 246 of the housing 242 of the bottom bar 240 may be oriented at an angle θ_{SC} from a vertical axis V (e.g., with respect to the covering material 230 as shown in FIG. 6), such that the solar cells 270 may be angled up (e.g., towards the sky to maximize the amount of sunlight that may shine on the solar cells 270). The housing 242 and the end caps 244 may define, for example, a teardrop shape as shown in FIG. 6, but could define other shapes, such as a triangular shape or a polygon shape having an angled rear surface. For example, the angle θ_{SC} at which the solar cells 270 are oriented may be in the range of approximately 5° to 75° (e.g., approximately 30°). The solar cells 270 may be oriented horizontally across the rear surface 246 of the housing 242 of the bottom bar 240. However, in some examples, the solar cells 270 may be oriented vertically (e.g., in parallel with the shade fabric), for instance, across the rear surface 246 of the housing 242 of the bottom bar 240. Further, in some examples, the motorized window treatment 200 may include one or more solar cells 270 attached to an interior surface 247 of the housing 242 of the bottom bar 240 (e.g., receive solar energy from outside the building), for instance, in addition to one or more solar cells 270 being attached to the rear surface 246 of the housing 242 of the bottom bar 240.

FIG. 13 is a left-side cross section view of the bottom bar 240. The bottom bar 240 may comprise a printed circuit board 272 configured to be received in a first channel 271a and a second channel 271b, such that an outer surface 273 of the printed circuit board 272 forms at least a portion of the rear surface 246 of the bottom bar 240. The first channel 271a in the bottom bar 240 may be formed by flange portion 276a adjacent to the outer surface 273 of the printed circuit board 272 and inner surfaces 277 of the bottom bar 240 adjacent to an inner surface 274 of the printed circuit board 272. Additionally, the second channel 271b in the bottom bar 240 may be formed by flange portion 276b adjacent to the outer surface 273 of the printed circuit board 272 and inner surfaces 277 of the bottom bar 240 adjacent to an inner surface 274 of the printed circuit board 272. For example, the printed circuit board 272 may be configured to be slid into the channels 271a, 271b from either the first end 241 or the second end 243 of the bottom bar 240 (e.g., when at least one of the end caps 244 is removed). The solar cells 270 may be located on (e.g., mounted to) the outer surface 273 of the printed circuit board 272. For example, the printed circuit board 272 (e.g., and thus the solar cells 270) may be mounted at the angle θ_{SC} from the vertical axis V.

The housing 242 of the bottom bar 240 may define a first cavity 278 that may be configured to receive the bottom end of the covering material 230. For example, the bottom end of the covering material 230 may be attached to an elongated member (not shown) that may extend through the first cavity 278 (e.g., the from the first end 241 to the second end 243 of the body 242) and may prevent the bottom end of the covering material 230 from being removed from the first cavity 278. In addition, the bottom bar 240 may comprise a second cavity 279 that may also extend from the first end 241 to the second end 243 of the housing 242. The second cavity 279 may be configured to receive a weighting member (not shown) for weighting the bottom bar 240 to cause the covering material 230 to hang vertically.

The solar cells 270 of the bottom bar 240 may be electrically connected to one or more energy storage elements (not shown) contained within the housing 242 of the bottom bar 240. The energy storage elements of the bottom bar 240 may comprise, for example, one or more of rechargeable batteries and/or supercapacitors. For example, the energy storage element of the bottom bar 240 may be located in the second cavity 279. The solar cells 270 may be configured to convert the received solar energy into a photovoltaic output voltage, which may be used to charge the energy storage elements located within the housing 242 of the bottom bar 240 (e.g., to generate a storage voltage across the energy storage element). The energy stored in the energy storage elements of the bottom bar 240 may be discharged into the motor drive unit 250 when the bottom bar 240 is close to the motor drive unit 250, for example, when the bottom bar 240 in the raised position P_{RAISED} (e.g., the fully-raised position). For example, the motor drive unit 250 may comprise one or more energy storage elements (not shown) configured to charge from the energy storage elements of the bottom bar 240 when the covering material 230 is in the raised position P_{RAISED}. For example, the energy storage elements of the motor drive unit 250 may comprise one or more of rechargeable batteries and/or supercapacitors.

The motorized window treatment 200 (e.g., the motor drive unit 250) may comprise a dock 280 that is configured to facilitate discharging of the energy storage elements of the bottom bar 240 into the energy storage elements of the motor drive unit 250, for example, when the covering material 230 is in the raised position P_{RAISED} (e.g., when the bottom bar 240 is docked). The dock 280 may comprise a base portion 282 that may be located adjacent to the rear surface 234 of the covering material 230 (e.g., adjacent to the window) at the first end 211 of the roller tube 212. The bottom bar 240 may be configured to be positioned adjacent to the base portion 282 of the dock 280 when the covering material 230 is in the raised position P_{RAISED}, such that the energy storage elements of the bottom bar 240 may discharge through the base portion 282 of the dock 280 into the energy storage elements of the motor drive unit 250. The base portion 282 of the dock 280 may define a contact surface 284 that may be configured to abut against the rear surface 246 of the bottom bar 240 when the bottom bar 240 is docked (e.g., when the covering material 230 is in the raised position P_{RAISED}). The contact surface 284 of the base portion 282 may be oriented at approximately the angle θ_{SC} from the vertical axis V (e.g., to match the rear surface 246 of the bottom bar 240).

The dock 280 may also comprise two or more electrical contacts 285 (e.g., two horizontally-oriented electrical contacts) located on the contact surface 284 of the base portion 282. The base portion 282 of the dock 280 (e.g., the electrical contacts 285) may be electrically coupled to the motor drive unit 250. For example, the base portion 282 of the dock 280 may be electrically coupled to the motor drive unit 250 via two or more electrical conductors (e.g., wires) extending between the base portion 282 of the dock 280 and the end portion 255 of the motor drive unit 250. The dock 280 may further comprise an attachment member 286 that extends from the end portion 255 of the motor drive unit 250 to the base portion 282. The attachment member 286 may comprise a plate 287 and an arm 288 that is oriented at an angle (e.g., approximately 90°) from the plate 287 (e.g., to bend the attachment member 286 behind the rear surface 234 of the covering material 230). The electrical conductors that extend between the base portion 282 of the dock 280 and the end portion 255 of the motor drive unit 250 may be located internal to or external to the attachment member 286. The plate 287 may comprise openings 289 through which the respective fasteners 224 may extend for coupling the window treatment assembly 210 to the first mounting bracket 220 (e.g., extending through the openings 256 in the first mounting bracket 220 and the openings 256 in the end portion 255 of the motor drive unit 250). For example, the attachment member 286 (e.g., the plate 287) may be affixed to and/or formed as a part of (e.g., integral with) the enclosure 252 and/or the end portion 255 of the motor drive unit 250. In some examples, the attachment member 286 may be affixed to and/or formed as a part of the first mounting bracket 220.

The electrical contacts 285 of the dock 280 may be configured to contact respective electrical contacts 275 (e.g., two vertically-oriented electrical contacts) on the rear surface 246 of the bottom bar 240 (e.g., at the first end 241 of the bottom bar 240) when the bottom bar 240 is docked (e.g., when the covering material 230 is in the raised position P_{RAISED}). Each of the electrical contacts 275 of the bottom bar 240 and the electrical contacts 285 of the dock 280 may be, for example, an elongated conductive element (e.g., an uninsulated wire). The electrical contacts 275 of the bottom bar 240 and the electrical contacts 285 of the dock 280 may be located next to each other (e.g., horizontally spaced apart from each other). For example, the electrical contacts 275 of the bottom bar 240 may be oriented vertically and the electrical contacts 285 of the dock 280 may be oriented horizontally to facilitate electrical connection between the respective electrical contacts 275, 285 when the bottom bar 240 is docked. The electrical contacts 275 of the bottom bar 240 may be electrically connected to the energy storage elements in the bottom bar 240, and the electrical contacts 285 of the dock 280 may be electrically connected to the energy storage elements of the motor drive unit 250, such that that the energy storage elements of the motor drive unit 250 may charge from the energy storage elements of the bottom bar 240 when the bottom bar 240 is docked. For example, the electrical contacts 275 of the bottom bar 240 may be biased (e.g., spring-loaded) away from the rear surface 246 and/or the electrical contacts 285 of the dock 280 may be biased (e.g., spring-loaded) away from the contact surface 284 to help establish and/or maintain the electrical contacts between the electrical contacts 275 of the bottom bar 240 and the electrical contacts 285 of the dock 280.

Alternatively or additionally, the electrical contacts 275 may be located on different surfaces of the bottom bar 240, such as on one of the end caps 244. In such examples, the dock 280 and the electrical contacts 285 of the dock 280 may be positioned such that the electrical contacts 285 of the dock 280 are aligned with the end cap 244 of the bottom bar 240.

Since the motor drive unit 250 is powered from (e.g., entirely powered from) the solar cells 270 and is configured to wirelessly communicate with external devices, the window treatment assembly 210 may be mounted to essentially any mounting brackets—even mounting brackets for manually-operated window treatment assemblies. Accordingly, the window treatment assembly 210 may provide a retro-fit solution for upgrading a manually-operated window treatment to a motorized window treatment without the need to replace the mounting brackets and/or run electrical wiring to the new motorized window treatment.

In some examples, the motor drive unit 250 may include electrical terminal (not shown) that are configured to allow for an external power source to jump start the motor drive unit 250 or recharge the motor drive unit 250 (e.g., if the motor drive unit 250 is uncharged and/or not performing well). In some examples, the electrical terminal may be a standard power supply connector (e.g., a USB connector). As such, the motor drive unit 250 (e.g., the energy storage element of the motor drive unit 250) could receive power from an external power source.

Although described in context of the motorized window treatment 200 comprises a bottom bar 240 that includes solar cells 270 and the bottom bar 240 is configured to charge the motor drive unit 250, the motorized window treatment 200 is not always so limited. In some examples, the bottom bar 240 may not be configured to charge the motor drive unit 250. For example, the motor drive unit 250 may be powered from an external source and/or changeable batteries. For instance, in some examples, the bottom bar 240 may include solar cells and the motor drive unit 250 may charge the energy storage element of the motor drive unit 250 when the bottom bar 240 is docked. Alternatively or additionally, the bottom bar 240 may include the solar cells 270, and one or more of the solar cells 270 may be configured to charge the energy storage element in the bottom bar 240 between docking events, or when docking is not possible. In some examples, the bottom bar 240 may not include solar cells 270. For example, the bottom bar 240 may not include solar cells 270 in examples where the bottom bar 240 is not able to or does not need to dock (e.g., when there is a wired connection between the bottom bar 240 and the motor drive unit 250. Finally, in some examples, the bottom bar 240 may include one or more sensors, such as an occupancy sensor, a vacancy sensor, a photosensor, etc., where the bottom bar 240 and/or the motor drive unit 250 may be configured to control the motorized window treatment 200 and/or external devices (e.g., such as lighting loads) based on feedback from the sensor(s). Finally, in some examples, the motor drive unit may be configured to move the covering material 230 to the raised position P_{RAISED} if the motor drive unit 250 detects that the window is open (e.g., based on feedback from one or more sensors).

Further, in some examples, the dock 280 may be separate from the motor drive unit 250 and the bottom bar 240 (e.g., the dock 280 may be coupled to, for example screwed into, the wall or window frame and one or more wires may be used to electrically connect the docket 280 to the motor drive unit 250).

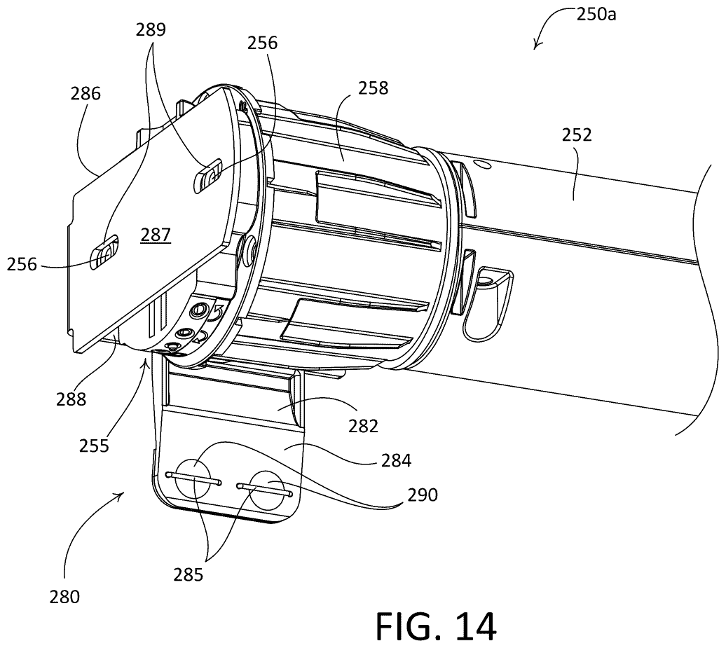

FIG. 14 is a partial enlarged perspective view of another example motor drive unit 250a for use in a motorized window treatment, such as the motorized window treatments 150 of the load control system 100 shown in FIG. 1 and/or the motorized window treatment 200 shown in FIG. 2. The motor drive unit 250a may be the same as the motor drive unit 250 except that the motor drive unit 250a may comprise one or more magnets 290. The magnets 290 may be located on the contact surface 284 of the base portion 282 of the dock 280 of the motor drive unit 250a. For example, as shown in FIG. 14, each of the magnets 290 may be located behind one of the respective electrical contacts 285 of the dock 280, and may be configured to be magnetically attracted to the respective electrical contacts 275 on the bottom bar 240. The magnets 290 may be configured to pull the electrical contacts 275 of the bottom bar 240 towards the electrical contacts 285 of the dock 280 to facilitate electrical connection between the electrical contacts 275 of the bottom bar 240 and the electrical contacts 285 of the dock 280 when the bottom bar 240 is docked. The bottom bar 240 may have a sufficient weight that may counteract the magnetic attraction between the magnets 290 and the respective electrical contacts 275 on the bottom bar 240 when the motor drive unit 250a lowers the bottom bar 240 below the raised position P_{RAISED} (e.g., to undock the bottom bar 240). In some examples, rather than being located behind the electrical contacts 285 of the dock 280, the magnets 290 may be located on other portions of the contact surface 284 of the base portion 282 and may be configured to be magnetically attracted to respective magnets (not shown) on the bottom bar 240. Further, while two magnets 290 are shown in FIG. 14, the motor drive unit 250a may comprise more or less magnets.

For example, the electrical contacts 275 of the bottom bar 240 may be biased (e.g., spring-loaded) away from the rear surface 246 and/or the electrical contacts 285 of the dock 280 may be biased (e.g., spring-loaded) away from the contact surface 284 to help establish and/or maintain the electrical contacts between the electrical contacts 275 of the bottom bar 240 and the electrical contacts 285 of the dock 280. While the electrical contacts 275 of the bottom bar 240 are oriented vertically and the electrical contacts 285 of the dock 280 are oriented horizontally as shown in FIGS. 12 and 14, the electrical contacts 275, 285 may be provided in different orientations, including non-vertical and non-horizontal orientations.

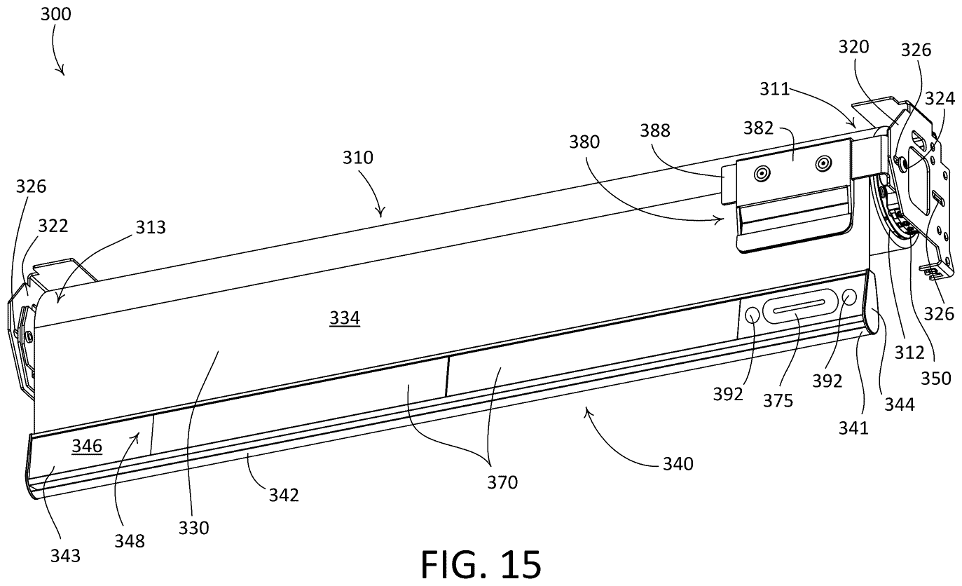

FIG. 15 is a rear perspective view of another example motorized window treatment 300, which may be deployed as one or more of the motorized window treatments 150 of the load control system 100. The motorized window treatment 300 may comprise a window treatment assembly 310 and one or more mounting brackets, such as first and second mounting brackets 320, 322. The first and second mounting brackets 320, 322 may be configured to be coupled to or otherwise mounted (e.g., wall-mounted and/or ceiling-mounted) to a structure (e.g., a window frame, a wall, or other structure of a building), such that the motorized window treatment 300 may be mounted proximate to an opening (e.g., a window). The window treatment assembly 310 may be coupled to (e.g., supported by) the first and second mounting bracket 320, 322. The window treatment assembly 310 may include a roller tube 312, a covering material 330, a bottom bar 340, a motor drive unit 350 at a first end 311 of the roller tube 312, and an idler (e.g., the idler 260) at a second end 313 of the roller tube 312. The motor drive unit 350 may be coupled to (e.g., fixedly coupled to) the first mounting bracket 320 and be rotatably coupled to the roller tube 312 at the first end 311 of the roller tube 312. The idler may be coupled to (e.g., fixedly coupled to) the second mounting bracket 322 and rotatably coupled to the roller tube 312 at the second end 313 of the roller tube 312.

The covering material 330 may be windingly attached to the roller tube 312. In some examples, a bottom end of the covering material 330 may be received within a housing 342 of the bottom bar 340 and secured to the bottom bar 340 inside the housing 342. The bottom bar 340 may comprise, for example, end caps 344 connected to the first and second ends 341, 343 of the bottom bar 340. The bottom bar 340 (e.g., the housing 342) may be configured, for example weighted, to cause the covering material 330 to hang vertically (e.g., to cover the window that is proximate to the motorized window treatment 300). The roller tube 312 of the window treatment assembly 310 may operate as a rotational element of the motorized window treatment 300. The roller tube 312 of the window treatment assembly 310 may be rotatably mounted to (e.g., rotatably supported by) the first and second mounting brackets 320, 322. Rotation of the roller tube 312 may cause the covering material 330 to wind around or unwind from the roller tube 312 to move the covering material 330 (e.g., the bottom bar 340) between a raised position P_{RAISED} (e.g., a fully-raised position and/or a fully-open position) and a lowered position P_{LOWERED} (e.g., a fully-lowered position and/or a fully-closed position).

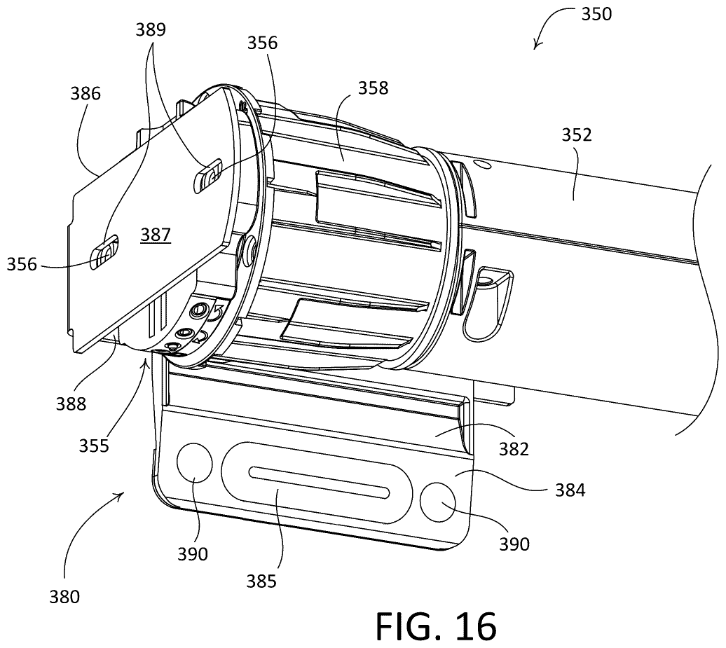

FIG. 16 is a partial enlarged perspective view of an example of the motor drive unit 350. The motor drive unit 350 may include an enclosure 352 for housing an internal motor (not shown) that may be coupled to a drive coupler (e.g., such as the drive coupler 254). The motor drive unit 350 may be configured to rotate the drive coupler for rotatably driving the roller tube 312. The motor drive unit 350 may further comprise an end portion 355 that may be coupled to (e.g., supported by) the first mounting bracket 320. For example, the end portion 355 may comprise one or more openings 356 that are configured to receive respective fasteners 324 (e.g., screws). The fasteners 324 may also be received though respective openings 326 in the first and second mounting brackets 320, 322. In some examples, the end portion 355 of the motor drive unit 350 may comprise additional openings (not shown) configured to allow the window treatment assembly 310 to be mounted to other mounting brackets (e.g., other than the first and second mounting brackets 320, 322). The openings 356 and the additional openings may be sized and/or located to allow the window treatment assembly 310 to be mounted to multiple types of mounting brackets (e.g., the first and second mounting brackets 320, 322 as well as other mounting brackets). The motor drive unit 350 may comprise a bearing assembly 358, which may be located adjacent to the end portion 355 and may be rotatably coupled to the roller tube 312.

As shown in FIG. 15, the bottom bar 340 may comprise one or more solar cells 370 (e.g., photovoltaic cells). The solar cells 370 may be attached to a rear surface 346 of the housing 342 of the bottom bar 340, such that the solar cells 370 face the window (e.g., that the covering material 330 is configured to cover) and are able to receive solar energy from outside the building (e.g., from the sun). The printed circuit board 272 may be received in the channels 271a, 271b in the housing 342, such that the outer surface 273 of the printed circuit board 272 forms at least a portion of the rear surface 346 of the bottom bar 340. The solar cells 370 may be mounted to the outer surface of the printed circuit board, and may be located within a recess 348 in the housing 342. The rear surface 346 of the housing 342 of the bottom bar 340 may be oriented at an angle from the vertical axis (e.g., such as the angle θ_{SC} at which the rear surface 246 of the bottom bar 240 is oriented from a vertical axis V as shown in FIG. 6), such that the solar cells 370 may be angled up (e.g., towards the sky to maximize the amount of sunlight that may shine on the solar cells 370).

The solar cells 370 may be electrically connected to one or more energy storage elements (not shown) contained within the housing 342 of the bottom bar 340. For example, the energy storage elements of the bottom bar 340 may comprise one or more of rechargeable batteries and/or supercapacitors. The solar cells 370 may be configured to convert the received solar energy into a photovoltaic output voltage, which may be used to charge the energy storage elements located within the housing 342 of the bottom bar 340 (e.g., to generate a storage voltage across the energy storage element). The energy stored in the energy storage elements of the bottom bar 340 may be discharged into the motor drive unit 350 when the bottom bar 340 is close to the motor drive unit 350, for example, when the bottom bar 340 is docked (e.g., when a covering material of the motorized window treatment is in the raised position P_{RAISED}). For example, the motor drive unit 350 may comprise one or more energy storage elements (not shown) configured to charge from the energy storage elements of the bottom bar 340 when the bottom bar 340 is in the raised position P_{RAISED}. For example, the energy storage elements of the motor drive unit 350 may comprise one or more of rechargeable batteries and/or supercapacitors.

The motor drive unit 350 may comprise a dock 380 that is configured to facilitate discharging of the energy storage elements of the bottom bar 340 into the energy storage elements of the motor drive unit 350, for example, when the bottom bar 340 is docked. The dock 380 may comprise a base portion 382 that may be located adjacent to a rear surface 334 of the covering material 330 (e.g., adjacent to the window) at the first end 311 of the roller tube 312. The base portion 382 of the dock 380 may define a contact surface 384 that may be configured to abut against the rear surface 346 of the bottom bar 340 when the bottom bar 340 is docked. The contact surface 384 of the base portion 382 may be oriented at approximately the angle θ_{SC} from the vertical axis (e.g., to match the rear surface 346 of the bottom bar 340).

The base portion 382 of the dock 380 may be electrically coupled to the motor drive unit 350. For example, the base portion 382 of the dock 380 may be electrically coupled to the motor drive unit 350 via two or more electrical conductors (e.g., wires) extending between the base portion 382 of the dock 380 and the end portion 355 of the motor drive unit 350. The dock 380 may be configured to facilitate inductive coupling (e.g., magnetic coupling) between the energy storage elements of the bottom bar 340 and the energy storage elements of the motor drive unit 350. The bottom bar 340 may comprise a first induction coil 375 at the first end 341 of the bottom bar 340. The first induction coil 375 on the bottom bar 340 may be configured to be inductively coupled to a second induction coil 385 on the contact surface 384 of the base portion 382 of the dock 380. The dock 380 may further comprise an attachment member 386 that extends from the end portion 355 of the motor drive unit 350 to the base portion 382. The attachment member 386 may comprise a plate 387 and an arm 388 that is oriented at an angle (e.g., approximately 90°) from the plate 387 (e.g., to bend the attachment member 386 behind the rear surface 334 of the covering material 330). The electrical conductors that extend between the base portion 382 of the dock 380 and the end portion 355 of the motor drive unit 350 may be located internal to or external to the attachment member 386. The plate 387 may comprise openings 389 through which the respective fasteners 324 may extend for coupling the window treatment assembly 310 to the first mounting bracket 320 (e.g., extending through the openings 356 in the first mounting bracket 320 and the openings 356 in the end portion 355 of the motor drive unit 350). For example, the plate 387 of the attachment member 386 may be affixed to and/or formed as a part of (e.g., integral with) the enclosure 352 and/or the end portion 355 of the motor drive unit 350. In some examples, the attachment member 386 may be affixed to and/or formed as a part of the first mounting bracket 320.

The first induction coil 375 of the bottom bar 340 may be configured to be inductively coupled to the second induction coil 385 of the dock 380 when the bottom bar 340 is docked. The first induction coil 375 of the bottom bar 340 may be electrically connected to the energy storage elements in the bottom bar 340, and the second induction coil 385 of the dock 380 may be electrically connected to the energy storage elements of the motor drive unit 350, such that that the energy storage elements of the motor drive unit 350 may charge from the energy storage elements of the bottom bar 340 via the inductive coupling when the bottom bar 340 is docked.

Since the motor drive unit 350 is powered from (e.g., entirely powered from) the solar cells 370 and is configured to wirelessly communicate with external devices, the window treatment assembly 310 may be mounted to essentially any mounting brackets—even mounting brackets for manually-operated window treatment assemblies. Accordingly, the window treatment assembly 310 may provide a retro-fit solution for upgrading a manually-operated window treatment to a motorized window treatment without the need to replace the mounting brackets and/or run electrical wiring to the new motorized window treatment.

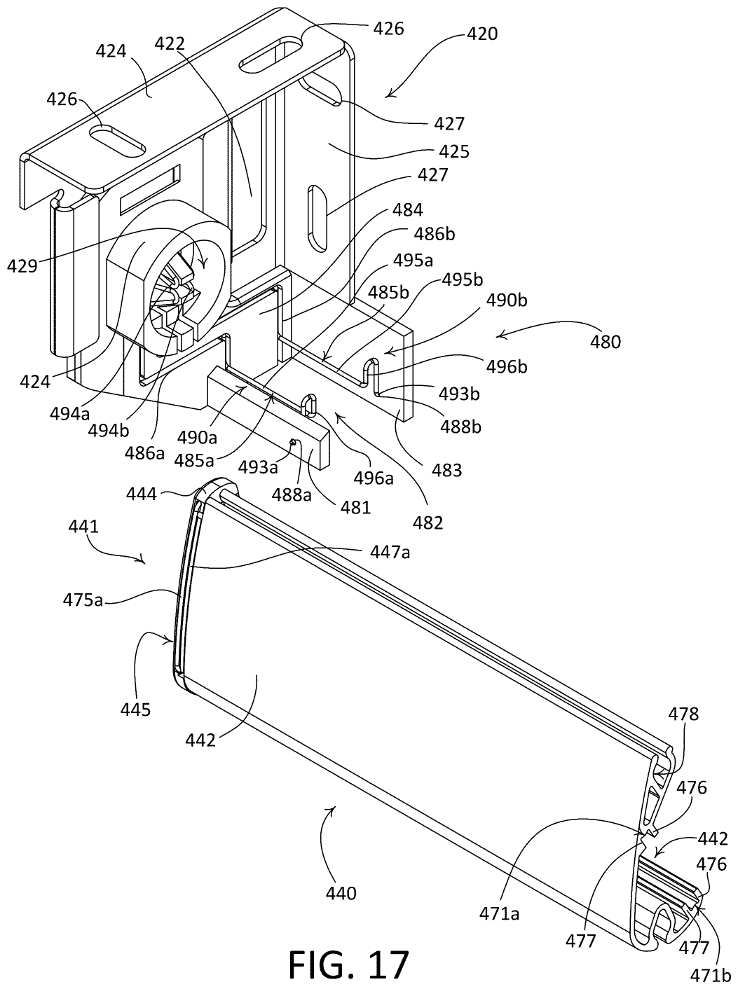

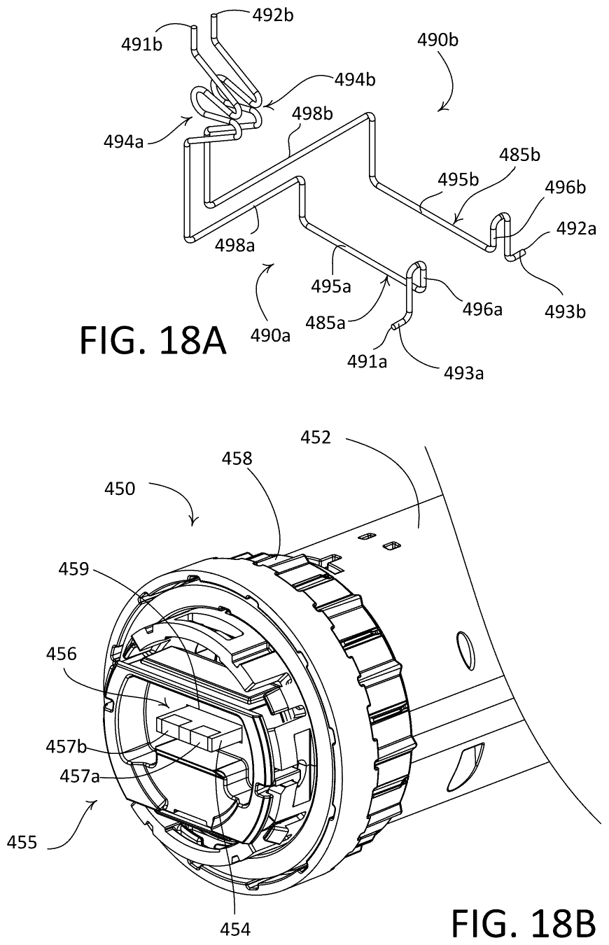

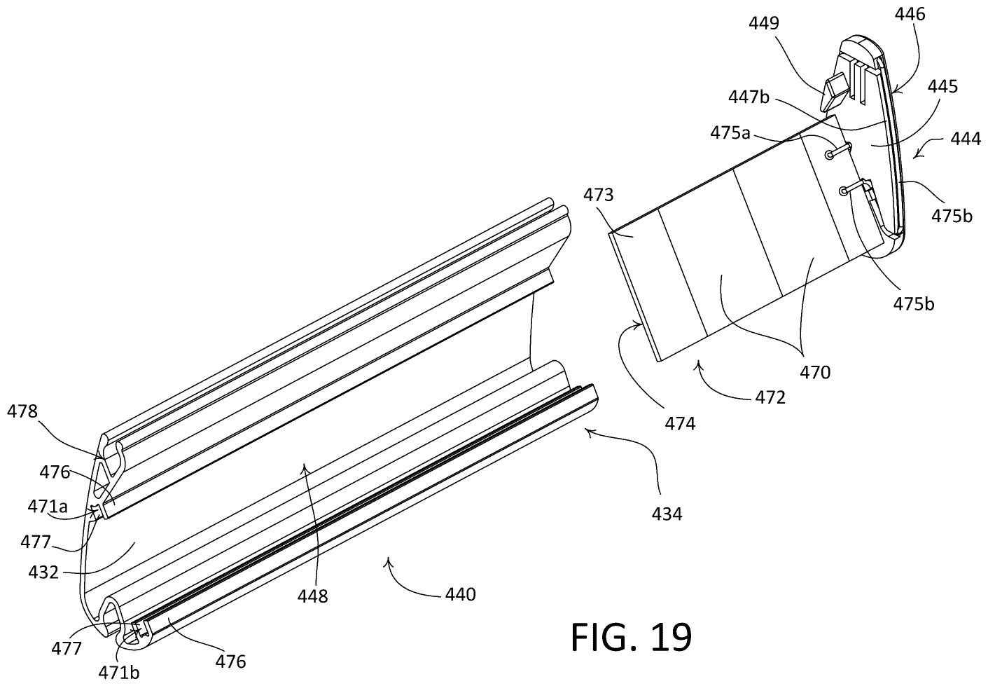

FIG. 17 is a front perspective view of a mounting bracket 420 and a portion of a bottom bar 440 of another example motorized window treatment, which may be deployed as one or more of the motorized window treatments 150 of the load control system 100. FIG. 18A is a perspective view of an example electrical contact structure of a dock of the motorized window treatment. FIG. 18B is a perspective view of an example motor drive unit 450 of the motorized window treatment. FIG. 19 is a rear perspective view of the bottom bar 440 of the motorized window treatment.

The motorized window treatment may include a window treatment assembly (e.g., such as the window treatment assembly 210 and/or the window treatment assembly 310), which may be coupled to (e.g., supported by) a first mounting bracket (e.g., the mounting bracket 420) and a second mounting bracket (not shown) of the motorized window treatment. The window treatment assembly may include a roller tube (e.g., such as the roller tubes 212, 312), a covering material (e.g., such as the covering materials 230, 330), the bottom bar 440, the motor drive unit 450 at a first end of the roller tube, and an idler (e.g., such as the idler 260) at a second end of the roller tube. As described in more detail below, the motor drive unit 450 may be coupled to (e.g., fixedly coupled to) the first mounting bracket (e.g., the mounting bracket 420) and rotatably coupled to the roller tube at the first end of the roller tube. The idler may be coupled to (e.g., fixedly coupled to) the second mounting bracket and rotatably coupled to the roller tube at the second end of the roller tube. Although not illustrated, the roller tube, the covering material and the idler of the motorized window treatment may be substantially similar to the roller tube, the covering material and the idler of the other motorized window treatments described herein.

The first mounting bracket (e.g., the mounting bracket 420) and the second mounting bracket may be configured to be coupled to or otherwise mounted to a structure. For example, each of the first and second mounting brackets may be configured to be mounted to (e.g., attached to) a window frame, a wall, or other structure of a building, such that the motorized window treatment may be mounted proximate to an opening (e.g., over the opening or in the opening), such as a window for example. The first and second mounting brackets may be configured to be mounted to a vertical structure (e.g., wall-mounted to a wall) and/or mounted to a horizontal structure (e.g., ceiling-mounted to a ceiling). The mounting bracket 420 may comprise a side wall 422, a first flange portion 424 (e.g., an upper flange portion), and a second flange portion 425 (e.g., a rear flange portion). The first flange portion 424 may comprise one or more openings 426 configured to receive fasteners (e.g., screws—not shown) for mounting the mounting bracket 420 to a horizontal structure (e.g., a ceiling). The second flange portion 425 may comprise one or more openings 427 configured to receive fasteners (e.g., screws—not shown) for mounting the mounting bracket 420 to a vertical structure (e.g., a wall).

The motor drive unit 450 may include an enclosure 452 for housing an internal motor (not shown) that may be coupled to a drive coupler (e.g., such as the drive coupler 254), which may engage the roller tube of the motorized window treatment in which the motor drive unit 450 is received. The motor drive unit 450 may be configured to rotate the drive coupler for rotatably driving the roller tube of the motorized window treatment. The motor drive unit 450 may further comprise an end portion 455 that may be coupled to (e.g., supported by) the mounting bracket 420. The mounting bracket 420 may comprise an attachment member 428 that may extend from the side wall 422 and may support the window treatment assembly of the motorized window treatment. For example, the attachment member 428 of the mounting bracket 420 may support an end portion of the window treatment assembly, such as the end portion 455 of the motor drive unit 450. For example, the end portion 455 of the motor drive unit 450 may be received in a recess 429 of the attachment member 428. The motor drive unit 450 may comprise a bearing assembly 458, which may be located adjacent to the end portion 455 and may be rotatably coupled to the roller tube.

The motorized window treatment may comprise a dock 480 that is configured to facilitate discharging of one or more energy storage elements of the bottom bar 440 into one or more energy storage elements of the motor drive unit 450, for example, when the bottom bar 440 is docked. For example, the dock 480 may be supported by the mounting bracket 420. In some examples, the dock 480 may be integral with the mounting bracket 420 (e.g., the mounting bracket 420 may comprise the dock 480). Although the second mounting bracket may be substantially similar to the first mounting bracket (e.g., the mounting bracket 420 shown in FIG. 17), the second mounting bracket may not include a respective dock (e.g., have a respective dock attached to or integral with the second mounting bracket). For example, the second mounting bracket may be a mirror image of the first mounting bracket (e.g., the mounting bracket 420), but without the dock 480 attached to or integral with the second mounting bracket. In some examples, the second mounting bracket may support the dock 480 such that the first mounting bracket 420 does not support the dock 480.

The dock 480 may comprise first and second electrical contacts 485a, 485b (e.g., horizontally-oriented contacts) and a base portion 482. The base portion 482 may comprise a front wall 481, a rear wall 483, and a body 484 extending between the front and rear walls 481, 483. The front wall 481 and the rear wall 483 of the base portion 482 may extend outward from the body 484. The first and second electrical contacts 485a, 485b may be located along the front and rear walls 481, 483 of the base portion 482.

The dock 480 may comprise first and second electrical contact structures 490a, 490b that may form the respective electrical contacts 485a, 485b. The first electrical contact structure 490a may include a first hook 493a located at a first end 491a of the first electrical contact structure 490a and a first clip 494a located at a second end 491b of the first electrical contact structure 490a. The first electrical contact structure 490a may comprise a first elongated portion 495a, that defines the first electrical contact 485a of the dock 480. The first electrical contact structure 490a may also define a first spring portion 496a located between the elongated portion 495a and the first hook 493a, and a first offset portion 498a located between the elongated portion 495a and the first clip 494a. The first offset portion 498a may comprise one or more horizontal, vertical, or diagonal portions. The first electrical contact structure 490a may be formed (e.g., bent) to define the first hook 493a, the first spring portion 496a, the first elongated electrical contact portion 495a, the first offset portion 498a, and the first clip 494a. Similarly, the second electrical contact structure 490b may include a second hook 493b located at a first end 492a of the second electrical contact structure 490b and a second clip 494b located at a second end 492b of the second electrical contact structure 490b. The second electrical contact structure 490b may comprise a second elongated portion 495b, that defines the second electrical contact 485b of the dock 480. The second electrical contact structure 490b may also define a second spring portion 496b located between the elongated portion 495b and the second hook 493b, and a second offset portion 498b located between the elongated portion 495b and the second clip 494b. The second offset portion 498b may comprise one or more horizontal, vertical, or diagonal portions. The second electrical contact structure 490b may be formed (e.g., bent) to define the second hook 493b, the second spring portion 496b, the second elongated electrical contact portion 495b, the second offset portion 498b, and the second clip 494b.

The first and second electrical contact structure 490a, 490b may be, at least partially, disposed in first and second channels 486a, 486b, respectively, in the body 484 of the base portion 482. For example, the first and second offset portions 498a, 498b of the first and second electrical contact structure 490a, 490b may extend through the first and second channels 486a, 486b, respectively, in the body 484 of the base portion 482. The first and second channels 486a, 486b may be formed within the body 484 of the base portion 482, which may be supported by the mounting bracket 420. The first and second channels 486a, 486b may extend between the front wall 481 and the rear wall 483 of the base portion 482, respectively, and the attachment member 428 of the mounting bracket 420. As described in more detail below, the clips 494a, 494b may be disposed in the attachment member 428, and the attachment member 428 may be configured to receive the motor drive unit 450 such that the clips 494a, 494b make electrical connections with the motor drive unit 450.

The first and second hooks 493a, 493b may be received in respective openings 488a, 488b in the front wall 481 and the rear wall 483 of the base portion 482. As such, the first and second elongated electrical contact portions 495a, 495b may be disposed adjacent to the front wall 481 and the rear wall 483 of the base portion 482, respectively. As described in more detail below, the base portion 482 may be configured to receive the bottom bar 440 between the front wall 481 and the rear wall 483 when the bottom bar 440 is in the fully-raised position. The first and second spring portions 496a, 496b may allow the first and second elongated portions 495a, 495b to be displaced towards the front wall 481 and the rear wall 483 of the base portion 482, respectively, when the bottom bar 440 is received within the dock 480.

As noted herein, the motor drive unit 450 may comprise a printed circuit board 454. The one or more energy storage elements of the motor drive unit 450 may be mounted to and/or electrically connected to the printed circuit board 454. For example, the one or more energy storage elements may comprise one or more of rechargeable batteries and/or supercapacitors. An exposed portion 456 of the printed circuit board 454 may extend through an opening 459 in (e.g., out of) the end portion 455 of the enclosure 452. The exposed portion 456 of the printed circuit board 454 may include a first electrical pad 457a and a second electrical pad 457b. When the end portion 455 of the motor drive unit 450 is coupled to (e.g., supported by) the attachment member 428 of the first mounting bracket 420, the first and second electrical pads 457a, 457b may be configured to be electrically connected to the first and second electrical contact structures 490a, 490b, respectively, of the dock 480. For example, when the first end of the motor drive unit 450 is pressed into the recess of the attachment member 428, the first electrical pad 457a may be configured to be received by the first clip 494a and the second electrical pad 457b may be received by the second clip 494b. For instance, each of the first and second clips 494a, 494b may form a press fit connection with the first and second electrical pads 457a, 457b, respectively, when the motor drive unit 450 is coupled with the attachment member 428. Therefore, when the motor drive unit 450 is coupled to the first mounting bracket 420 (e.g., via the attachment member 428), the printed circuit board 454 of the motor drive unit 450 may be electrically connected to the first and second electrical contact structures 490a, 490b of the dock 480.

The bottom bar 440 may include a housing 442. The bottom bar 440 may be defined by a first end 441 and a second end. Note that only a portion of the bottom bar 440 is shown in FIGS. 17 and 19. The housing 442 of the bottom bar 440 may define a first cavity 478 that may be configured to receive the bottom end of the covering material of the motorized window treatment. For example, the bottom end of the covering material may be attached to an elongated member (not shown) that may extend through the first cavity 478 (e.g., the from the first end 441 to the second end of the housing 442) and may prevent the bottom end of the covering material from being removed from the first cavity 478.

The bottom bar 440 may have an end cap 444, for example at the first end 441 of the bottom bar 440. Although not illustrated, in some examples the bottom bar 440 may also have an end cap at the second end. The end cap 444 may define an interior surface 445 and an exterior surface 446, for example opposite the interior surface 445. For example, the interior surface 445 of the end cap 444 may include a post 449, as shown in FIG. 19. The post 449 may be configured to be inserted into the first cavity 478 of the housing 442 at the first end 441 of the bottom bar 440, for example with a friction fit, to secure the end cap 444 to the bottom bar 440. The end cap 444 may also define an inner edge 447a and an outer edge 447b that both remain exposed outside of the housing 442 when the end cap 444 is installed at the first end 441 of the bottom bar 440.

The bottom bar 440 may include a recess 448 in the housing 442 that is configured to receive a printed circuit board 472. The printed circuit board 472 may comprise an outer surface 473 and an opposing inner surface 474. The bottom bar 440 may include first and second channels 471a, 471b for receiving the printed circuit board 472. The first and second channels 471a, 471b may be formed by respective flange portions 476 and inner surfaces 477 of the bottom bar 440. (e.g., each of the first and second channels 471a, 471b may be formed by respective flange portions 476 and respective inner surfaces 477). The printed circuit board 472 may be received in the channels 471a, 471b and located in the recess 448, such that the outer surface 473 of the printed circuit board 472 forms a rear surface of the bottom bar 440. For example, the printed circuit board 472 may be configured to slide into the recess 448 (e.g., via the channels 471a, 471b) from either the first end 441 or the second end of the bottom bar 440. The printed circuit board 472 may be received into the recess 448, for example when the end cap 444 is removed from the bottom bar 440. The printed circuit board 472 may be configured to extend a length or most of the length from the first end 441 and the second end of the bottom bar 440. When the printed circuit board 472 is received in the channels 471a, 471b, the outer surface 473 of the printed circuit board 472 may be located adjacent to the flange portions 476 and the inner surface 474 of the printed circuit board 472 may be located adjacent to the inner surfaces 477 of the bottom bar 440. When the printed circuit board 472 is received in the channels 471a, 471b, the housing 442 and the printed circuit board 472 (e.g., the inner surface 474 of the printed circuit board 472) may define a second cavity (e.g., such as the second cavity 279 of the bottom bar 240 shown in FIG. 13).

The bottom bar 440 may comprise one or more solar cells 470 (e.g., photovoltaic cells). The solar cells 470 may be disposed on the outer surface 473 of the printed circuit board 472. For example, the printed circuit board 472 (e.g., and thus the solar cells 470) may be mounted at the angle θ_{SC} from the vertical axis V. Additionally, or alternatively, the solar cells 470 may be disposed on the housing 442 and/or on one or more substrates that are separate from the printed circuit board 472 and are received in the channels 471a, 471b (e.g., in line with the printed circuit board 472).

The solar cells 470 of the bottom bar 440 may be electrically connected to the one or more energy storage elements, which may be contained within the housing 442 of the bottom bar 440 (e.g., within the second cavity defined by the printed circuit board 472 and the housing 442). The energy storage elements of the bottom bar 440 may comprise, for example, one or more of rechargeable batteries and/or supercapacitors. For example, the energy storage elements of the bottom bar 440 may be located on (e.g., mounted to) the printed circuit board 472 and/or otherwise located within the housing 442 of the bottom bar 440. The solar cells 470 may be configured to convert the received solar energy into a photovoltaic output voltage, which may be used to charge the energy storage elements located within the housing 442 of the bottom bar 440 (e.g., to generate a storage voltage across the energy storage elements). The energy stored in the energy storage elements of the bottom bar 440 may be discharged into the one or more energy storage elements of the motor drive unit 450 when the bottom bar 440 is close to the motor drive unit 450, for example, when the bottom bar 440 in the raised position P_{RAISED} (e.g., the fully-raised position). For example, the energy storage elements of the motor drive unit 450 may be configured to charge from the energy storage elements of the bottom bar 440 via the dock 480 when the covering material is in the raised position P_{RAISED}. For example, the energy storage elements of the motor drive unit 450 may comprise one or more of rechargeable batteries and/or supercapacitors.

The bottom bar 440 may include a first electrical contact 475a and a second electrical contact 475b. For example, the first and second electrical contacts 475a, 475b may be located on the end cap 444 of the bottom bar 440. A first end of the first electrical contact 475a may be electrically coupled to the printed circuit board 472 (e.g., and the one or more solar cells 470). The first electrical contact 475a may extend at least partially around the inner edge 447a of the end cap 444 (e.g., as shown in FIG. 17). A first end of the second electrical contact 475b may be electrically coupled to the printed circuit board 472 (e.g., and the one or more solar cells 470). The second electrical contact 475b may extend at least partially around the outer edge 447b of the end cap 444 (e.g., as shown in FIG. 19). The first and second electrical contacts 475a, 475b may be exposed around the inner edge 447a and the outer edge 447b of the end cap 444, respectively, so that the first and second electrical contacts 475a, 475b can contact the first and second elongated portions 495a, 495b of the first and second electrical contact structures 490a, 490b, respectively, of the dock 480.

In the illustrated examples, the dock 480 may comprise two electrical contacts 485a, 485b, for example where the two electrical contacts 485a, 485b are used for the delivery of power from the bottom bar 440 to the motor drive unit 450. In some examples, the bottom bar 440 and the motor drive unit 450 may be configured to communicate with each other wirelessly (e.g., via a wireless connection) and/or via the two electrical contacts 485a, 485b on the dock 480 and the two electrical contacts 475a, 475b of the bottom bar 440 (e.g., via a wired connection). The number of electrical contacts of the dock 480 may be the same as the number of electrical contacts of the bottom bar 440. In some examples, the dock 480 may comprise four electrical contacts, such as two electrical contacts that are electrically connected to an energy storage element (e.g., a storage voltage) and two electrical contacts that are connected for communication. For example, the dock 480 may include four electrical contacts, for instance, where two of the electrical contacts (e.g., the first and second electrical contacts 485a, 485b) may be used to deliver power from the bottom bar 440 to the motor drive unit 450, while the other two electrical contacts (not shown) can be used to enable communication between the bottom bar 440 and the motor drive unit 450 (e.g., digital communication). For example, when the bottom bar 440 is docked with the dock 480, the first electrical contact 485a of the dock 480 may be in electrical contact with the first electrical contact 475a of the bottom bar 440, the second electrical contact 485b of the dock 480 may be in electrical contact with the second electrical contact 475b of the bottom bar 440, a third electrical contact (not shown) of the dock 480 may be in electrical contact with the a third electrical contact (not shown) of the bottom bar 440, and a fourth electrical contact (not shown) of the dock 480 may be in electrical contact with a fourth electrical contact (not shown) of the bottom bar 440.

When the covering material of the motorized window treatment is in the raised position P_{RAISED}, the bottom bar 440 may be received by the dock 480. For example, when the covering material of the motorized window treatment is in the raised position P_{RAISED}, the end cap 434 of the bottom bar 440 may be configured to reside between the front wall 481 and the rear wall 483 of the base portion 482 of the dock 480. When the end cap 434 resides between the front wall 481 and the rear wall 483 of the base portion 482 of the dock 480, the first electrical contact 475a of the bottom bar 40 may be in contact with the first elongated portion 495a of the first electrical contact structure 490a, and the second electrical contact 475b of the bottom bar 440 may be in contact with the second elongated portion 495b of the second electrical contact structure 490b. The first and second spring portions 496a, 496b may be configured to flex and may bias the first and second elongated portions 495a, 495b towards the first and second electrical contacts 475a, 475b of the bottom bar 440, respectively, for example, so that the first and second elongated portions 495a, 495b establish a secure electrical connection with the first and second electrical contacts 475a, 475b of the bottom bar 440, respectively. As such, when the covering material of the motorized window treatment is in the raised position P_{RAISED}, the first and second electrical contacts 475a, 475b of the bottom bar 440 may be electrically connected to the first and second electrical contact structures 490a, 490b of the dock 480.

Further, as noted above, the first and second clips 494a, 494b of the first and second electrical contact structures 490a, 490b of the dock 480 may be electrically connected to the first and second electrical pads 457a, 457b of the printed circuit board 454 of the motor drive unit 450, respectively. Therefore, when the covering material of the motorized window treatment is in the raised position P_{RAISED}, the one or more energy storage elements of the bottom bar 440 may be configured to discharge through the dock 480 into one or more energy storage elements of the motor drive unit 450. Therefore, the one or more energy storage elements of the motor drive unit 450 may charge from the one or more energy storage elements of the bottom bar 440 via the dock 480 when the covering material is in the raised position P_{RAISED}.

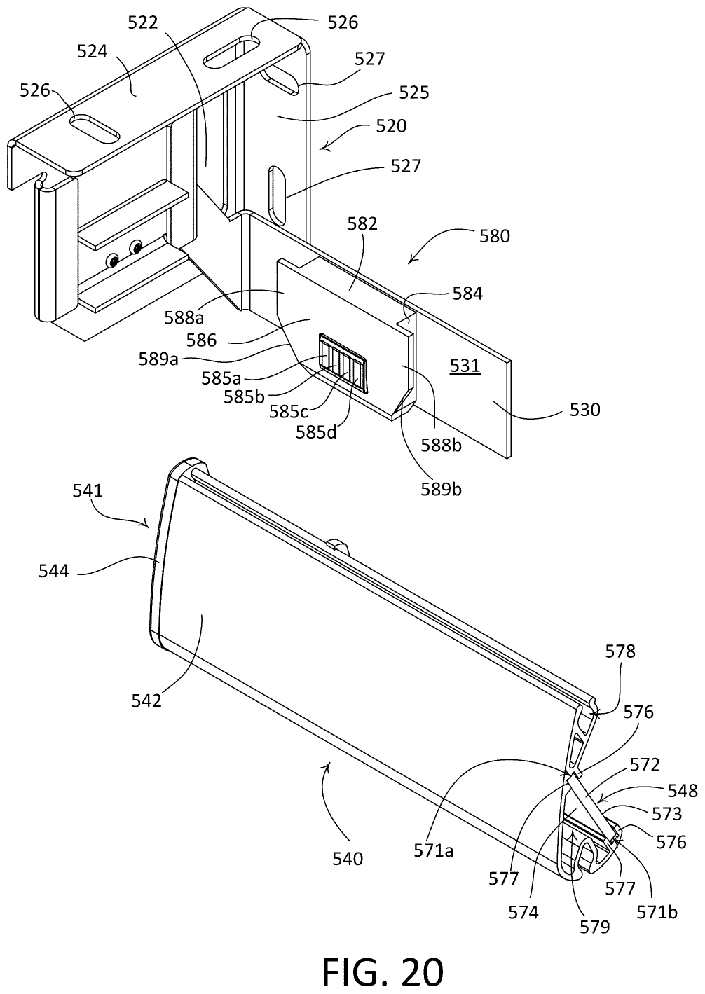

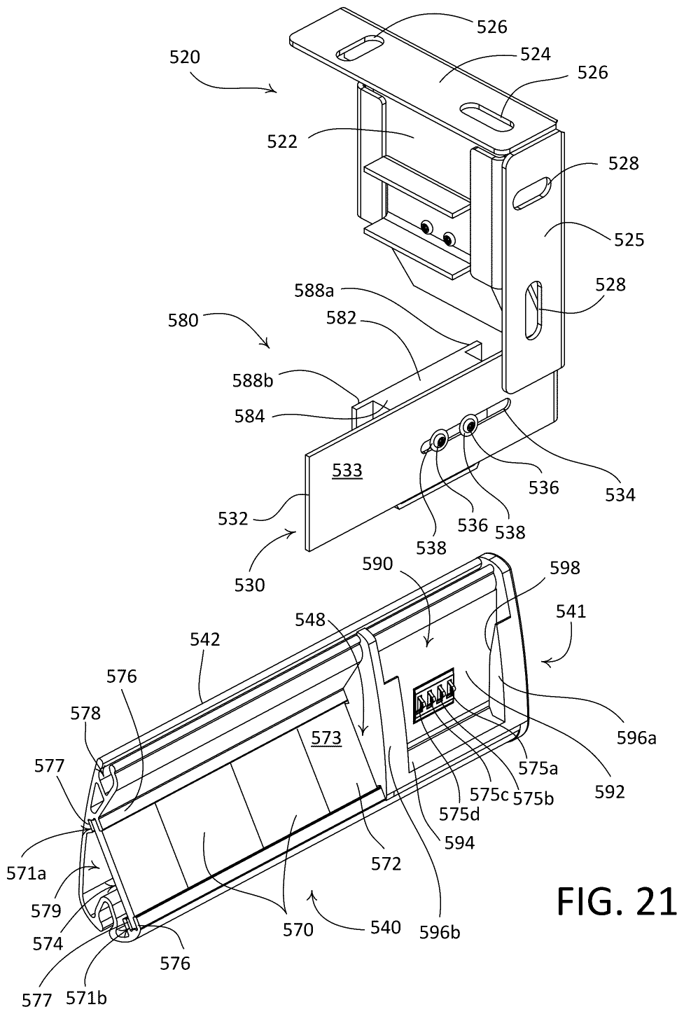

FIG. 20 is a front perspective view of a mounting bracket 520 and a portion of a bottom bar 540 of another example motorized window treatment, which may be deployed as one or more of the motorized window treatments 150 of the load control system 100. FIG. 21 is a rear perspective view of the mounting bracket 520 and the bottom bar 540 of FIG. 20.

The motorized window treatment may include a window treatment assembly (e.g., such as the window treatment assembly 210 and/or the window treatment assembly 310), which may be coupled to (e.g., supported by) a first mounting bracket (e.g., the mounting bracket 520) and a second mounting bracket (not shown) of the motorized window treatment. The window treatment assembly may include a roller tube (e.g., such as the roller tubes 212, 312), a covering material (e.g., such as the covering materials 230, 330), the bottom bar 540, a motor drive unit (e.g., such as the motor drive units 250, 350, 450) at a first end of the roller tube, and an idler (e.g., such as the idler 260) at a second end of the roller tube. The motor drive unit may be coupled to (e.g., fixedly coupled to) the first mounting bracket 520 and be rotatably coupled to the roller tube at the first end of the roller tube. The idler may be coupled to (e.g., fixedly coupled to) the second mounting bracket and rotatably coupled to the roller tube at the second end of the roller tube. Although not illustrated, the motor drive unit, the roller tube, the covering material and the idler of the motorized window treatment may be substantially similar to the motor drive unit, the roller tube, the covering material and the idler of the other motorized window treatments described herein.

The first mounting bracket (e.g., the mounting bracket 520) and the second mounting bracket may be configured to be coupled to or otherwise mounted to a structure. For example, each of the first and second mounting brackets may be configured to be mounted to (e.g., attached to) a window frame, a wall, or other structure of a building, such that the motorized window treatment may be mounted proximate to an opening (e.g., over the opening or in the opening), such as a window for example. The first and second mounting brackets may be configured to be mounted to a vertical structure (e.g., wall-mounted to a wall) and/or mounted to a horizontal structure (e.g., ceiling-mounted to a ceiling). The mounting bracket 520 may include a side wall 522, a first flange portion 524 (e.g., an upper flange portion), and a second flange portion 525 (e.g., a rear flange portion). The first flange portion 524 may comprise one or more openings 526 configured to receive fasteners (e.g., screws—not shown) for mounting the mounting bracket 520 to a horizontal structure (e.g., a ceiling). The second flange portion 525 may comprise one or more openings 527 configured to receive fasteners (e.g., screws—not shown) for mounting the mounting bracket 520 to a vertical structure (e.g., a wall). The mounting bracket 520 may include an attachment member (e.g., such as the attachment member 428) that may extend from the side wall 522 and may support the window treatment assembly of the motorized window treatment. For example, the attachment member of the mounting bracket 520 may support an end portion of the window treatment assembly (e.g., such as the end portion 455 of the motor drive unit 450).

The motorized window treatment may comprise a dock 580 that is configured to facilitate discharging of one or more energy storage elements of the bottom bar 540 into one or more energy storage elements of the motor drive unit, for example, when the bottom bar 540 is docked. For example, the dock 580 may be supported by the mounting bracket 520. In some examples, the dock 580 may be integral with the mounting bracket 520 (e.g., the mounting bracket 520 may comprise the dock 580). Although the second mounting bracket may be substantially similar to the first mounting bracket (e.g., the mounting bracket 520 shown in FIGS. 20 and 21), the second mounting bracket may not include a respective dock (e.g., have a respective dock attached to or integral with the second mounting bracket). For example, the second mounting bracket may be a mirror image of the first mounting bracket (e.g., the first mounting bracket 520), but without the dock 580 mounted to or integral with the second mounting bracket. In some examples, the second mounting bracket may support the dock 580 such that the first mounting bracket 520 does not support the dock 580.

The dock 580 may comprise a base portion 582 that may be connected to and extend from an arm 530. The arm 530 may extend from the mounting bracket 520. The arm 530 may include a front surface 531 and a rear surface 533 that is opposite the front surface 531. For example, the base portion 582 may be connected to the arm 530, for example through a slot 534 in the arm 530. The base portion 582 may be connected to the arm 530 using one or more fasteners 536 (e.g., screws) that extend through a slot 534 in the arm 530 to secure the base portion 582 to the arm 530. In some examples, a respective washer 538 may be disposed about a long axis of each of the fasteners 536, for example such that the respective washer 538 is disposed against the rear surface 533 of the arm 530. The fasteners 536 may be loosened to allow the base portion 582 to be moved along the slot 534, for example, to ensure proper docking of a bottom bar 540 of the motorized window treatment with the dock 580, as described in more detail herein. Additionally, or alternatively, a respective spring (not shown) may also be disposed along the long axis of each of the fasteners 536 between the respective washer 538 and the arm 530. The springs may enable the base portion 582 to be spring-biased with respect to the arm 530 to facilitate docking, for example with the bottom bar 540.

The base portion 582 may include an offset portion 584 and a face 586. The dock 580 may comprise a plurality of electrical contacts 585a-585d located on the face 586 of the base portion 582. The face 586 of the base portion 582 may be offset from the front surface 531 of the arm 530 of the dock 580 by the offset portion 584. The face 586 may define a first flange portion 588a and a second flange portion 588b. The first flange portion 588a and the second flange portion 588b may reside on opposite sides of the face 586 of the base portion 582. The first and second flange portions 582a, 582b may be tapered. For example, the first and second flange portion 582a, 582b may comprise respective tapered edges 589a, 589b. As described in more detail below, the offset of the face portion 585 and the tapering of the first and second flange portions 582a, 582b may facilitate the docking of the bottom bar 540 with the dock 580.

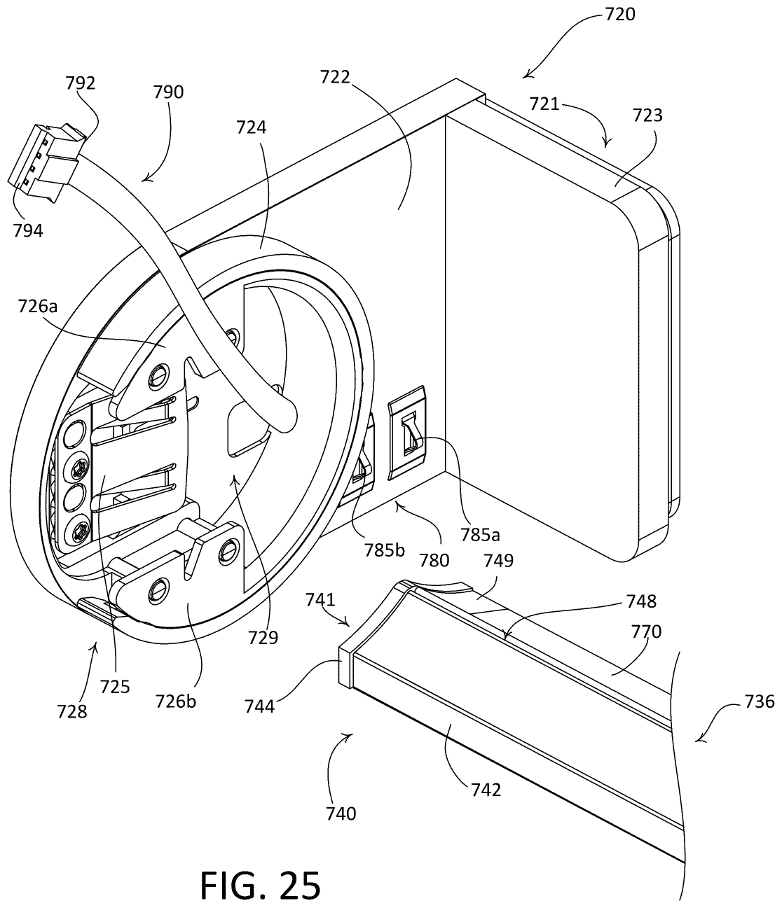

The plurality of electrical contacts 585a-585d may be located on the face 586 of the base portion 582. The bottom bar 540 may comprise a plurality of electrical contacts 575a-575d. The plurality of electrical contacts 585a-585d may be configured to be electrically connected to the plurality of electrical contacts 575a-575d of the bottom bar 540. In the illustrated examples, the dock 580 may include four electrical contacts 585a-585d where, for instance, two of the electrical contacts may be used to deliver power from the bottom bar 540 to the motor drive unit (e.g., and/or vice versa), while the other two electrical contacts can be used to enable communication between the bottom bar 540 and the motor drive unit (e.g., digital communication). Although not illustrated, in some examples, the electrical contacts 585a-585d of the dock 580 may be electrically coupled to the motor drive unit of the motorized window treatment (such as the end portion) via four electrical conductors (e.g., two wires for power and two wires for communications) or via a cable (e.g., a cable having four wires, such as cable 790 illustrated in FIG. 25).

The bottom bar 540 may include a housing 542. The bottom bar 540 may be defined by a first end 541 and a second end. Note that only a portion of the bottom bar 540 is shown in FIGS. 20 and 21. The housing 542 of the bottom bar 540 may define a first cavity 578 that may be configured to receive the bottom end of the covering material of the motorized window treatment. For example, the bottom end of the covering material may be attached to an elongated member (not shown) that may extend through the first cavity 578 (e.g., the from the first end 541 to the second end of the housing 542) and may prevent the bottom end of the covering material from being removed from the first cavity 578. The bottom bar 540 may have an end cap 544, for example, at the first end 541 of the bottom bar 540. For example, the end cap 544 may be integral (e.g., connected to) the housing 542 of the bottom bar 540. Although not illustrated, in some examples the bottom bar 540 may have an end cap (e.g., such as the end cap 444) at the second end. The bottom bar 540 may include a recess 548 in the housing 542 that is configured to receive a printed circuit board 572. The printed circuit board 572 may comprise an outer surface 573 and an opposing inner surface 574. The bottom bar 540 may include first and second channels 571a, 571b for receiving the printed circuit board 572. The first and second channels 571a, 571b may be formed by respective flange portions 576 and inner surfaces 577 of the bottom bar 540 (e.g., each of the first and second channels 571a, 571b may be formed by respective flange portions 576 and respective inner surfaces 577).

The printed circuit board 572 may be received in the channels 571a, 571b and located in the recess 548, such that the outer surface 573 of the printed circuit board 572 forms a rear surface of the bottom bar 540. For example, the printed circuit board 572 may be configured to slide into the recess 548 (e.g., via the channels 571a, 571b) from the second end of the bottom bar 540. The printed circuit board 572 may slide into the recess 548, for example when the end cap located at the second end is removed from the bottom bar 540. The printed circuit board 572 may be configured to extend a length from the second end of the bottom bar 540 to approximately the first end 541 of the bottom bar 540. When the printed circuit board 572 is received in the channels 571a, 571b, the outer surface 573 of the printed circuit board 572 may be located adjacent to the flange portions 576 and the inner surface 574 of the printed circuit board 572 of the printed circuit board 572 may be located adjacent to the inner surfaces 577 of the bottom bar 540. The housing 542 and the printed circuit board 572 (e.g., the inner surface 574 of the printed circuit board 572) may define a second cavity 579.

The bottom bar 540 may comprise one or more solar cells 570 (e.g., photovoltaic cells). The solar cells 570 may be disposed on the outer surface 573 of the printed circuit board 572. For example, the printed circuit board 572 (e.g., and thus the solar cells 570) may be mounted at the angle θ_{SC} from the vertical axis V. Additionally, or alternatively, the solar cells 570 may be disposed on the housing 542 and/or on one or more substrates that are separate from the printed circuit board 572 and are received in the channels 571a, 571b (e.g., in line with the printed circuit board 572). The solar cells 570 of the bottom bar 540 may be electrically connected to the one or more energy storage elements, which may be contained within the housing 542 of the bottom bar 540 (e.g., within the second cavity 579). The energy storage elements of the bottom bar 540 may comprise, for example, one or more of rechargeable batteries and/or supercapacitors. For example, the energy storage elements of the bottom bar 540 may be located on (e.g., mounted to) the printed circuit board 572 and/or otherwise located within the housing 542 of the bottom bar 540. The solar cells 570 may be configured to convert the received solar energy into a photovoltaic output voltage, which may be used to charge the energy storage elements located within the housing 542 of the bottom bar 540 (e.g., to generate a storage voltage across the energy storage element). The energy stored in the energy storage elements of the bottom bar 540 may be discharged into the one or more energy storage elements of the motor drive unit when the bottom bar 540 is close to the motor drive unit, for example, when the bottom bar 540 in the raised position P_{RAISED} (e.g., the fully-raised position). For example, the energy storage elements of the motor drive unit be configured to charge from the energy storage elements of the bottom bar 540 via the dock 580 when the covering material is in the raised position P_{RAISED}. For example, the energy storage elements of the motor drive unit may comprise one or more of rechargeable batteries and/or supercapacitors.

The bottom bar 540 may comprise a pocket 590 at the first end 541. The pocket 590 may include a rear wall 592, a bottom wall 594, and first and second guiding member 596a, 596b. The plurality of electrical contacts 575a-575d of the bottom bar 540 may be located within the pocket 590. As described herein, the pocket 590 may be configured to receive the base portion 582 of the dock 580 so that the plurality of electrical contacts 575a-575d of the bottom bar 540 may be electrically connected to the plurality of electrical contacts 585a-585d of the base portion 582. The plurality of electrical contacts 575a-575d may be located on the rear wall 592 of the pocket 590. In some examples, the plurality of electrical contacts 575a-575d may be spring contacts that are biased outward and configured to be compressed inward towards the rear wall 592 of the pocket 590 when a force is applied to the electrical contacts 575a-575d, such as when the base portion 582 of the dock 580 is positioned within the pocket 590. The spring-biasing of the electrical contacts 575a-575d may allow for easier docking of the base portion 582 of the dock 580 with the pocket 590 of the bottom bar 540. The spring-biasing of the electrical contacts 575a-575d may facilitate docking of the bottom bar 540, for example, since the outward bias of the electrical contacts 575a-575d may ensure a strong electrical connection with the electrical contacts 585a-585d of the base portion.

In the illustrated examples, the dock 580 may comprise four electrical contacts 585a-585d where, for instance, two of the electrical contacts 585a-585d may be used to deliver power from the bottom bar 540 to the motor drive unit, while the other two electrical contacts 585a-585d can be used to enable communication between the bottom bar 540 and the motor drive unit (e.g., digital communication). For example, when the bottom bar 540 is docked with the dock 580, the first electrical contact 585a of the dock 580 may be in electrical contact with the first electrical contact 575a of the bottom bar 540, the second electrical contact 585b of the dock 580 may be in electrical contact with the second electrical contact 575b of the bottom bar 540, the third electrical contact 585c of the dock 580 may be in electrical contact with the third electrical contact 575c of the bottom bar 540, and the fourth electrical contact 585d of the dock 580 may be in electrical contact with the fourth electrical contact 575d of the bottom bar 540. However, in other examples, the dock 580 may comprise two electrical contacts and the bottom bar 540 may comprise two electrical contacts, where the two electrical contacts are used for the delivery of power from the bottom bar 540 to the motor drive unit. In some examples, the bottom bar 540 and the motor drive unit may be configured to communicate with each other wirelessly (e.g., via a wireless connection) and/or via the two electrical contacts on the dock 580 and the two electrical contacts of the bottom bar 540 (e.g., via a wired connection). The number of electrical contacts of the dock 580 may be the same as the number of electrical contacts of the bottom bar 540. Docking may include when the bottom bar 540 is positioned adjacent to the dock 580 such that the base portion 582 is received in the pocket 590 of the bottom bar and the electrical contacts 585a-585d of the dock 580 are in electrical contact with the electrical contacts 575a-575d of the bottom bar 540.

The bottom wall 594 and the first and second guiding members 596a, 596b of the pocket 590 may facilitate the insertion of the base portion 582 into the pocket 590. For instance, the bottom wall 594 may be configured to stop upward motion of the bottom bar 540 when the bottom bar 540 docks with the dock 580 and the base portion 582 of the dock 580 contacts the bottom wall 594 of the pocket 590. The guiding members 596a, 596b of the pocket 590 may be configured to guide the base portion 582 into the pocket 590 such that there is electrical contact between the electrical contacts 585a-585d of the dock 580 and the electrical contacts 575a-575d of the pocket 590. For example, the guiding members 596a, 596b may guide the pocket 590 to surround the base portion 582 of the dock 580 as the bottom bar 540 moves toward the dock 580. The guiding members 596a, 596b of the pocket 590 may comprise respective sloped surfaces 598 configured to engage the respective flange portions 582a, 582b of the base portion 582 such that the bottom bar 540 docks with the dock 580. Note that while only the sloped surface 598 of the guiding member 596a is shown in FIG. 21, the other guiding member 596b may also have a similarly-shaped sloped surface. The tapered edges 589a, 589b of the flange respective portions 582a, 582b may help guide the base portion 582 to be received within the pocket 590. For example, the flange portions 582a, 582b may press against the guiding members 596a, 596b such that electrical contact is established between the electrical contacts 585a-585d of the dock 580 and the electrical contacts 575a-575d of the pocket 590. The offset portion 584 of the base portion 582 may have a width approximately equal to a width of the guiding members 596a, 596b. For example, the width of the guiding members 596a, 596b may be slightly larger than the width of the offset portion 584 of the base portion such that the base portion 582 of the dock 580 may be slid into the pocket 590 of the bottom bar 540. Alternatively, offset portion 584 of the base portion 582 may be slightly larger than the width of the guiding members 596a, 596b such that the base portion 582 of the dock 580 may be slid into the pocket 590 of the bottom bar 540. Finally, as noted above, the position of the base portion 582 along the arm 530 can be adjusted along the slot 534, if needed, as noted above. For example, a position of the base portion 582 may be selected along a length of the arm 530 such that the base portion 582 is aligned with the pocket 590 (e.g., horizontally along the length of the arm 530). The position of the base portion 582 may be adjusted (e.g., to the position selected) by a user, for example during installation of the motorized window treatment. Additionally or alternatively, a position of the bottom bar 540 may be selected and adjusted by a user (e.g., during installation) such that the pocket 590 of the bottom bar aligns with the base portion 582 of the dock 580.

Accordingly, when the covering material of the motorized window treatment is in the raised position P_{RAISED}, the base portion 582 of the dock 580 may be received by the pocket 590 of the bottom bar 540. Therefore, when the covering material of the motorized window treatment is in the raised position P_{RAISED}, the one or more energy storage elements of the bottom bar 540 may be configured to discharge through the dock 580 into the one or more energy storage elements of the motor drive unit. Therefore, the one or more energy storage elements of the motor drive unit may charge from the energy storage elements of the bottom bar 540 via the dock 580 when the covering material is in the raised position P_{RAISED}.

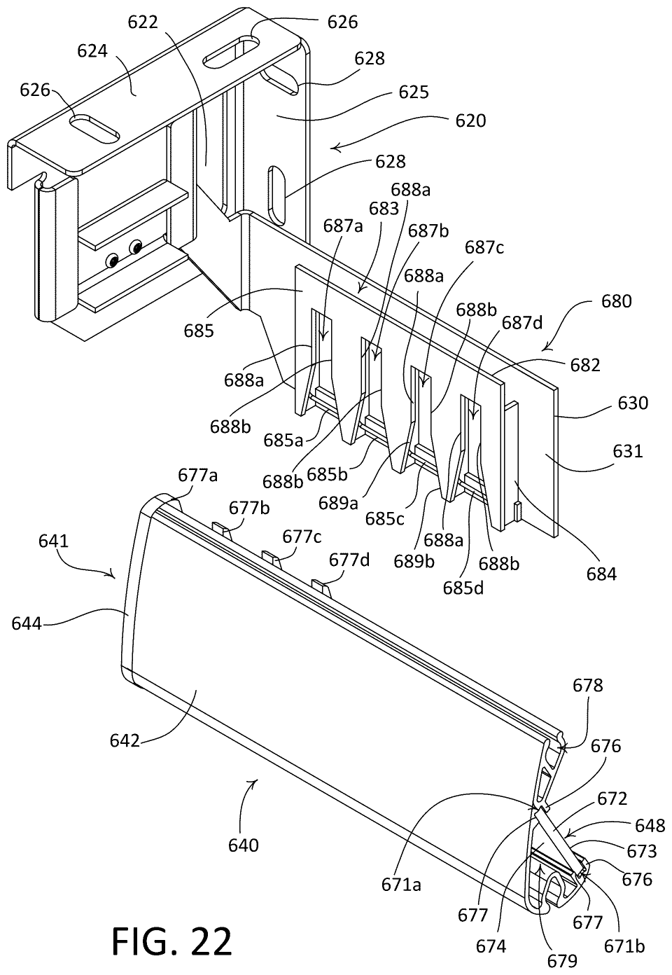

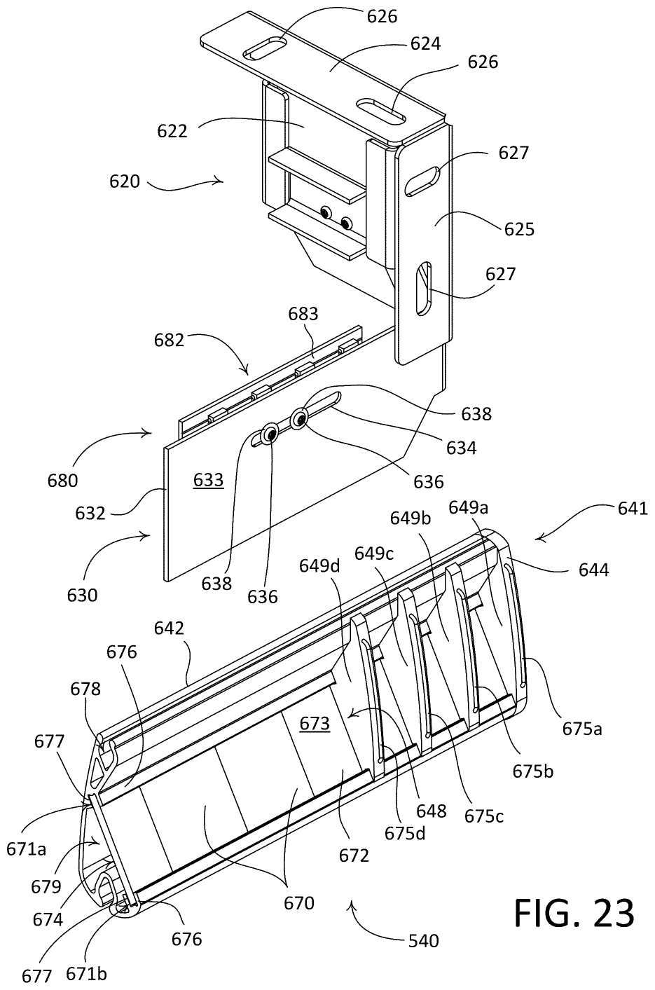

FIG. 22 is a front perspective view of a mounting bracket 620 and a portion of a bottom bar 640 of another example motorized window treatment, which may be deployed as one or more of the motorized window treatments 150 of the load control system 100. FIG. 23 is a rear perspective view of the mounting bracket 620 and the bottom bar 640 of FIG. 22.

The motorized window treatment may include a window treatment assembly (e.g., such as the window treatment assembly 210 and/or the window treatment assembly 310), which may be coupled to (e.g., supported by) a first mounting bracket (e.g., the mounting bracket 620) and a second mounting bracket (not shown) of the motorized window treatment. The window treatment assembly may include a roller tube (e.g., such as the roller tubes 212, 312), a covering material (e.g., such as the covering materials 230, 330), the bottom bar 640, a motor drive unit (e.g., such as the motor drive units 250, 350, 450) at a first end of the roller tube, and an idler (e.g., such as the idler 260) at a second end of the roller tube. The motor drive unit may be coupled to (e.g., fixedly coupled to) the first mounting bracket 620 and be rotatably coupled to the roller tube at the first end of the roller tube. The idler may be coupled to (e.g., fixedly coupled to) the second mounting bracket and rotatably coupled to the roller tube at the second end of the roller tube. Although not illustrated, the motor drive unit, the roller tube, the covering material and the idler of the motorized window treatment may be substantially similar to the motor drive unit, the roller tube, the covering material and the idler of the other motorized window treatments described herein.

The first mounting bracket (e.g., the mounting bracket 620) and the second mounting bracket may be configured to be coupled to or otherwise mounted to a structure. For example, each of the first and second mounting brackets may be configured to be mounted to (e.g., attached to) a window frame, a wall, or other structure of a building, such that the motorized window treatment may be mounted proximate to an opening (e.g., over the opening or in the opening), such as a window for example. The first and second mounting brackets may be configured to be mounted to a vertical structure (e.g., wall-mounted to a wall) and/or mounted to a horizontal structure (e.g., ceiling-mounted to a ceiling). The mounting bracket 620 may include a side wall 622, a first flange portion 624 (e.g., an upper flange portion), and a second flange portion 625 (e.g., a rear flange portion). The first flange portion 624 may comprise one or more openings 626 configured to receive fasteners (e.g., screws—not shown) for mounting the mounting bracket 620 to a horizontal structure (e.g., a ceiling). The second flange portion 625 may comprise one or more openings 627 configured to receive fasteners (e.g., screws—not shown) for mounting the mounting bracket 620 to a vertical structure (e.g., a wall). The mounting bracket 620 may include an attachment member (e.g., such as the attachment member 428) that may extend from the side wall 622 and may support the window treatment assembly of the motorized window treatment. For example, the attachment member of the mounting bracket 620 may support an end portion of the window treatment assembly (e.g., such as the end portion 455 of the motor drive unit 450).

The motorized window treatment may comprise a dock 680 that is configured to facilitate discharging of one or more energy storage elements of the bottom bar 640 into one or more energy storage elements of the motor drive unit, for example, when the bottom bar 640 is docked. For example, the dock 680 may be supported by the mounting bracket 620. In some examples, the dock 680 may be integral with the mounting bracket 620 (e.g., the mounting bracket 620 may comprise the dock 680). Although the second mounting bracket may be substantially similar to the first mounting bracket 620, the second mounting bracket may not include a respective dock (e.g., have a respective dock attached to or integral with the second mounting bracket). For example, the second mounting bracket may be a mirror image of the first mounting bracket (e.g., the mounting bracket 620 shown in FIGS. 22 and 23), but without the dock 680 mounted to or integral with the second mounting bracket. In some examples, the second mounting bracket may support the dock 680 such that the first mounting bracket 620 does not support the dock 680.

The dock 680 may comprise an attachment member 630 and a base portion 682 that may be connected to the attachment member 630. The attachment member 630 may comprise an arm 632 that may extend from the mounting bracket 620. The arm 632 may include a front surface 631 and a rear surface 633 that is opposite the front surface 631. The base portion 682 of the dock 680 may extend from the front surface 631 of the arm 632. In some examples, the arm 632 may further comprise a slot 634 extending from the front surface 631 to the rear surface 633 of the arm 632. For example, the base portion 682 may be connected to the arm 632 via the slot 634 in the arm 632 that allows the base portion 682 to be moved along the arm 632. The base portion 682 may be connected to the arm 632 using one or more fasteners 636 (e.g., screws) that extend through the slot 634 to secure the base portion 682 to the arm 632. In some examples, a respective washer 638 may be disposed about a long axis of each of the fasteners 636, for example such that the respective washer 638 is disposed against the rear surface 683 of the base portion 682. The fasteners 636 may be loosened to allow the base portion 682 to be moved along the slot 634, for example, to allow the ensure proper docking of a bottom bar 640 of the motorized window treatment with the dock 680, as described in more detail herein. Additionally, or alternatively, a respective spring (not shown) may be disposed along the long axis of each of the fasteners 636 between the respective washer 638 and the arm 632. The springs may enable the base portion 682 to be spring-biased with respect to the arm 632 to facilitate docking, for example with the bottom bar 640.

The base portion 682 may include an offset portion 684 and a face 685. The face 685 of the base portion 682 may be offset from the front surface 631 of the arm 632 of the dock 680 by the offset portion 684. The face 685 may define a plurality of slots 687a-687d. Each of the slots 687a-687d may be defined by (e.g., bordered by) a first flange portion 688a and a second flange portion 688b (e.g., as shown for the slot 687c in FIG. 22). The first and second flange portions 688a, 688b may reside on opposite sides of each of the slots 687a-687d. The first and second flange portions 688a, 688b may be tapered. For example, the first and second flange portions 688a, 688b may comprise respective tapered edges 689a, 689b. As described in more detail below, the offset of the face portion 685 and the tapering of the plurality of flanged portions 688a, 688b of each of the slots 687a-687d may facilitate docking of the bottom bar 640 with the dock 680.

The dock 680 may further comprise a plurality of electrical contacts 685a-685d located between the flanged portions 688a, 688b and within the slots 687a-687d. Each of the plurality of electrical contacts 685a-685d may reside within one of the slots 687a-687d, respectively. For example, the first electrical contact 668a may reside within the first slot 687a, the second electrical contact 685b may reside within the second slot 687b, the third electrical contact 668c may reside within the third slot 687c, and the fourth electrical contact 668d may reside within the fourth slot 687d. As such, the plurality of electrical contacts 685a-685d may be located between the flanged portions 688a, 688b of each of the slots 687a-687d.

The bottom bar 640 may comprise a plurality of electrical contacts 675a-675d. The plurality of electrical contacts 685a-685d of the dock 680 may be configured to be electrically connected to the plurality of electrical contacts 675a-675d of the bottom bar 640, as described herein. In the illustrated examples, the dock 680 may include four electrical contacts 685a-685d where, for instance, two of the electrical contacts may be used to deliver power from the bottom bar 640 to the motor drive unit (e.g., and/or vice versa), while the other two electrical contacts can be used to enable communication between the bottom bar 640 and the motor drive unit (e.g., digital communication). Although not illustrated, in some examples, the electrical contacts 685a-685d of the dock 680 may be electrically coupled to the motor drive unit of the motorized window treatment via four electrical conductors (e.g., two wires for power and two wires for communications) or via a cable (e.g., a cable having four wires, such as the cable 790 illustrated in FIG. 25).

The bottom bar 640 may include a housing 642. The bottom bar 640 may be defined by a first end 641 and a second end. Note that only a portion of the bottom bar 640 is shown in FIGS. 22 and 23. The housing 642 of the bottom bar 640 may define a first cavity 678 that may be configured to receive the bottom end of the covering material of the motorized window treatment. For example, the bottom end of the covering material may be attached to an elongated member (not shown) that may extend through the first cavity 678 (e.g., the from the first end 641 to the second end of the housing 642) and may prevent the bottom end of the covering material from being removed from the first cavity 678. The bottom bar 640 may have an end cap 644, for example, at the first end 641 of the bottom bar 640. For example, the end cap 644 may be integral (e.g., connected to) the housing 642 of the bottom bar 640. Although not illustrated, in some examples the bottom bar 640 may have an end cap (e.g., such as the end cap 644) at the second end. The bottom bar 640 may include a recess 648 in the housing 642 that is configured to receive a printed circuit board 672. The printed circuit board 672 may comprise an outer surface 673 and an opposing inner surface 674. The bottom bar 640 may include first and second channels 671a, 671b for receiving the printed circuit board 672. The first and second channels 671a, 671b may be formed by respective flange portions 676 and inner surfaces 677 of the bottom bar 640 (e.g., each of the first and second channels 671a, 671b may be formed by respective flange portions 676 and respective inner surfaces 677).

The printed circuit board 672 may be received in the channels 671a, 671b and located in the recess 648, such that the outer surface 673 of the printed circuit board 672 forms a rear surface of the bottom bar 640. For example, the printed circuit board 672 may be configured to slide into the recess 648 (e.g., via the channels 671a, 671b) from the second end of the bottom bar 640. The printed circuit board 672 may slide into the recess 648, for example when the end cap located at the second end is removed from the bottom bar 640. The printed circuit board 672 may be configured to extend a length from the second end of the bottom bar 640 to approximately the first end 641 of the bottom bar 640. When the printed circuit board 672 is received in the channels 671a, 671b, the outer surface 673 of the printed circuit board 672 may be located adjacent to the flange portions 676 and the inner surface 674 of the printed circuit board 672 of the printed circuit board 672 may be located adjacent to the inner surfaces 677 of the bottom bar 640. The housing 642 and the printed circuit board 672 (e.g., the inner surface 674 of the printed circuit board 672) may define a second cavity 679.

The bottom bar 640 may comprise one or more solar cells 670 (e.g., photovoltaic cells). The solar cells 670 may be disposed on the outer surface 673 of the printed circuit board 672. For example, the printed circuit board 672 (e.g., and thus the solar cells 670) may be mounted at the angle θ_{SC} from the vertical axis V. Additionally, or alternatively, the solar cells 670 may be disposed on the housing 642 and/or on one or more substrates that are from the printed circuit board 672 and are received in the channels 671a, 671b (e.g., in line with the printed circuit board 672). The solar cells 670 of the bottom bar 640 may be electrically connected to the one or more energy storage elements, which may be contained within the housing 642 of the bottom bar 640 (e.g., within the second cavity 679). The energy storage elements of the bottom bar 640 may comprise, for example, one or more of rechargeable batteries and/or supercapacitors. For example, the energy storage element of the bottom bar 640 may be located on (e.g., mounted to) the printed circuit board 672 and/or otherwise located within the housing 642 of the bottom bar 640. The solar cells 670 may be configured to convert the received solar energy into a photovoltaic output voltage, which may be used to charge the energy storage elements located within the housing 642 of the bottom bar 640 (e.g., to generate a storage voltage across the energy storage element). The energy stored in the energy storage elements of the bottom bar 640 may be discharged into the one or more energy storage elements of the motor drive unit when the bottom bar 640 is close to the motor drive unit, for example, when the bottom bar 640 in the raised position P_{RAISED} (e.g., the fully-raised position). For example, the energy storage elements of the motor drive unit may be configured to charge from the energy storage elements of the bottom bar 640 via the dock 680 when the covering material is in the raised position P_{RAISED}. For example, the energy storage elements of the motor drive unit may comprise one or more of rechargeable batteries and/or supercapacitors.

The bottom bar 640 may include a plurality of support members 649a-649d (e.g., fins) that extend across the recess 648 of the housing 642 of the bottom bar 640. The plurality of electrical contacts 675a-675d of the bottom bar 640 may be located on (e.g., supported by) the plurality of support members 649a-649d, respectively. For example, the first electrical contact 675a may reside on the first support member 649a, the second electrical contact 675b may reside on the second support member 649b, the third electrical contact 675c may reside on the third support member 649c, and the fourth electrical contact 675d may reside on the fourth support member 649d. For example, the first support member 649a may form at least a portion of the end cap 644 of the bottom bar 640 (e.g., the first electrical contact 675a may reside on the end cap 644 of the bottom bar 640). In some examples, the first support member 649a may not form at least a portion of the end cap 644 and/or the first electrical contact 675a may not reside on the end cap 644. In such an example, the first supporting member 649a and the first electrical contact 675a may be spaced apart from the end cap 644 (e.g., to the left of the end cap 644 towards the printed circuit board 672 as shown in FIG. 23). Accordingly, the bottom bar 640 may be docked when the bottom bar 640 is positioned adjacent to the dock 680 such that support members 649a-649d of the bottom bar 640 are received in the slots 687a-687d of the base portion 682 and electrical contacts 685a-685d of the dock 680 are in electrical contact with electrical contacts 675a-675d of the bottom bar 640.

As the covering material of the motorized window treatment is moving towards the raised position P_{RAISED}, the tapered edges 689a, 689b of the respective flanged portions 688a, 688b of each of the slots 687a-687d of base portion 682 of the dock 680 may be configured to guide the support members 649a-649d of the bottom bar 640 into the respective slots 687a-687d of the dock 680. When the covering material of the motorized window treatment is in the raised position P_{RAISED}, the first support member 649a of the bottom bar 640 may be positioned within the first slot 687a of the dock 680, such that the first electrical contact 675a of the bottom bar 640 is in contact with the first electrical contact 685a of the dock 680. Similarly, the second support member 649b of the bottom bar 640 may be positioned within the second slot 687b of the dock 680, such that the second electrical contact 675b of the bottom bar 640 is in contact with the second electrical contact 668b of the dock 680. Further, the third support member 649c of the bottom bar 640 may be positioned within the third slot 687c of the dock 680, such that the third electrical contact 675c of the bottom bar 640 is in contact with the third electrical contact 685c of the dock 680. Finally, the fourth support member 649d of the bottom bar 640 may be positioned within the fourth slot 687d of the dock 680, such that the fourth electrical contact 675d of the bottom bar 640 is in contact with the fourth electrical contact 668d of the dock 680.

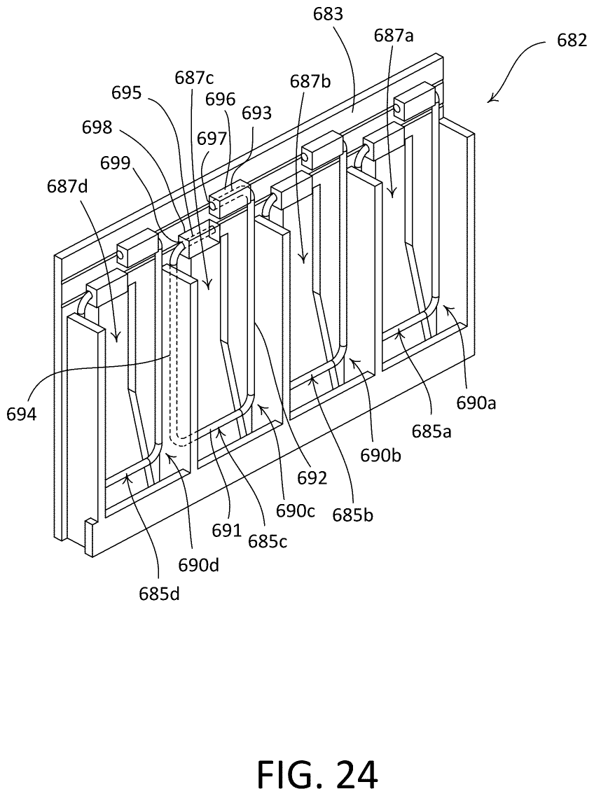

FIG. 24 is a rear perspective view of the base portion 682 of the dock 680 of FIG. 22 when the base portion 682 is removed from the arm 632. The base portion 682 may comprise a plurality of electrical contact structures 690a-690d that may form the respective electrical contacts 685a-685d of the dock 680. The plurality of electrical contacts 685a-685d (e.g., the electrical contact structures 690a-690d) of the base portion 682 may be biased outward away from the front surface 631 of the arm 632 (e.g., and towards the flanged portions 688a, 688b). Each of the plurality of electrical contact structures 690a-690d may be connected (e.g., mechanically connected) to the base portion 682. For example, each of the electrical contact structures 690a-690d may comprise an elongated portion 691 that defines the respective electrical contacts 685a-685d (e.g., such that the electrical contacts 685a-685d are horizontally-oriented). Each of the electrical contact structures 690a-690d may further comprise a first arm 692 that extends from the elongated portion 691 to a first end portion 693, and a second arm 694 that extends from the elongated portion 691 to a second end portion 695. The first and second arms 692, 694 may be perpendicular to the elongated portion 691 (e.g., such that the first and second arms 692, 694 are parallel to each other), and the first and second end portions 693, 695 may be perpendicular to the first and second arms 692, 694, respectively, such that each of the plurality of electrical contact structures 690a-690d may form a partial loop. The first arm 692 may be longer than the second arm 694, such that the first and second end portions 693, 695 are not collinear (e.g., are not in line with each other). The elongated portion 691, the first arm 692, the first end portion 693, the second arm 694, and the second end portion 695 of each of the electrical contact structures 690a-690d may be coplanar. Note that a full length of one of the electrical contact structures 690a-690d (e.g., the third electrical contact structure 690c) is shown in dashed lines in FIG. 24, and all of the electrical contact structures 690a-690d may have similar structures

The plurality of electrical contact structures 690a-690d may be connected (e.g., mounted) to the rear surface 683 of the base portion 682, such the each of the respective electrical contacts 685a-685d (e.g., the elongated portion 691 of each of the plurality electrical contact structures 690a-690d) may be biased towards the rear surface 683 of the base portion 682. The first end portion 693 of each of the electrical contact structures 690a-690d may be received in an opening 697 of a respective connection member 696 (e.g., block) that may extend from a rear surface 683 of the base portion 682. The second end portion 695 of each of the electrical contact structures 690a-690d may be received in an opening 699 of a respective connection member 698 (e.g., block) that may extend from the rear surface 683 of the base portion 682. The connection member 696 that receives the first end 693 of each of the plurality of electrical contact structures 690a-690d may be offset from the connection member 698 that receives the second end 695 of each of the plurality of electrical contact structures 690a-690d. Since the first arm 692 is longer than the second arm 694 and the respective connection members 696, 698 are offset from each other, each of the plurality of electrical contact structures 690a-690d may not be configured to pivot (e.g., about respective axes of the first and second end portions 693, 695).

Each of the plurality of electrical contact structures 690a-690d may be configured to be electrically connected to the motor drive unit (e.g., as described above, for instance, via electrical connectors and/or via a cable). For example, the first end portions 693 and/or the second end portions 695 of each of the plurality of electrical contact structures 690a-690d may be configured to be electrically connected to the motor drive unit (e.g., via the electrical conductors and/or the cable).

Since each of the plurality of electrical contact structures 690a-690d may not be configured to pivot, each of the respective electrical contacts 685a-685d (e.g., the elongated portion 691 of each of the plurality electrical contact structures 690a-690d) of the dock 680 may be biased towards the rear surface 683 of the base portion 682. When the electrical contacts 675a-675d of the bottom bar 640 contact the respective electrical contacts 685a-685d of the dock 680, the first and second arms 692, 694 may be configured to bend away from the rear surface 683 of the base portion 682. Therefore, when the bottom bar 640 is docked with the dock 680, the electrical contacts 685a-685d of the dock 680 may be configured to pressed towards the front surface 631 of the arm 632 by a force applied by the electrical contacts 675a-675d of the bottom bar 640, which may ensure a strong electrical connection between the electrical contacts 685a-685d of the dock 680 and the electrical contacts 675a-675d of the bottom bar 640. As such, the electrical contacts 675a-675d of the bottom bar 640 may be configured to contact (e.g., and force) the electrical contacts 685a-685d of the dock 680 to move towards the front surface 631 of the arm 632, for instance, when the covering material of the motorized window treatment is in the raised position P_{RAISED}, and when the support members 649a-649d of the bottom bar 640 are positioned in the respective slots 687a-687d of the dock 680.

In the illustrated examples, the dock 680 may comprise four electrical contacts 685a-685d where, for instance, two of the electrical contacts 685a-685d may be used to deliver power from the bottom bar 640 to the motor drive unit, while the other two electrical contacts 685a-685d can be used to enable communication between the bottom bar 640 and the motor drive unit (e.g., digital communication). For example, when the bottom bar 640 is docked with the dock 680, the first electrical contact 685a of the dock 680 may be in electrical contact with the first electrical contact 675a of the bottom bar 640, the second electrical contact 685b of the dock 680 may be in electrical contact with the second electrical contact 675b of the bottom bar 640, the third electrical contact 685c of the dock 680 may be in electrical contact with the third electrical contact 675c of the bottom bar 640, and the fourth electrical contact 685d of the dock 680 may be in electrical contact with the fourth electrical contact 675d of the bottom bar 640. However, in other examples, the dock 680 may comprise two electrical contacts and the bottom bar 640 may comprise two electrical contacts, where the two electrical contacts are used for the delivery of power from the bottom bar 640 to the motor drive unit. In some examples, the bottom bar 640 and the motor drive unit may be configured to communicate with each other wirelessly (e.g., via a wireless connection) and/or via the two electrical contacts on the dock 680 and the two electrical contacts of the bottom bar 640 (e.g., via a wired connection). The number of electrical contacts of the dock 680 should be the same as the number of electrical contacts of the bottom bar 640.

Accordingly, when the covering material of the motorized window treatment is in the raised position P_{RAISED}, the support members 649a-649d of the bottom bar 640 may be received in the respective slots 687a-687d of the dock 680. Therefore, when the covering material of the motorized window treatment is in the raised position P_{RAISED}, the one or more energy storage elements of the bottom bar 640 may be configured to discharge through the dock 680 into the one or more energy storage elements of the motor drive unit. Therefore, the one or more energy storage elements of the motor drive unit may charge from the energy storage elements of the bottom bar 640 via the dock 680 when the covering material is in the raised position P_{RAISED}.

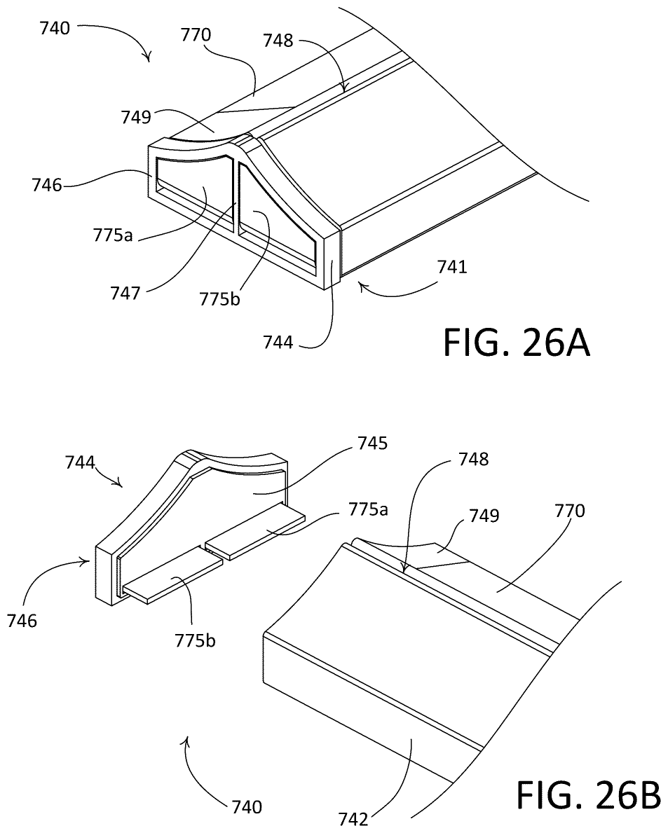

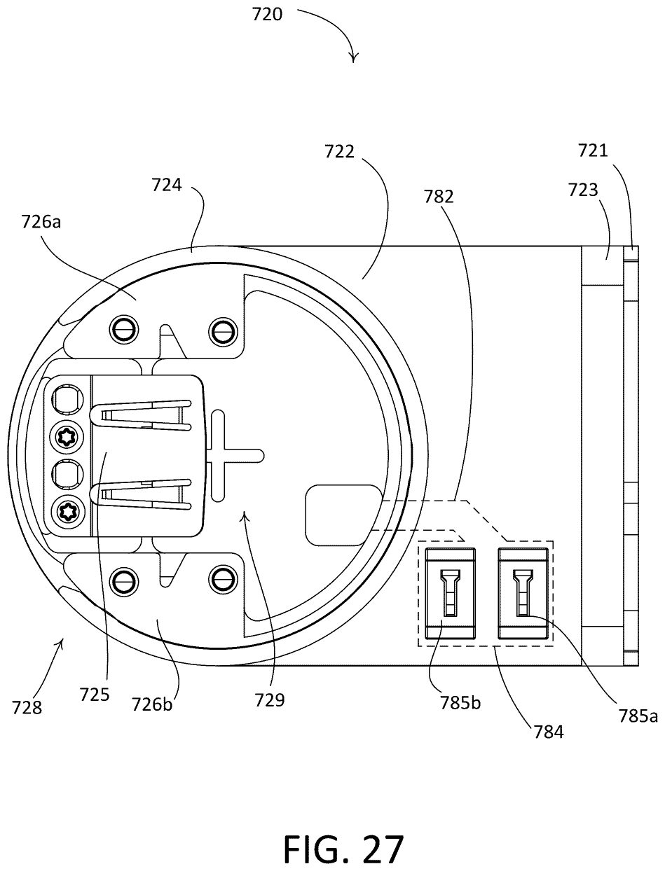

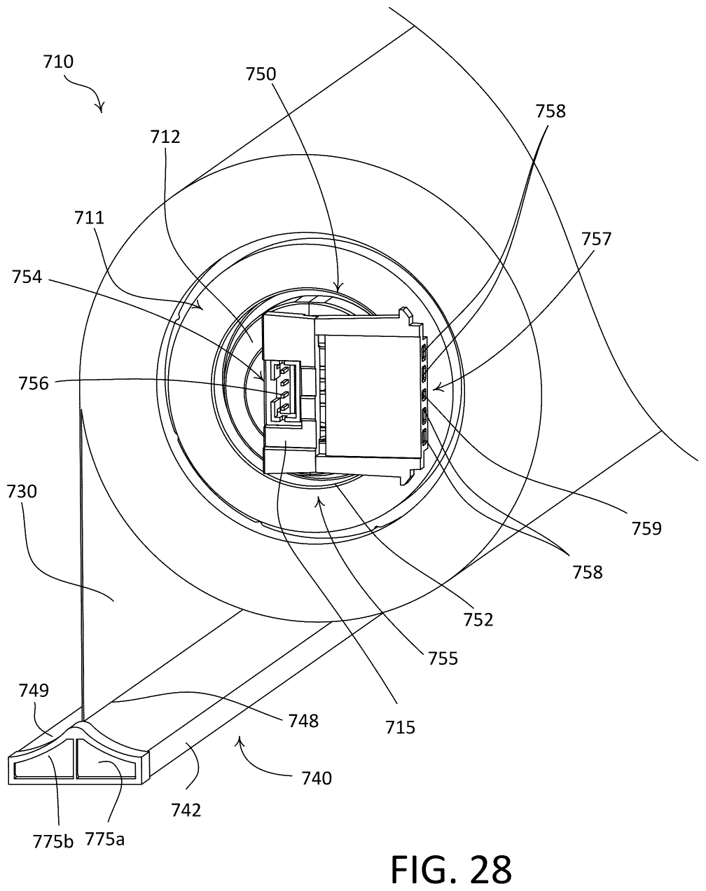

FIG. 25 is a front perspective view of a mounting bracket 720 and a portion of a bottom bar 740 of another example motorized window treatment. FIG. 26A is a partial perspective view of the bottom bar 740 of FIG. 25. FIG. 26B is a partial exploded view of the bottom bar 740 of FIG. 25. FIG. 27 is a side view of the mounting bracket 720 of FIG. 25. FIG. 28 is a partial perspective view of a window treatment assembly 710 (e.g., such as the window treatment assembly 210 and/or the window treatment assembly 310) that may be mounted to the mounting bracket 720 of FIG. 25.

The window treatment assembly 710 may be coupled to (e.g., supported by) a first mounting bracket (e.g., the mounting bracket 720) and a second mounting bracket (not shown) of the motorized window treatment. The window treatment assembly 710 may include a roller tube 712 (e.g., such as the roller tubes 154, 212, 312), the covering material 730 (e.g., such as the covering materials 152, 230, 330), the bottom bar 740, a motor drive unit 750 (e.g., such as the motor drive units 156, 250, 350, 450) at a first end 711 of the roller tube 712, and an idler (e.g., such as the idler 260) at a second end of the roller tube 712. The motor drive unit 750 may be coupled to (e.g., fixedly coupled to) the first mounting bracket 720 and rotatably coupled to the roller tube 712 at the first end 711 of the roller tube 712. The idler may be coupled to (e.g., fixedly coupled to) the second mounting bracket and rotatably coupled to the roller tube 712 at the second end of the roller tube. Although not illustrated, the idler of the motorized window treatment may be substantially similar to the idler of the other motorized window treatments described herein.

The first mounting bracket (e.g., the mounting bracket 720) and the second mounting bracket may be configured to be coupled to or otherwise mounted to a structure. For example, each of the first and second mounting brackets may be configured to be mounted to (e.g., attached to) a window frame, a wall, or other structure of a building, such that the motorized window treatment may be mounted proximate to an opening (e.g., over the opening or in the opening), such as a window for example. The first and second mounting brackets may be configured to be mounted to a vertical structure (e.g., wall-mounted to a wall) and/or mounted to a horizontal structure (e.g., ceiling-mounted to a ceiling). The mounting bracket 720 may include an arm 722 that extends substantially perpendicularly from a base 721 (e.g., a foot) to an attachment member 728. The base 721 may be enclosed, at least partially, in a base cover 723. For example, the base 721 may be configured to attach the mounting bracket 720 to a structure (e.g., such as a window frame, a wall, a ceiling, or other structure). When the mounting bracket 720 is attached to a vertical structure (e.g., such as a wall), the arm 722 of the mounting bracket 720 may extend horizontally from the base 721 to the attachment member 728. When the mounting bracket 720 is attached to a horizontal structure (e.g., such as to the bottom of a ceiling), the arm 722 of the mounting bracket 720 may extend vertically from the base 721 to the attachment member 728. In other configurations, there may be no base 721.

The motor drive unit 750 may include an enclosure 752 for housing an internal motor (not shown) that may be coupled to a drive coupler (e.g., such as the drive coupler 254), which may engage the roller tube 712 of the window treatment assembly 710 in which the motor drive unit 750 is received. The motor drive unit 750 may be configured to rotate the drive coupler for rotatably driving the roller tube 712 of the motorized window treatment. The motor drive unit 750 may further comprise an end portion 755 that may be coupled to (e.g., supported by) the mounting bracket 720. The attachment member 728 of the mounting bracket 720 may extend from the arm 722 and may support the end portion 755 of the motor drive unit 750. The motor drive unit 750 (e.g., the end portion 755) may include a socket 754 that includes one or more pins 756. The motor drive unit 750 (e.g., the end portion 755) may include a user interface 757 that may be accessible when the roller tube 712 is received within a channel 729 of the mounting bracket 720. For example, the user interface 757 may include one or more actuators 758 (e.g., buttons) and/or one or more visual indicators 759 (e.g., light sources, such as light-emitting diodes) on the end portion 755. The actuators 758 of the user interface 757 may be configured to be actuated by user, for example to provide inputs to control the motorized window treatment during setup and/or configuration.

The window treatment assembly 710 may be configured to be supported by (e.g., connected to) the attachment member 728 of the mounting bracket 720. The mounting bracket 720 may include a channel 729 formed in the attachment member 728. The channel 729 may be configured to receive the end portion 755 of the motor drive unit 750 at the first end 711 of the roller tube 712. A sliding cover 724 may be configured to be located around the attachment member 728. The sliding cover 724 may be operated into a closed position and an open position. The sliding cover 724 may have a circular shape and/or may rotate between the closed position and the open position. When the sliding cover 724 is in the open position, the end portion 755 of the motor drive unit 750 may be installed into the channel 729 of the attachment member 728. When the end portion 755 of the motor drive unit 750 is fully installed in the channel 729, the sliding cover 724 may be rotated into the closed position, for example in which the sliding cover 724 hides the end portion 755 of the motor drive unit 750 (e.g., the user interface 757) and/or the channel 729 from view.

The mounting bracket 720 may include a spring 725 that is secured to the attachment member 728, for example, in the channel 729. The spring 725 may be configured to flex as the end portion 755 of the motor drive unit 750 is inserted into the channel 729. For example, the end portion 755 of the motor drive unit 750 may apply a force on the spring 725 that pushes the spring 725. The spring 725 may be configured to engage the end portion 755 of the motor drive unit 750, for example, to secure the end portion 755 of the motor drive unit 750 within the channel 729. When the end portion 755 of the motor drive unit 750 is fully inserted into the channel 729, the spring 725 may exert a force on the end portion 755 of the motor drive unit 750 such that the end portion 755 of the motor drive unit 750 is retained within the channel 729. The attachment member 728 may include a first flange 726a and a second flange 726b. The first and second flanges 726a, 726b may be configured to retain the end portion 755 of the motor drive unit 750 within the channel 729. The first and second flanges 726a, 726b may be configured to secure the window treatment assembly 710, for example in a transverse direction and/or longitudinal direction.

The mounting bracket 720 may comprise a dock 780 that is configured to facilitate discharging of energy storage elements of the bottom bar 740 into energy storage elements of the motor drive unit 750, for example, when the bottom bar 740 is docked. For example, the dock 780 may be supported by the mounting bracket 720. In some examples, the dock 780 may be integral with the mounting bracket 720 (e.g., the mounting bracket 720 may comprise the dock 780). The dock 780 may include first and second electrical contacts 785a, 785b, a cable 790 that may extend through a tunnel (e.g., or channel or trench) 782 and that is configured to receive the cable 790, and a cavity 784. The dock 780 may utilize a portion of the arm 722 of the mounting bracket 720, such that the arm 722 operates as a base portion for the dock 780. The first and second electrical contacts 785a, 785b may be supported by the arm 722 of the mounting bracket 720 (e.g., the base portion for the dock 780). The tunnel 782 and the cavity 784 may be located inside of the arm 722 (e.g., inside of the base portion for the dock 780).

The cable 790 may be configured to provide an electrical connection to the motor drive unit 750. One end of the cable 790 may include a connector 792, while the other end of the cable 790 may terminate at the first and second electrical contacts 785a, 785b. The cable 790 may include one or more electrical conductors, such as wires, that extend through the cable 790 between the connector 792 and the first and second electrical contacts 785a, 785b. As described in more detail herein, the connector 792 may be configured to be connected to the socket 754 of the motor drive unit 750. Further, the cable 790 may be received in the channel 729 of the attachment member 728 of the mounting bracket 720. In some examples, the cable 790 may be disposed and fixed within the channel 729. However, in other examples, the cable 790 may be removably attached to the mounting bracket 720.

The first and second electrical contacts 785a, 785b of the dock 780 may be disposed on the arm 722 of the mounting bracket 720 (e.g., the base portion for the dock 780). The cavity 784 may be located in the arm 722 behind (e.g., immediately behind) the first and second electrical contacts 785a, 785b and may provide space to allow wires of the cable 790 to be electrically connected to the first and second electrical contacts 785a, 785b. The tunnel 782 may extend from the cavity 784 through the arm 722 to the channel 729 of the attachment member 728. The tunnel 782 may form a path for the cable 790 to connect the first and second electrical contacts 785a, 785b to the connector 792. For example, the cable 790 may extend through the tunnel 782 and be connected to the first and second electrical contacts 785a, 785b within the cavity 784. When the window treatment assembly 710 is connected to the sliding cover 724, the connector 792 may be (e.g., partially) disposed in the tunnel 782 and/or the cavity 784.

As described in more detail below, the first and second electrical contacts 785a, 785b may be electrically connected to the electrical contacts of the bottom bar 740 when the covering material 730 of the window treatment assembly 710 is in the raised position P_{RAISED}. In some examples, the first and second electrical contacts 785a, 785b may comprise spring contacts that are biased outward and configured to be compressed inward into the arm 722 of the mounting bracket 720 when a force is applied to the electrical contacts 785a, 785b, such as when the bottom bar 740 is in the docked position. The spring-biasing of the electrical contacts 785a, 785b may facilitate docking of the bottom bar 740, for example as the outward bias of the electrical contacts 785a, 785b may ensure a strong electrical connection with electrical contacts 775a, 775b of the bottom bar 740. Docking may include when the bottom bar 740 is positioned adjacent to the dock 780 such that the electrical contacts 785a, 785b of the dock 780 are in electrical contact with the electrical contacts 775a, 775b of the bottom bar 740.

The connector 792 of the cable 790 of the dock 780 may be configured to be connected to the socket 754 of the motor drive unit 750. The connector 792 of the cable 790 may comprise one or more openings 794 for housing electrical conductors that may be electrically coupled to the pins 756 of the socket 754 of the motor drive unit 750. For example, the openings 794 may be configured to receive the pins 756 of socket 754 of the motor drive unit 750. In the illustrated examples, the socket 754 of the motor drive unit 750 may include four pins 756 and the connector 792 of the cable 790 of the dock 780 may include four openings 794 where, for instance, all pins 756 and openings 794 may be used to deliver power from the bottom bar 740 to the motor drive unit 750. In some examples, there may be four electrical contacts such that a first set of two pins 756 and openings 794 may be used to deliver power from the bottom bar 740 to the motor drive unit 750 while the a second set of two pins 756 and openings 794 may be used to enable communication between the bottom bar 740 and the motor drive unit 750 (e.g., digital communication).

The bottom bar 740 may include a housing 742. The bottom bar 740 may be secured at the bottom of the covering material 730 (e.g., as shown in FIG. 28). The covering material 730 may be received through a gap 748 in the housing 742 of the bottom bar 740 and secured within the housing 742. The housing 742 may be configured to include an energy storage element, a printed circuit board, and other electronics, for example, as described herein. The housing may include one or more solar cells 770 that are disposed on and/or form an outer surface of the housing 742. For example, the bottom bar 740 may include one or more solar cells 770 disposed on an angled surface 749 of the housing 742. For example, the solar cells 770 may be mounted at the angle θ_{SC} from the vertical axis V. The solar cells 770 of the bottom bar 740 may be electrically connected to one or more energy storage elements (not shown) contained within the housing 742 of the bottom bar 740. The energy storage elements of the bottom bar 740 may comprise, for example, one or more of rechargeable batteries and/or supercapacitors. For example, the energy storage elements of the bottom bar 740 may be located on a printed circuit board and/or otherwise located within the housing 742. The solar cells 770 may be configured to convert the received solar energy into a photovoltaic output voltage, which may be used to charge the energy storage elements located within the housing 742 of the bottom bar 740 (e.g., to generate a storage voltage across the energy storage element). The energy stored in the energy storage elements of the bottom bar 740 may be discharged into the motor drive unit 750 when the bottom bar 740 is close to the motor drive unit 750, for example, when the bottom bar 740 in the raised position P_{RAISED} (e.g., the fully-raised position).

The bottom bar 740 may be defined by a first end 741 and a second end. The bottom bar 740 may have an end cap 744, for example at the first end 741 of the bottom bar 740. Although not illustrated, in some examples the bottom bar 740 may have an end cap at the second end. The end cap 744 may have an interior surface 745 and an exterior surface 746. The bottom bar 740 may comprise a first electrical contact 775a and a second electrical contact 775b. The first and second electrical contacts 775a, 775b may be located on the end cap 744 (e.g., on the exterior surface 746) of the bottom bar 740. The first and second electrical contacts 775a, 775b may be separated by a divider 747 that is formed on the exterior surface 746. The end cap 744 may include the interior surface 745. The first and second electrical contacts 775a, 775b may extend through the interior surface 745 so that they can electrically connect to a printed circuit board of the bottom bar 740, for example disposed in the housing 742 of the bottom bar 740.

In the illustrated examples, the dock 780 may include two electrical contacts 785a, 785b and the bottom bar 740 may include two electrical contacts 775a, 775b where, for instance, the two electrical contacts 785a, 785b of the dock 780 and the two electrical contacts 775a, 775b of the bottom bar 740 are used for the delivery of power from the bottom bar 740 to the motor drive unit 750. In some examples, the bottom bar 740 and the motor drive unit 750 may be configured to communicate with each other wirelessly (e.g., via a wireless connection) and/or via the two electrical contacts 785a, 785b on the dock 780 and the two electrical contacts 775a, 775b of the bottom bar 740 (e.g., via a wired connection). However, in other examples, the dock 780 and the bottom bar 740 may each include four electrical contacts where, for instance, two of the electrical contacts may be used to deliver power from the bottom bar 740 to the motor drive unit 750, while the other two electrical contacts can be used to enable communication between the bottom bar 740 and the motor drive unit 750 (e.g., digital communication).

When the bottom bar 740 is docked with the dock 780, the first electrical contact 785a of the dock 780 may be in electrical contact with the first electrical contact 775a of the bottom bar 740 and the second electrical contact 785b of the dock 780 may be in electrical contact with the second electrical contact 775b of the bottom bar 740. For instance, when the bottom bar 740 is in the docked position, the first and second electrical contacts 785a, 785b may be compressed inward into the arm 722 of the mounting bracket 720 when a force is applied to the electrical contacts 785a, 785b by the first and second electrical contacts 775a, 775b of the bottom bar 740. The spring-biasing of the electrical contacts 785a, 785b of the dock 780 may allow for easier docking of the bottom bar 740 and/or to ensure a strong electrical connection is established between the electrical contacts 785a, 785b of the dock 780 and the first and second electrical contacts=775a, 775b of the bottom bar 740.

Accordingly, when the covering material 730 of the window treatment assembly 710 is in the raised position P_{RAISED}, the electrical contacts 785a, 785b of the dock 780 may be electrically connected to the first and second electrical contacts 775a, 775b of the bottom bar 740. Further, as noted above, the connector 792 of the cable 790 of the dock 780 may be connected to the connector 764 of the motor drive unit 750. Therefore, when the covering material 730 of the window treatment assembly 710 is in the raised position P_{RAISED}, the one or more energy storage elements of the bottom bar 740 may be configured to discharge through the dock 780 into the one or more energy storage elements of the motor drive unit 750. Therefore, using the dock 780 in the mounting bracket 720 and the electrical contacts 775a, 775b on the end cap 734 of the bottom bar 740, the one or more energy storage elements of the motor drive unit 750 may charge from the one or more energy storage elements of the bottom bar 740 when the covering material is in the raised position P_{RAISED}.

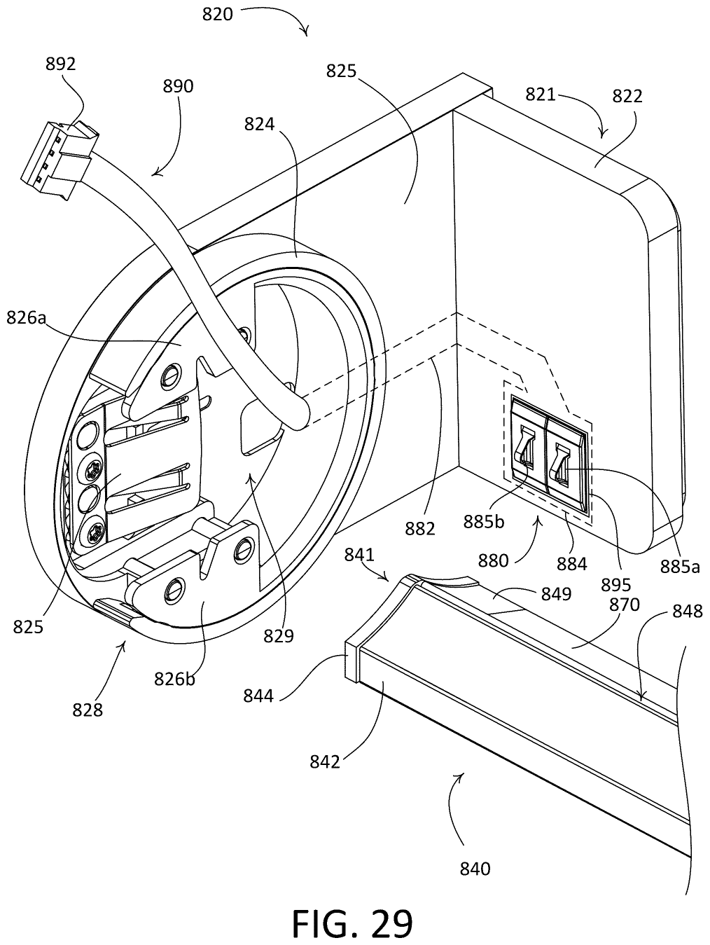

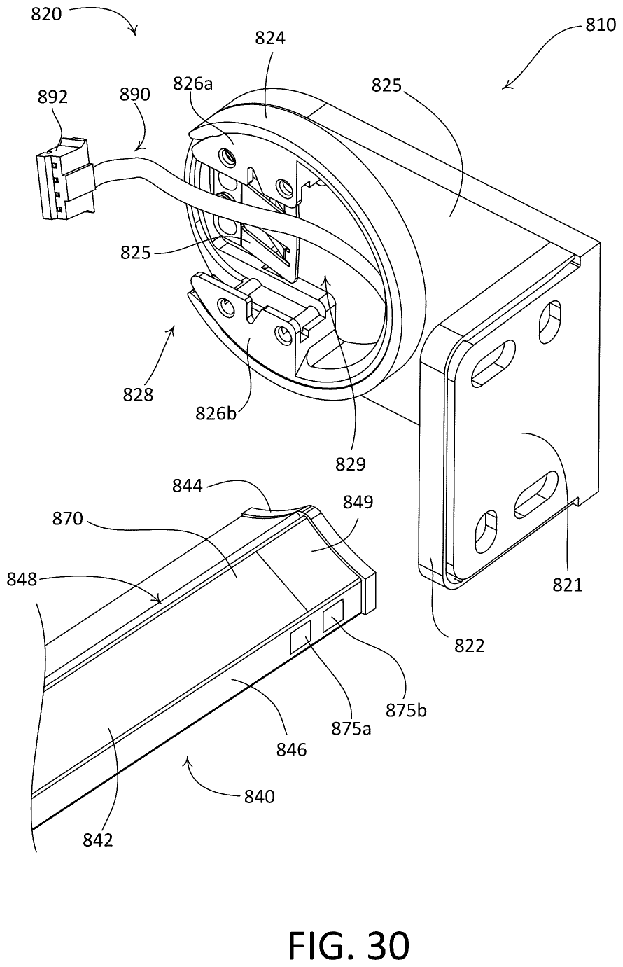

FIG. 29 is a front perspective view and FIG. 30 is a rear perspective view of a mounting bracket 820 and a portion of a bottom bar 840 of another example motorized window treatment. The motorized window treatment may include a window treatment assembly (e.g., such as the window treatment assembly 210, the window treatment assembly 310, and/or the window treatment assembly 710), which may be coupled to (e.g., supported by) a first mounting bracket (e.g., the mounting bracket 820) and a second mounting bracket (not shown) of the motorized window treatment. The window treatment assembly may include a roller tube (e.g., such as the roller tubes 212, 312, 723), a covering material (e.g., such as the covering materials 230, 330, 752), a bottom bar 840, a motor drive unit (e.g., such as the motor drive units 250, 350, 450, 760) at a first end of the roller tube, and an idler (e.g., such as the idler 260) at a second end of the roller tube. The motor drive unit may be coupled to (e.g., fixedly coupled to) the first mounting bracket 820 and be rotatably coupled to the roller tube at the first end of the roller tube. The idler may be coupled to (e.g., fixedly coupled to) the second mounting bracket and rotatably coupled to the roller tube at the second end of the roller tube. Although not illustrated, the motor drive unit, the roller tube, the covering material, and the idler of the motorized window treatment may be substantially similar to the motor drive unit, the roller tube, the covering material, and the idler of the other motorized window treatments described herein.

The first mounting bracket (e.g., the mounting bracket 820) and the second mounting bracket may be configured to be coupled to or otherwise mounted to a structure. For example, each of the first and second mounting brackets may be configured to be mounted to (e.g., attached to) a window frame, a wall, or other structure of a building, such that the motorized window treatment may be mounted proximate to an opening (e.g., over the opening or in the opening), such as a window for example. The first and second mounting brackets may be configured to be mounted to a vertical structure (e.g., wall-mounted to a wall) and/or mounted to a horizontal structure (e.g., ceiling-mounted to a ceiling). The mounting bracket 820 may include an arm 822 that extends substantially perpendicularly from a base 821 (e.g., a foot) to an attachment member 828. The base 821 may be enclosed, at least partially, in a base cover 823. For example, the base 821 may be configured to attach the mounting bracket 820 to a structure (e.g., such as a window frame, a wall, a ceiling, or other structure). When the mounting bracket 820 is attached to a vertical structure (e.g., such as a wall), the arm 822 of the mounting bracket 820 may extend horizontally from the base 821 to the attachment member 828. When the mounting bracket 820 is attached to a horizontal structure (e.g., such as to the bottom of a ceiling), the arm 822 of the mounting bracket 820 may extend vertically from the base 821 to the attachment member 828.

The window treatment assembly of the motorized window treatment may be configured to be supported by (e.g., connected to) the attachment member 828. The attachment member 828 may include a channel 829 formed in the attachment member 828. The channel 829 may be configured to receive an end portion of the motor drive unit (e.g., such as the end portion 755 of the motor drive unit 750 illustrated in FIG. 28). A sliding cover 824 may be configured to be located around the attachment member 828. The sliding cover 824 may be operated into a closed position and an open position. The sliding cover 824 may have a circular shape and/or may rotate between the closed position and the open position. When the sliding cover 824 is in the open position, the end portion of the roller tube may be installed into the channel 829 of the sliding cover 824. When the end portion of the motor drive unit is fully installed in the channel 829, the sliding cover 824 may be rotated into the closed position, for example in which the sliding cover 824 hides the end portion of the motor drive unit and/or the channel 829 from view.

The mounting bracket 820 may include a spring 885 that is secured to the attachment member 828, for example in the channel 829. The spring 885 may be configured to flex as the end portion of the motor drive unit is inserted into the channel 829. For example, the end portion of the motor drive unit may apply a force on the spring 885 that pushes the spring 885. The spring 885 may be configured to engage the end portion of the motor drive unit, for example to secure the end portion of the motor drive unit within the channel 829. When the end portion of the motor drive unit is fully inserted into the channel 829, the spring 885 may exert a force on the end portion of the motor drive unit such that the end portion of the motor drive unit is retained within the channel 829. The attachment member 828 may include a first flange 826a and a second flange 826b. The first and second flanges 826a, 826b may be configured to retain the end portion of the motor drive unit within the channel 829. The first and second flanges 826a, 826b may be configured to secure the window treatment assembly, for example in a transverse direction and/or longitudinal direction.

The motorized window treatment may comprise a dock 880 that is configured to facilitate discharging of energy storage elements of the bottom bar 840 into energy storage elements of the motor drive unit, for example, when the bottom bar 840 is docked. For example, the dock 880 may be supported by the mounting bracket 820. In some examples, the dock 880 may be integral with the mounting bracket 820 (e.g., the mounting bracket 820 may comprise the dock 880). The dock 880 may include first and second electrical contacts 885a, 885b, a cable 890 that extends through a tunnel 882 that is configured to receive the cable 890, and a cavity 884. The dock 880 may utilize a portion of a base 821 of the mounting bracket 820, such that the base 821 operates a base portion for the dock 880. The first and second electrical contacts 885a, 885b may be supported by the base 821 of the mounting bracket 820 (e.g., the base portion for the dock 880). The first and second electrical contacts 885a, 885b may extend through an opening 827 in a base cover 823. The cavity 884 may be located inside of the base 821 of the mounting bracket 820 (e.g., inside of the base portion for the dock 880). The tunnel 882 may be located inside of the base 821 and the arm 822 of the mounting bracket 820.

The cable 890 may be configured to provide an electrical connection to the motor drive unit. One end of the cable 890 may include a connector 892, while the other end of the cable 890 may terminate at the first and second electrical contacts 885a, 885b. The cable 890 may include one or more electrical conductors, such as wires, that extend through the cable 890 between the connector 892 and the first and second electrical contacts 885a, 885b. As described in more detail herein, the connector 892 may be configured to be connected to a socket (e.g., such as the socket 754 of the motor drive unit 750) of the motor drive unit. Further, the cable 890 may be received in the channel 829 of the attachment member 828 of the mounting bracket 820. In some examples, the cable 890 may be disposed and fixed within the channel 829. However, in other examples, the cable 890 may be removably attached to the mounting bracket 820.

The first and second electrical contacts 885a, 885b of the dock 880 may be disposed on the base 821 of the mounting bracket 820 (e.g., the base portion for the dock 880) and may extend through the opening 827 of the base cover 823 configured to cover the base 821 of the mounting bracket 820. The cavity 884 may be located in the base 821 behind (e.g., immediately behind) the first and second electrical contacts 885a, 885b and may provide space to allow wires of the cable 890 to be electrically connected to the first and second electrical contacts 885a, 885b. The tunnel 882 may extend from the cavity 884 in the base 821 through the base 821 and the arm 822 to the channel 829 of the attachment member 828. The tunnel 882 may form a path for the cable 890 to connect the first and second electrical contacts 885a, 885b to the connector 892. For example, the cable 890 may extend through the tunnel 882 and be connected to the first and second electrical contacts 885a, 885b within the cavity 884. The tunnel 882 may extend through the base 821 and the arm 822 of the mounting bracket 820. When the window treatment assembly is connected to the sliding cover 824, the connector 892 may be (e.g., partially) disposed in the tunnel 882 and the cavity 884.

As described in more detail below, the first and second electrical contacts 885a, 885b may be electrically connected to the electrical contacts of the bottom bar 840 when the covering material (not shown) of the window treatment assembly is in the raised position P_{RAISED}. In some examples, the first and second electrical contacts 885a, 885b may comprise spring contacts that are biased outward and configured to be compressed inward into the base 821 of the mounting bracket 820 when a force is applied to the electrical contacts 885a, 885b, such as when the bottom bar 840 is in the docked position. The spring-biasing of the electrical contacts 885a, 885b may allow for easier docking of the bottom bar 840. The spring-biasing of the electrical contacts 885a, 885b may facilitate docking of the bottom bar 840, for example as the outward bias of the electrical contacts 885a, 885b may ensure a strong electrical connection with the electrical contacts 875a, 875b of the bottom bar 840.

The bottom bar 840 may include a housing 842. The bottom bar 840 may be secured at the bottom of the covering material. The covering material may be received through a gap 848 in the housing 842 of the bottom bar 840 and secured within the housing 842. The housing 842 may be configured to include one or more energy storage elements, a printed circuit board, and other electronics, for example, as described herein. The bottom bar 840 may include one or more solar cells 870 that are disposed on and/or form an angled surface 849 of the housing 842. For example, the solar cells 870 may be mounted at the angle θ_{SC} from the vertical axis V. The solar cells 870 of the bottom bar 840 may be electrically connected to one or more energy storage elements (not shown) contained within the housing 842 of the bottom bar 840. The energy storage elements of the bottom bar 840 may comprise, for example, one or more of rechargeable batteries and/or supercapacitors. For example, the energy storage elements of the bottom bar 840 may be located on the printed circuit board and/or otherwise located within the housing 842. The solar cells 870 may be configured to convert the received solar energy into a photovoltaic output voltage, which may be used to charge the energy storage elements located within the housing 842 of the bottom bar 840 (e.g., to generate a storage voltage across the energy storage element). The energy stored in the energy storage elements of the bottom bar 840 may be discharged into the motor drive unit when the bottom bar 840 is close to the motor drive unit, for example, when the bottom bar 840 in the raised position P_{RAISED} (e.g., the fully-raised position).

The bottom bar 840 may be defined by a first end 841 and a second end. The bottom bar 840 may have an end cap 844, for example at the first end 841 of the bottom bar 840. Although not illustrated, in some examples the bottom bar 840 may have an end cap at the second end. The bottom bar 840 may include a rear surface 846. The bottom bar 840 may include a first electrical contact 875a and a second electrical contact 875b located on the rear surface 846 of the bottom bar 840. For example, the first and second electrical contacts 875a, 875b may be electrically connected to the printed circuit board disposed in the housing 842 of the bottom bar 840. In the illustrated examples, the dock 880 may include two electrical contacts 885a, 885b and the bottom bar 840 may include two electrical contacts 875a, 875b where, for instance, the two electrical contacts 885a, 885b of the dock 880 and the two electrical contacts 875a, 875b of the bottom bar 840 are used for the delivery of power from the bottom bar 840 to the motor drive unit. In some examples, the bottom bar 840 and the motor drive unit may be configured to communicate with each other wirelessly (e.g., via a wireless connection) and/or via the two electrical contacts 885a, 885b on the dock 880 and the two electrical contacts 875a, 875b of the bottom bar 840 (e.g., via a wired connection). However, in other examples, the dock 880 and the bottom bar 840 may each include four electrical contacts where, for instance, two of the electrical contacts may be used to deliver power from the bottom bar 840 to the motor drive unit, while the other two electrical contacts can be used to enable communication between the bottom bar 840 and the motor drive unit (e.g., digital communication).

When the bottom bar 840 is docked with the dock 880, the first electrical contact 885a of the dock 880 may be in electrical contact with the first electrical contact 875a of the bottom bar 840 and the second electrical contact 885b of the dock 880 may be in electrical contact with the second electrical contact 875b of the bottom bar 840. For instance, when the bottom bar 840 is in the docked position, the first and second electrical contacts 885a, 885b may be compressed inward into the base 821 of the mounting bracket 820 when a force is applied to the electrical contacts 885a, 885b by the first and second electrical contacts 875a, 875b of the bottom bar 840. The spring-biasing of the electrical contacts 885a, 885b of the dock 880 may allow for easier docking of the bottom bar 840 and/or to ensure a strong electrical connection is established between the electrical contacts 885a, 885b of the dock 880 and the first and second electrical contacts 875a, 875b of the bottom bar 840.

Accordingly, when the covering material (not shown) of the window treatment assembly is in the raised position P_{RAISED}, the electrical contacts 885a, 885b of the dock 880 may be electrically connected to the first and second electrical contacts 875a, 875b of the bottom bar 840. Further, as noted above, the connector 892 of the cable 890 of the dock 880 may be connected to the connector 864 of the motor drive unit (not shown). Therefore, when the covering material of the motorized window assembly is in the raised position P_{RAISED}, the one or more energy storage elements of the bottom bar 840 may be configured to discharge through the dock 880 into the one or more energy storage elements of the motor drive unit. Therefore, using the dock 880 in the mounting bracket 820 and the electrical contacts 875a, 875b on the rear surface 846 of the bottom bar 840, the one or more energy storage elements of the motor drive unit may charge from the one or more energy storage elements of the bottom bar 840 when the covering material is in the raised position P_{RAISED}.

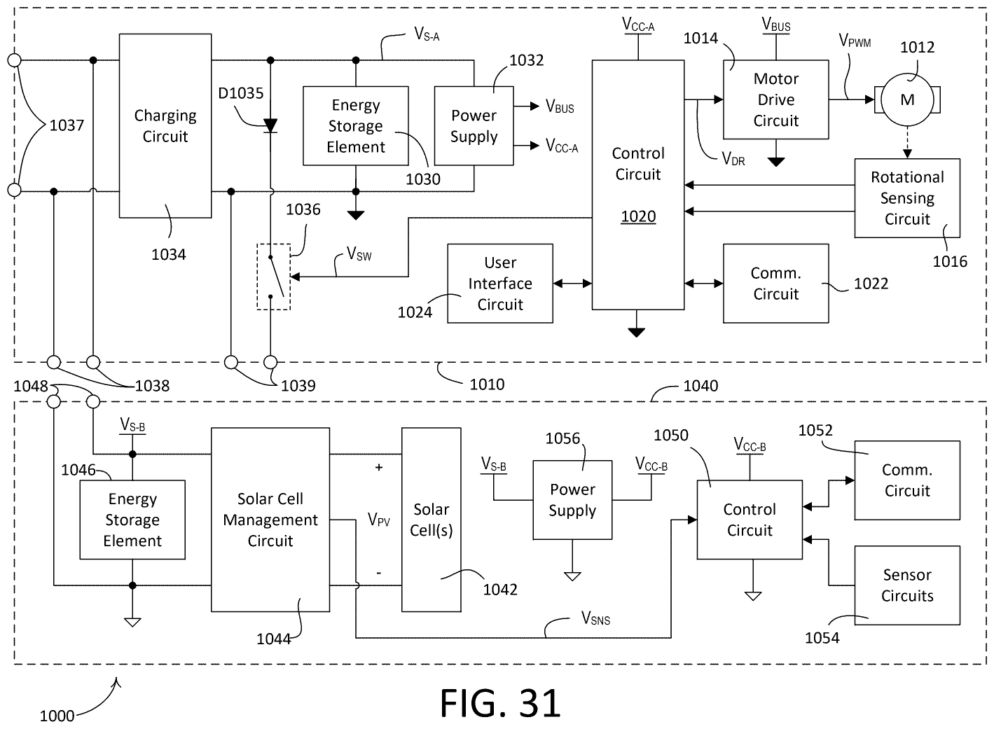

FIG. 31 is a simplified block diagram of a motorized window treatment control system 1000 for controlling a motorized window treatment (e.g., the motorized window treatments 150 of the load control system 100, the motorized window treatment 200, and/or the motorized window treatment 300). The motorized window treatment may comprise a covering material (e.g., the covering material 152, 230, 330, 730) that may be wound around a roller tube (e.g., the roller tubes 212, 312, 712) and may extend to a bottom bar (e.g., the bottom bars 240, 340, 440, 540, 640, 740, 840). The motorized window treatment control system 1000 may comprise a motor drive unit 1010 (e.g., the motor drive units 156, 250, 350, 750) for rotating the roller tube for raising and lowering the covering material to adjust a present position P_{PRES} of the covering material (e.g., the bottom bar). The motor drive unit 1010 may include a motor 1012 (e.g., a direct-current motor) that may be coupled to the roller tube for rotating the roller tube. The motor drive unit 1010 may include a motor drive circuit 1014 (e.g., an H-bridge drive circuit) that receives a bus voltage V_{BUS} and may generate a pulse-width modulated (PWM) voltage V_{PWM} for driving the motor 1012. For example, the motor drive circuit 1014 may comprise an H-bridge drive circuit and/or an H-bridge controller (e.g., an integrated circuit) for controlling the H-bridge drive circuit to generate the PWM voltage V_{PWM} across the motor 1012.

The motor drive unit 1010 may include a control circuit 1020 (e.g., a motor control circuit) for controlling the operation of the motor 1012. The control circuit 1020 may include, for example, any combination of one or more microprocessors, a programmable logic devices (PLD), microcontrollers, application specific integrated circuits (ASIC), a field-programmable gate arrays (FPGA), and/or any suitable processing device or control circuit. The procedures described herein may be performed by the control circuit 1020 of the motor drive unit and/or may be distributed across one or more control circuits or processors that are included in the motorized window treatment control system 1000, such as a bottom bar module 1040, a mobile device, and/or a system controller.

The motor drive unit 1010 may include instructions (e.g., software instructions) that configure the control circuit 1020 to generate at least one drive signal V_{DR} for controlling the motor drive circuit 1014. The motor drive circuit 1014 may be configured to control the rotational speed and the direction of rotation of the motor 1012 in response to the drive signal V_{DR}. The control circuit 1020 may be configured to control the motor drive circuit 1014 to rotate the motor 1012 to adjust a present position P_{PRES} of the covering material (e.g., of the bottom bar). The motor drive unit 1010 may be configured to control the covering material between a raised position P_{RAISED} (e.g., a fully-raised position and/or a fully-open position) and a lowered position P_{LOWERED} (e.g., a fully-lowered position and/or a fully-closed position). The covering material may be fully wound around the roller tube in the raised position P_{RAISED} and fully extended in the lowered position P_{LOWERED}. The control circuit 1020 may be configured to set limits (e.g., an upper limit position P_{UP-LIMIT} and a lower limit position P_{LO-LIMIT}) for limiting a range across which the present position P_{PRES} of the covering material may be adjusted (e.g., to be less than a full range between the raised position P_{RAISED} and lowered position P_{LOWERED}.

The motor drive unit 1010 may comprise a memory (not shown), e.g., such as a non-volatile memory. The memory may be communicatively coupled to the control circuit 1020 for the storage and/or retrieval of, for example, operational settings of the motor drive unit 1010. In addition, the memory may be configured to store software for execution by the control circuit 1020 to operate the motor drive unit 1010 as described herein. The memory may be implemented as an internal circuit of the control circuit 1020 or as an external integrated circuit (IC). The memory may comprise a computer-readable storage medium (e.g., non-transitory computer-readable storage medium) or machine-readable storage medium that maintains computer-executable instructions for performing one or more of the procedures and/or routines as described herein. For example, the memory may comprise computer-executable instructions or machine-readable instructions that include one or more portions of the procedures and/or routines described herein. The control circuit 1020 may access the instructions from memory for being executed to cause the control circuit 1020 to operate as described herein, or to operate one or more other devices as described herein. The memory may comprise computer-executable instructions for executing configuration software. In addition, the memory may have stored thereon one or more settings and/or control parameters associated with the motor drive unit 1010. The control circuit may store the present position of the covering material and/or limits for controlling the position of the covering material (e.g., the fully-raised position P_{RAISED} and/or the fully-lowered position P_{LOWERED}) in the memory. The control circuit 1020 may be configured to store a record of a movement of the covering material each time that the control circuit 1020 controls the motor 1012 to adjust the present position P_{PRES} of the covering material.

The motor drive unit 1010 may include a rotational position sensing circuit 1016, such as, for example, a Hall effect sensor (HES) circuit, which may be configured to generate first and second rotational position sensing signals V_{S1}, V_{S2}. The first and second rotational position sensing signals V_{S1}, V_{S2} may indicate the rotational speed and/or the direction of rotation of the motor 1012 to the control circuit 1020. The rotational position sensing circuit 1016 may include other suitable position sensors, such as, for example, magnetic, optical, and/or resistive sensors. The control circuit 1020 may be configured to determine the rotational position of the motor 1012 in response to the first and second rotational position sensing signals V_{S1}, V_{S2} generated by the rotational position sensing circuit 1016. The control circuit 1020 may be configured to determine the present position P_{PRES} of the covering material in response to the rotational position of the motor 1012. The operation of a motor drive circuit and a rotational position sensing circuit of a motor drive unit is described in greater detail in commonly-assigned U.S. Pat. No. 5,848,934, issued Dec. 15, 1998, entitled MOTORIZED WINDOW SHADE SYSTEM, and commonly-assigned U.S. Pat. No. 7,839,109, issued Nov. 23, 2010, entitled METHOD OF CONTROLLING A MOTORIZED WINDOW TREATMENT, the entire disclosures of which are hereby incorporated by reference.

The motor drive unit 1010 may include a communication circuit 1022 that may allow the control circuit 1020 to transmit and receive messages (e.g., digital messages) via signals, e.g., wired signals and/or wireless signals, such as radio-frequency (RF) signals. For example, the control circuit 1020 may be configured to communication messages via the RF signals using a wireless communication protocol (e.g., a proprietary RF protocol, such as the CLEAR CONNECT protocol (e.g., CLEAR CONNECT TYPE A and/or CLEAR CONNECT TYPE X protocols), and/or a standard protocol, such as one of WIFI, cellular (e.g., 3G, 4G LTE, 5G NR, or other cellular protocol), BLUETOOTH, BLUETOOTH LOW ENERGY (BLE), ZIGBEE, Z-WAVE, THREAD, KNX-RF, ENOCEAN RADIO protocols, or a different standard protocol). The communication circuit 1022 may be implemented as an internal circuit of the control circuit 1020 or as an external integrated circuit (IC).

The control circuit 1020 may be configured to control the motor 1012 to control the movement of the covering material in response to a shade movement command received in messages received via the communication circuit 1022 from a remote control device. For example, the shade movement command may include a commanded position P_{CMD} to which the control circuit 1020 will control the covering material. In addition, the control circuit 1020 may be configured to receive messages from external devices. For example, the control circuit 1020 may be configured to receive messages including indications of occupancy conditions and/or vacancy conditions in the space in which the motorized window treatment is installed from occupancy sensors and/or vacancy sensors, and messages including indications of an ambient light level in the space in which the motorized window treatment is installed form daylight sensors. Further, the control circuit 1020 may be configured to transmit messages including a status of the motorized window treatment control system 1000, such as the present position P_{PRES} of the covering material. During a configuration procedure (e.g., an association procedure), the motor drive unit 1010 may be associated with a remote control device, such that the control circuit 1020 may be responsive to the messages transmitted by the remote control device (e.g., via wireless signals).

The motor drive unit 1010 may include a user interface 1024 having one or more buttons, for example, that allow a user to provide inputs to the control circuit 1020 during setup and/or configuration of the motorized window treatment. The control circuit 1020 may be configured to control the motor 1012 to control the movement of the covering material in response to a shade movement command received via the communication circuit 1022 and/or the user inputs received via the buttons of the user interface 1024. The user interface 1024 may also include one or more light-emitting diodes (LEDs) that may be illuminated by the control circuit 1020, for example, to provide feedback to a user of the motorized window treatment.

The motor drive unit 1010 may include a sensor circuit (not shown) coupled to the control circuit 1020. For example, the sensor circuit may comprise a photosensor configured to generate a signal that indicates a light level, such as a daylight level L_{DL} outside the window that the motorized window treatment is covering and/or an ambient light level L_{AMB} inside the space in which the motorized window treatment is located. The control circuit 1020 to control the motor 1012 to control the movement of the covering material in response to the daylight level L_{DL} and/or the ambient light level L_{AMB} indicated by the sensor circuit. In addition, the sensor circuit may comprise an occupancy detection circuit configured to detect when the space in which the motorized window treatment is installed is occupied and/or vacant. For example, the occupancy detection circuit may comprise a passive infrared (PIR) detection circuit for detecting movement of occupants in the space. The control circuit 1020 of the motor drive unit 1010 may be configured to control the motor 1012 to control the movement of the covering material in response to the occupancy condition and/or a vacancy condition detected by the occupancy detection circuit.

The electrical circuitry of the motor drive unit 1010 may be powered from a first storage voltage V_{S-A} produced across an energy storage element 1030 of the motor drive unit 1010. For example, the energy storage element 1030 may comprise one or more individual storage elements electrically coupled in parallel. The individual storage elements of the energy storage element 1030 may comprise, for example, one or more one or more of rechargeable batteries and/or supercapacitors. In some examples, the energy storage element 1030 may be external to the motor drive unit 1010 (e.g., external to an enclosure of the motor drive unit 1010, such as the enclosure 252 of the motor drive unit 250). The motor drive unit 1010 may comprise a power supply 1032 configured to receive the first storage voltage V_{S-A} and generate one or more supply voltages for powering the electrical circuitry of the motor drive unit 1010. For example, the power supply 1032 may be configured to generate a low-voltage supply voltage V_{CC-A} for powering the control circuit 1020, the memory, the communication circuit 1022, and/or the user interface circuit 1024. In addition, the power supply 1032 may be configured to generate the bus voltage V_{BUS} for powering the motor drive circuit 1014. In some examples, the motor drive circuit 1014 may be configured to be powered directly from the first storage voltage V_{S-A} produced across the energy storage element 1030. The energy storage element 1030 of the motor drive unit 1010 may be configured to charge through a charging circuit 1034 from a second storage voltage V_{S-B} received via electrical connections 1038.

The motor drive unit 1010 may further comprise electrical connections 1039 that may be connected to a power bus (e.g., the power bus 158 shown in FIG. 1) for coupling the motor drive unit 1010 to the motor drive units of other motorized window treatments (e.g., nearby motorized window treatments). For example, the power bus may comprise two electrical conductors (e.g., wires) coupled between the motor drive units, which may be coupled in parallel with each other. The motor drive unit 1010 may be configured to provide the storage voltage V_{S-A} produced across the energy storage element 1030 at the electrical connections 1039 (e.g., to provide the storage voltage V_{S-A} on the power bus). For example, the motor drive unit 1010 may comprise a diode D1035 coupled in series with a switching circuit 1036 between the storage voltage V_{S-A} and one of the electrical connections 1039 (e.g., with the other electrical connection 1039 coupled to circuit common). The control circuit 1020 may be configured to generate a switch control signal V_{SW} for rendering the switching circuit 1036 conductive and non-conductive for controllably providing the storage voltage V_{S-A} the electrical connections 1039. The control circuit 1020 may be configured to generate the switch control signal V_{SW} to render the switching circuit 1036 to charge energy storage elements of one or more of the other motor drive units coupled to the power bus.

The motorized window treatment control system 1000 may further comprise a bottom bar module 1040 that may be located in the bottom bar. For example, the electrical circuitry of the bottom bar module 1040 may be mounted to a printed circuit board (e.g., the printed circuit boards 272, 472, 572, 672) in the bottom bar. The bottom bar module 1040 may comprise one or more solar cells 1042 (e.g., photovoltaic cells) that may be mounted to a rear surface of the bottom bar (e.g., such as the solar cells 270, 370, 470, 570, 670, 770, 870 are mounted to the bottom bars 240, 340, 440, 540, 640, 740, 840 respectively). The solar cells 1042 may be configured to convert received solar energy into a photovoltaic output voltage V_{PV}. The bottom bar module 1040 may also comprise a solar cell management circuit 1044 configured to charge an energy storage element 1046 of the bottom bar for producing a second storage voltage V_{S-B} across the energy storage element 1046. For example, The solar cell management circuit 1044 may be configured to control the charging of the energy storage element 1046. The energy storage element 1046 of the bottom bar module 1040 may, for instance, comprise one or more individual storage elements electrically coupled in parallel. The individual storage elements of the energy storage element 1046 may comprise, for example, one or more one or more of rechargeable batteries and/or supercapacitors. For example, the solar cell management circuit 1044 may comprise a boost converter for generating the second storage voltage V_{S-B} from the photovoltaic output voltage V_{PV}. The solar cell management circuit 1044 may include, for example, a maximum power point tracking (MPPT) solar charge controller. The solar cell management circuit 1044 may be characterized by a duty cycle DC_{SCM} for driving a transistor of the boost converter circuit to generate the second storage voltage V_{S-B} from the photovoltaic output voltage V_{PV}. The solar cell management circuit 1044 may be configured to adjust the duty cycle DC_{SCM} to track a maximum power point for charging the energy storage element 1046.

The bottom bar module 1040 may comprise electrical connections 1048 configured to be coupled to (e.g., electrically and/or inductively coupled to) the electrical connections 1038 of the motor drive unit 1010 for example via electrical connections of a dock of a mounting bracket). For example, the electrical connections 1038 of the motor drive unit 1010 may represent the electrical contacts 285 of the dock 280, the electrical contact structures 490a, 490b of the dock 480, the electrical contacts 585a, 585b, 585c, 585d of the dock 580, the electrical contacts 685a, 668b, 668c, 668d of the dock 680, the electrical contacts 785a, 785b of the dock 780, and/or the electrical contacts 885a, 885b of the dock 880. In addition, the electrical connections 1048 of the bottom bar module 1040 may represent the electrical contacts 275 of the bottom bar 240, the electrical contacts 475a, 475b of the bottom bar 440, the electrical contacts 575a, 575b, 575c, 575d of the bottom bar 540, the electrical contacts 675a, 675b, 675c, 675d of the bottom bar 640, the electrical contacts 775a, 775b of the bottom bar 740, and/or the electrical contacts 875a, 875b of the bottom bar 840.

In some examples, the motor drive unit 1010 and the bottom bar module 1040 may not comprise the respective electrical connections 1038, 1048, but may alternatively comprise respective induction coils (e.g., the first induction coil 375 of the bottom bar 340 and/or the second induction coil 385 of the motor drive unit 350) to facilitate inductive coupling (e.g., magnetic coupling) between the bottom bar module 1040 and the motor drive unit 1010. When the covering material is in the raised position P_{RAISED} (e.g., when the bottom bar is docked), the electrical connections 1048 of the bottom bar module 1040 may be coupled to (e.g., electrically and/or inductively coupled to) the electrical connections 1038 of the motor drive unit 1010, such that the energy storage element 1030 of the motor drive unit 1010 is configured to charge from the energy storage element 1046 of the bottom bar module 1040 via the charging circuit 1034. While the charging circuit 1034 is shown in FIG. 31 as a part of the motor drive unit 1010, the charging circuit 1034 could alternatively or additionally be included in the bottom bar module 1040.

The bottom bar module 1040 may include a control circuit 1050 (e.g., a bottom bar control circuit), which may include, for example, a microprocessor, a programmable logic device (PLD), a microcontroller, an application specific integrated circuit (ASIC), a field-programmable gate array (FPGA), or any suitable processing device or control circuit. The control circuit 1050 of the bottom bar module 1040 monitor the operation of the solar cells 1042 and/or the energy storage element 1046. The control circuit 1050 of the bottom bar module 1040 may be configured to receive one or more sense signals V_{SNS} from the solar cell management circuit 1044. The one or more sense signals V_{SNS} received from the solar cell management circuit 1044 may indicate, for example, a magnitude of the photovoltaic output voltage V_{PV} generated by the solar cells 1042 and/or a magnitude of the second storage voltage V_{S-B} generated across the energy storage element 1046. For example, the one or more sense signals V_{SNS} generated by the solar cell management circuit 1044 may comprise direct-current (DC) signals having magnitudes that indicate the magnitude of the photovoltaic output voltage V_{PV} and/or the magnitude of the second storage voltage V_{S-B} (e.g., the solar cell management circuit 1044 may comprise one or more resistive divider circuits for generating the one or more sense signals V_{SNS}). In addition, the one or more sense signals V_{SNS} generated by the solar cell management circuit 1044 may comprise messages (e.g., digital messages) including indications of the magnitude of the photovoltaic output voltage V_{PV} and/or the magnitude of the second storage voltage V_{S-B}.

In some examples, the bottom bar module 1040 may comprise a memory (not shown), e.g., such as a non-volatile memory. The memory may be communicatively coupled to the control circuit 1050 for the storage and/or retrieval of, for example, operational settings of the bottom bar module 1040. In addition, the memory may be configured to store software for execution by the control circuit 1050. The memory may be implemented as an internal circuit of the control circuit 1050 or as an external integrated circuit (IC). The memory may comprise a computer-readable storage medium (e.g., non-transitory computer-readable storage medium) or machine-readable storage medium that maintains computer-executable instructions for performing one or more of the procedures and/or routines as described herein. For example, the memory may comprise computer-executable instructions or machine-readable instructions that include one or more portions of the procedures and/or routines described herein. The control circuit 1050 may access the instructions from memory for being executed to cause the control circuit 1020 to operate as described herein, or to operate one or more other devices as described herein. The memory may comprise computer-executable instructions for executing configuration software. In addition, the memory may have stored thereon one or more settings and/or control parameters associated with the motor drive unit 1010. The control circuit may store measurements (e.g., the magnitude of the photovoltaic output voltage V_{PV} and/or the magnitude of the second storage voltage V_{S-B}) and/or operational characteristics (e.g., the duty cycle DC_{SCM} of the solar cell management circuit 1044) in the memory.

The bottom bar module 1040 may include a communication circuit 1052 that may allow the control circuit 1050 to communicate messages (e.g., digital messages) with the communication circuit 1022 of the motor drive unit 1010 via a communication link, such as a wired communication link and/or a wireless communication link, e.g., a radio-frequency (RF) communication link. The control circuit 1050 of the bottom bar module 1040 may be configured to communicate messages with the control circuit 1020 of the motor drive unit 1010, for example, via RF signals using a short-range wireless communication protocol (e.g., the BLUETOOTH LOW ENERGY (BLE) protocol, the Thread wireless communication protocol, etc.). In addition, the communication circuit 1022 of the motor drive unit 1010 and the communication circuit 1052 of the bottom bar module 1040 may be coupled together via a wired communication link, for example, when the bottom bar is docked. For example, the communication circuit 1022 of the motor drive unit 1010 may be coupled to the electrical connections 1038 and the communication circuit 1052 of the bottom bar module 1040 may be coupled to the electrical connections 1048, such that the communication circuits 1022, 1052 are configured to communicate with each other via the electrical connections 1038, 1048 when the bottom bar is docked. In addition, the motor drive unit 1010 and/or the bottom bar module 1040 may comprise additional electrical connections to allow the communication circuits 1022, 1052 to communicate with each other via the wired communication link.

In some examples, the communication circuit 1022 and the communication circuit 1052 may be configured for infrared (IR) communication. For example, the communication circuit 1052 may comprise an IR emitter, and the communication circuit 1022 may comprise an IR receiver. As such, the communication circuit 1052 may allow the control circuit 1050 to communicate messages (e.g., digital messages) with the communication circuit 1022 of the motor drive unit 1010 via an IR communication link. In some examples, the communication circuit 1022 of the motor drive unit 1010 may include an IR receiver that may be located at an end portion of the motor drive unit 1010, and the communication circuit 1052 of the bottom bar module 1040 may include an IR transmitter that be located at a corresponding (e.g., aligned) end portion of the bottom bar. Alternatively or additionally, the communication circuit 1022 of the motor drive unit 1010 may be an IR dongle that, for example, may be coupled to the control circuit 1020 of the motor drive unit 1010 via a Universal Serial Bus (USB) connection.

The control circuit 1050 of the bottom bar module 1040 may be configured to transmit messages including measurements recorded by the bottom bar module 1040 and/or one or more operational characteristics of the bottom bar module 1040. For example, the control circuit 1050 of the bottom bar module 1040 may be configured to transmit a message including an indication of a measurement of the magnitude of the photovoltaic output voltage V_{PV} generated by the solar cells 1042 and/or an indication of a measurement of the magnitude of the second storage voltage V_{S-B} generated across the energy storage element 1046 to the control circuit 1020 of the motor drive unit 1010. In addition, the control circuit 1050 of the bottom bar module 1040 may be configured to transmit a message an indication of an operational characteristic of the solar cell management circuit 1044, such as the duty cycle DC_{SCM} of the solar cell management circuit 1044.

The bottom bar module 1040 may include a sensor circuit 1054 coupled to the control circuit 1050. For example, the sensor circuit 1054 may comprise a photosensor configured to generate a signal that indicates a light level, such as a daylight level L_{DL} outside the window that the motorized window treatment is covering and/or an ambient light level L_{AMB} inside the space in which the motorized window treatment is located. The control circuit 1050 of the bottom bar module 1040 may be configured to transmit a message including the daylight level L_{DL} and/or the ambient light level L_{AMB} indicated by the sensor circuit 1054 to the motor drive unit 1010. In addition, the sensor circuit 1054 may comprise one or more orientation detection sensors, such as an accelerometer and/or a gyroscope. For example, the control circuit 1050 of the bottom bar module 1040 may be configured to determine when the motor drive unit 1010 is adjusting the present position P_{PRES} (e.g., the bottom bar is moving) in response to the accelerometer and/or the gyroscope of the sensor circuit 1054. Further, the sensor circuit 1054 may comprise an occupancy detection circuit configured to detect when the space in which the motorized window treatment is installed is occupied and/or vacant. For example, the occupancy detection circuit may comprise a passive infrared (PIR) detection circuit for detecting movement of occupants in the space. The control circuit 1050 of the bottom bar module 1040 may be configured to transmit a message including an indication of an occupancy condition and/or a vacancy condition to the motor drive unit 1010.

The bottom bar module 1040 may also comprise a power supply 1056 configured to receive the second storage voltage V_{S-B} and generate a low-voltage supply voltage V_{CC-B} for powering the control circuit 1050, the memory, the communication circuit 1052, and/or the sensor circuit 1054.

The control circuit 1020 of the motor drive unit 1010 and/or the control circuit 1050 of the bottom bar module 1040 may be configured to determine a magnitude of a solar power P_{SOLAR} being received (e.g., presently being received) by the solar cells 1042. The control circuit 1020 of the motor drive unit 1010 and/or the control circuit 1050 of the bottom bar module 1040 may be configured to calculate the solar power P_{SOLAR} as a function of the magnitude of the photovoltaic output voltage V_{PV}, the magnitude of the second storage voltage V_{S-B}, and/or the duty cycle DC_{SCM} of the solar cell management circuit 1044 (e.g., as received from the bottom bar module 1040).

The control circuit 1020 of the motor drive unit 1010 may be configured to adjust the present position P_{PRES} of the covering material in response to the magnitude of the solar power P_{SOLAR} being received (e.g., presently being received) by the solar cells 1042 of the bottom bar module 1040. The control circuit 1020 of the motor drive unit 1010 may be configured to adjust the present position P_{PRES} of the covering material to improve the magnitude of the solar power P_{SOLAR} being received by the solar cells 1042. For example, the control circuit 1020 of the motor drive unit 1010 may be configured to adjust present position P_{PRES} of the covering material to move the bottom bar out of a location of low sunlight to a location of higher sunlight. The control circuit 1020 may be configured to compare the magnitude of the solar power P_{SOLAR} being received by the solar cells 1042 to a low-power threshold P_{TH-LP} and may be configured to move the covering material until the magnitude of the solar power P_{SOLAR} being received by the solar cells 1042 of the bottom bar module 1040 has increased above an acceptable-power threshold P_{TH-ACC}.

The control circuit 1020 of the motor drive unit 1010 may be configured to control the motor drive circuit 1014 to move the covering material to the raised position P_{RAISED}, such that the bottom bar is docked and the electrical connections 1048 of the bottom bar module 1040 may be coupled to (e.g., electrically and/or inductively coupled to) the electrical connections 1038 of the motor drive unit 1010. When the control circuit 1020 is moving the covering material to dock the bottom bar, the control circuit 1020 may control the covering material through a docking movement (e.g., a docking sequence) as the bottom bar nears the dock. For example, the control circuit 1020 may ramp down a rotational speed at which the motor is rotating as the bottom bar nears the dock.

The control circuit 1020 of the motor drive unit 1010 and/or the control circuit 1050 of the bottom bar module 1040 may be configured to determine that the bottom bar is docked by determining if the electrical connections 1038 of the motor drive unit 1010 are electrically connected to the electrical connections 1048 of the bottom bar module 1040. For example, the control circuit 1020 of the motor drive unit 1010 may be configured to determine that the bottom bar is docked by detecting that the second supply voltage V_{S-B} is present at the electrical connections 1038. In addition, the control circuit 1050 of the bottom bar module 1040 may be configured to determine that the bottom bar is docked by detecting that the motor drive unit 1010 is drawing current from the energy storage element 1046 via the electrical connections 1048. Further, the control circuit 1020 of the motor drive unit 1010 may be configured to determine that the bottom bar is docked in response to receiving a message from the bottom bar module 1040, and the control circuit 1050 of the bottom bar module 1040 may be configured to determine that the bottom bar is docked in response to receiving a message from the motor drive unit 1010. The control circuit 1020 of the motor drive unit 1010 may be configured to transmit a query message to the bottom bar module 1040, and the control circuit 1050 of the bottom bar module 1040 may be configured to transmit a response to the query message to the motor drive unit 1010. For example, the control circuit 1020 of the motor drive unit 1010 may be configured to transmit the query message to the bottom bar module 1040 via a wired communication link (e.g., via the electrical connections 1038, 1048 and/or via separate electrical connections on the dock) and/or via a wireless communication link (e.g., where the query message may indicate that the bottom bar is docked).

The control circuit 1020 of the motor drive unit 1010 and/or the control circuit 1050 of the bottom bar module 1040 may be configured to determine (e.g., automatically determine) when the motor drive unit 1010 should dock the bottom bar (e.g., move the covering material to the raised position P_{RAISED}) to charge the energy storage element 1030 from the energy storage element 1046 of the bottom bar module 1040. For example, the control circuit 1020 of the motor drive unit 1010 may be configured to determine that the bottom bar should be docked when the magnitude of the first storage voltage V_{S-A} produced across the energy storage element 1030 falls too low (e.g., is less than a low-charge threshold V_{TH-LC}). The control circuit 1020 of the motor drive unit 1010 may be move (e.g., automatically move) the covering material to the raised position P_{RAISED} when the magnitude of the first storage voltage V_{S-A} drops below the low-charge threshold V_{TH-LC}. Although described in context of storage voltages, the control circuit 1020 of the motor drive unit 1010 may be configured to determine whether or not the bottom bar should be docked (e.g., whether to charge the energy storage element of the motor drive unit) based on the state of charge of the energy storage elements of the motorized window treatment, for instance, when the state of charge of the energy storage element 1030 falls below a threshold. For example, the control circuit 1020 may be configured to calculate the state of charge of the energy storage element 1030 based on the first storage voltage V_{S-A}. In some examples, the control circuit 1020 may use the magnitude of the first storage voltage V_{S-A} as an indication of the state of charge of the energy storage element 1030.

In addition, the control circuit 1050 of the bottom bar module 1040 may be configured to determine that the bottom bar should be docked when the magnitude of the second storage voltage V_{S-B} produced across the energy storage element 1046 is greater than a high-charge threshold V_{TH-HC}. For example, the control circuit 1050 of the bottom bar module 1040 may be configured to transmit a message indicating that the bottom bar should be docked to the motor drive unit 1010 via the communication circuit 1052 when the magnitude of the second storage voltage V_{S-A} rises above the high-charge threshold V_{TH-HC}. The control circuit 1020 of the motor drive unit 1010 maybe configured to move the covering material to the raised position P_{RAISED} in response to receiving the message from the bottom bar module 1040 via the communication circuit 1022. In addition, the control circuit 1050 of the bottom bar module 1040 may be configured to transmit a message including an indication of the magnitude of the second storage voltage V_{S-A} to the motor drive unit 1010, and the motor drive unit may be configured to move the covering material to the raised position P_{RAISED} when the magnitude of the second storage voltage V_{S-A} rises above the high-charge threshold VTH-HC.

The control circuit 1020 of the motor drive unit 1010 may be configured to determine when to dock the bottom bar in response to occupancy conditions or vacancy conditions in the space in which the motorized window treatment is located. The control circuit 1020 may receive messages including indications of occupancy conditions and/or vacancy conditions in the space from the bottom bar module 1040 (e.g., as determined by the sensor circuit 1054) and/or from external occupancy sensors. For example, the control circuit 1020 may be configured to dock the bottom bar when the control circuit 1020 has determined that the bottom bar should be docked (e.g., when the magnitude of the second storage voltage V_{S-B} has risen below the high-charge threshold V_{TH-HC}) and when (e.g., only when) the space is vacant. In addition, the control circuit 1020 may be configured to dock the bottom bar when the control circuit 1020 has determined that the bottom bar should be docked (e.g., when the magnitude of the first storage voltage V_{S-A} has dropped below the low-charge threshold V_{TH-LC}) and when (e.g., only when) the space is vacant. In some examples, the control circuit 1020 may be configured to dock the bottom bar when the space is occupied, but the magnitude of the first storage voltage V_{S-A} has dropped below a critical-charge threshold VTH-CRIT (e.g., which may be smaller than the low-charge threshold V_{TH-LC}). Further, in some examples, the control circuit 1020 may use the status of one or more lighting loads as a proxy or indicator that the space is occupied or vacant. For instance, the control circuit may determine that the space is occupied when the lighting loads are on, and determine that the space is vacant when the lighting loads are off. Alternatively or additionally, the control circuit 1020 may determine that the space is occupied or vacant based on external feedback, such as indications as to whether a meeting is scheduled for the space. For instance, the control circuit 1020 may receive data from one or more calendar programs (e.g., such as Microsoft® Outlook®), and may determine that the space is vacant based on there not being a meeting scheduled for the space at a particular day and time.

The control circuit 1020 of the motor drive unit 1010 may be configured to determine when to dock the bottom bar in response to the present day of the week and/or the time of the day. For example, the control circuit 1020 may be configured to not dock the bottom bar during a nighttime period (e.g., during a privacy mode, which may be between sunset and sunrise), for example, to maintain the covering material at a lowered position P_{LOWER} to provide privacy for occupants of the space. In addition, the control circuit 1020 may be configured to dock the bottom bar at a predetermined docking time. For example, the motor drive unit 1010 (e.g., the control circuit 1020) may comprise a timeclock for keeping track of the day of the week and/or the time of the day. In addition, the control circuit 1020 may be configured to determine the present day of the week and/or the time of the day from messages received via the communication circuit 1022 (e.g., from the Internet). Further, the control circuit 1050 of the bottom bar 1040 may be configured to estimate the time of the day in response to the sensor circuit 1054. For example, the control circuit 1050 may be configured to determine that the present time of the day is during the nighttime period when the ambient light level L_{AMB} indicated by the sensor circuit 1054 is less than a nighttime threshold LTH-NIGHT, and may transmit a message indicating that the present time of the day is during the nighttime period to the motor drive unit 1010.

Further, in some examples, the control circuit 1020 may schedule one or more docking events (e.g., period and/or reoccurring docking events) based on occupancy and/or vacancy information for the space. The control circuit 1020 may be configured to determine the occupancy and vacancy of the space over time, for instance, based on the occupancy or vacant messages received from one or more occupancy or vacancy sensors. As noted herein, the control circuit 1020 may receive messages including indications of occupancy conditions and/or vacancy conditions in the space from the bottom bar module 1040 (e.g., as determined by the sensor circuit 1054) and/or from external occupancy sensors. For instance, the control circuit 1020 may determine, over time, that the space is vacant at certain days and/or times (e.g., Sundays from 8-10 am), and may schedule a docking event for those days/times. Further, in some examples, the control circuit 1020 may use the status of one or more lighting loads as a proxy or indicator that the space is occupied or vacant. For instance, the control circuit may determine that the space is occupied when the lighting loads are on, and determine that the space is vacant when the lighting loads are off. In some examples, the control circuit 1020 may determine that the space is vacant on certain days and/or times (e.g., Sundays from 8-10 am) based on the lighting loads within the space consistently being off during those days and/or times, and may schedule a docking event for those days/times. Alternatively or additionally, the control circuit 1020 may determine that the space is occupied or vacant based on external feedback, such as indications as to whether a meeting is scheduled for the space. For instance, the control circuit 1020 may receive data from one or more calendar programs (e.g., such as Microsoft® Outlook®), and may determine that the space is vacant based on there not being a meeting scheduled for the space at a particular day and time.

In addition, the control circuit 1020 of the motor drive unit 1010 may be configured to determine when to dock the bottom bar in response to one or more other factors. For example, after determining the control circuit 1020 should dock the bottom bar (e.g., based on the magnitude of the first storage voltage V_{S-A}, the magnitude of the second storage voltage V_{S-B}, the occupancy or vacancy status of the space, and/or the present day of the week and/or the time of the day), the control circuit 1020 may also consider one or more factors to determine if the control circuit 1020 should dock the bottom bar. For example, the control circuit 1020 may determine whether or not to dock the bottom bar based on the position of the sun, for example, if the sun is not shining on a façade on which the motorized window treatment system 1000 is installed, for instance, to take advance of instances where the solar cells 1042 are less likely to be missing out on collecting a relatively large amount of solar energy. In addition, the control circuit 1020 may determine whether or not to dock the bottom bar based on weather information (e.g., temperature, cloud coverage, precipitation, barometric pressure, etc.). For example, the control circuit 1020 may determine to dock the bottom bar if it is cloudy, for instance, to take advance of instances where the solar cells 1042 are less likely to be missing out on collecting a relatively large amount of solar energy. The control circuit may determine whether or not to dock the bottom bar based on feedback from the photosensor of the sensor circuits of the motor drive unit 1010. For example, the control circuit 1020 may determine to dock the bottom bar if there is less daylight as indicated by the photosensor of the motor drive unit 1010, for instance, to take advance of instances where the solar cells 1042 are less likely to be missing out on collecting a relatively large amount of solar energy.

The control circuit 1020 of the motor drive unit 1010 and/or the control circuit 1050 of the bottom bar module 1040 may be configured to measure and/or collect solar data regarding the operation of the motorized window treatment control system 1000. The solar data may comprise one or more measurements recorded by the motor drive unit 1010 and/or the bottom bar module 1040, and/or one or more operational characteristics of the motor drive unit 1010 and/or the bottom bar module 1040. For example, the measurements included in the solar data may comprise measurements of the magnitude of the photovoltaic output voltage V_{PV}, the magnitude of the second storage voltage V_{S-B}, and/or the ambient light level L_{AMB} (e.g., as measured by the sensor circuit 1054). For example, the operational characteristics included in the solar data may comprise the duty cycle DC_{SCM} of the solar cell management circuit 1044 and/or other operational characteristics of the solar cell management circuit 1044. The solar data may also comprise tracking information associated with each of the measurements and/or operational characteristics. For example, the tracking information may include timing information (e.g., a time stamp indicating a time at which the respective measurement and/or operational characteristic was recorded) and/or position information (e.g., the present position P_{PRES} of the covering material at the time at which the respective measurement and/or operational characteristic was recorded).

The control circuit 1020 of the motor drive unit 1010 and/or the control circuit 1050 of the bottom bar module 1040 may be configured to determine the solar power P_{SOLAR} (e.g., as received by the solar cells 1042) with respect to the position P_{CM} of the covering material (e.g., determine a relationship between the solar power P_{SOLAR} and the position P_{CM} of the covering material). The control circuit 1020 of the motor drive unit 1010 and/or the control circuit 1050 of the bottom bar module 1040 may be configured to calculate the solar power P_{SOLAR} using the solar data. For example, the control circuit 1020 of the motor drive unit 1010 and/or the control circuit 1050 of the bottom bar module 1040 may be configured to calculate the solar power P_{SOLAR} as a function of the magnitude of the photovoltaic output voltage V_{PV}, the magnitude of the second storage voltage V_{S-B}, and/or the duty cycle DC_{SCM} of the solar cell management circuit 1044. The control circuit 1020 of the motor drive unit 1010 and/or the control circuit 1050 of the bottom bar module 1040 may be configured to determine the solar power P_{SOLAR} at each of a plurality of intermediate positions between the raised position P_{RAISED} and the lowered position P_{LOWERED}. The control circuit 1020 of the motor drive unit 1010 and/or the control circuit 1050 of the bottom bar module 1040 may be configured to store data defining the relationship between the solar power P_{SOLAR} and the position P_{CM} of the covering material in the solar data.

The control circuit 1020 of the motor drive unit 1010 and/or the control circuit 1050 of the bottom bar module 1040 to measure and/or collect solar data regarding the operation of the motorized window treatment control system 1000 during a configuration procedure of the motorized window treatment control system 1000. During the configuration procedure, the control circuit 1020 of the motor drive unit 1010 and/or the control circuit 1050 of the bottom bar module 1040 may be configured to measure and/or collect the solar data. In addition, the control circuit 1020 of the motor drive unit 1010 and/or the control circuit 1050 of the bottom bar module 1040 may be configured to determine the solar power P_{SOLAR} with respect to the position P_{CM} of the covering material (e.g., the relationship between the solar power P_{SOLAR} and the position P_{CM} of the covering material) during the configuration procedure. For example, the configuration procedure may be completed when the motorized window treatment control system 1000 is first installed (e.g., prior to normal operation). In some examples, the control circuit 1020 of the motor drive unit 1010 may be configured to execute the configuration procedure in response to an actuation of one or more of the buttons of the user interface 1024 and/or a message received via the communication circuit 1022, and the control circuit 1050 of the bottom bar module 1040 may be configured to execute the configuration procedure in response to a message received via the communication circuit 1052. In addition, the control circuit 1020 of the motor drive unit 1010 and/or the control circuit 1050 of the bottom bar module 1040 may be configured to execute the configuration procedure during normal operation (e.g., continuously and/or periodically over time). Further, the control circuit 1020 of the motor drive unit 1010 and/or the control circuit 1050 of the bottom bar module 1040 may be configured to execute the configuration procedure in response to determining a change in the solar power P_{SOLAR} received by the solar cells 1042 (e.g., as compared to an expected solar power).

When the communication circuit 1052 of the bottom bar module 1040 is configured to communicate with the communication circuit 1022 of the motor drive unit 1010 via a wireless communication link (e.g., via RF signals using a short-range wireless communication protocol), the control circuit 1050 of the bottom bar module 1040 may be configured to periodically transmit the solar data (e.g., one or more measurements and/or operational characteristics) to the control circuit 1020 of the motor drive unit 1010 at a transmission rate T_{TX}. In some examples, the wireless communication link between the control circuit 1020 of the motor drive unit 1010 and the control circuit 1050 of the bottom bar module 1040 may be a one-way communication link (e.g., from the control circuit 1050 of the bottom bar module 1040 to the control circuit 1020 of the motor drive unit 1010) to facilitate reporting of the solar data to the control circuit 1020 of the motor drive unit 1010. In some examples, the communication circuit 1052 of the bottom bar module 1040 may be configured to communicate with the communication circuit 1022 of the motor drive unit 1010 via a wired communication link (e.g., as described herein). The control circuit 1020 of the motor drive unit 1010 may be configured to store the solar data received from the control circuit 1050 of the bottom bar module 1040 in the memory of the motor drive unit 1010. For each of the measurements and/or operational characteristics of the solar data, the control circuit 1020 of the motor drive unit 1010 may be configured to add to the solar data a respective position P_{DATA} of the covering material at the time at which the solar data was received. In some examples, the control circuit may be configured to adjust the transmission rate T_{TX} of the communication circuit 1052 based on the magnitude of the second storage voltage V_{S-B} across the energy storage element 1046. For example, the control circuit may be configured to decrease the transmission rate T_{TX} when the magnitude of the second storage voltage V_{S-B} is high, such that the control circuit 1050 transmits the solar data at a higher rate when the magnitude of the second storage voltage V_{S-B} is high than when the magnitude of the second storage voltage V_{S-B} is low.

When the communication circuit 1052 of the bottom bar module 1040 is configured to communicate with the communication circuit 1022 of the motor drive unit 1010 via a wired communication link (e.g., via the electrical connections 1038, 1048), the control circuit 1050 of the bottom bar module 1040 may be configured to collect and store the solar data in the memory of the bottom bar module 1040, and then transmit the solar data to the communication circuit 1022 of the motor drive unit 1010 via the wired communication link when the bottom bar is docked. Since the control circuit 1050 of the bottom bar module 1040 may not have access to the present position P_{PRES} of the covering material (e.g., which is maintained by the control circuit 1020 of the motor drive unit 1010), the control circuit may be configured to store in the solar data timing information (e.g., a time stamp indicating a time at which the respective measurement and/or operational characteristic was recorded). After receiving the solar data from the control circuit 1050 of the bottom bar module 1040, the control circuit 1020 of the motor drive unit 1010 may be determine a respective position P_{DATA} of the covering material for each of the measurements and/or operational characteristics of the solar data by comparing the respective time stamp with the record of movements of the covering material that are stored in the memory of the motor drive unit 1010. In some examples, the control circuit 1050 of the bottom bar module 1040 may be configured to estimate the present position P_{PRE}s of the covering material in response to the accelerometer and/or the gyroscope of the sensor circuit 1054 and add to the solar data a respective position P_{DATA} of the covering material at the time at which the measurement and/or operational characteristic was recorded.

The control circuit 1050 of the bottom bar module 1040 may be configured to record the measurements and/or operational characteristics of the solar data at a timing interval T_{TIM}. For examples, the transmission rate T_{TX} of the communication circuit communication circuit 1052 may be equal to the timing interval T_{TIM}, such the control circuit 1050 is configured to record the measurements and/or operational characteristics of the solar data and/or transmit the measurements and/or operational characteristics of the solar data at the same time (e.g., at the timing interval T_{TIM}). The control circuit 1050 may be configured to set the timing interval T_{TIM} based on whether the covering material is moving or not. For example, the control circuit 1050 may be configured to increase the timing interval T_{TIM} when the covering material is not moving and decrease the timing interval T_{TIM} when the covering material is moving. The control circuit 1050 may be configured to set the timing interval T_{TIM} to an inactive interval value T_{INACTIVE} when the covering material is not moving and to an active interval value T_{ACTIVE} when the covering material is moving, where the inactive interval value T_{INACTIVE} is longer than the active interval value T_{ACTIVE}. For example, the control circuit 1050 of the bottom bar module 1040 may be configured to determine that the covering material is moving in response to the accelerometer and/or the gyroscope of the sensor circuit 1054. In addition, the control circuit 1050 may be configured to determine that the covering material is moving in response to a message received from the control circuit 1020 of the motor drive unit 1010 (e.g., which may include an indication that the control circuit 1020 is presently moving the covering material).

The control circuit 1020 of the motor drive unit 1010 may be configured to use the solar data to configure the motor drive unit 1010 (e.g., configure the behavior of the motor drive unit 1010 during normal operation). For example, the control circuit 1020 may be configured to analyze the solar data to determine a charging position P_{CHRG} (e.g., a maximum-solar-power position) at which the solar cells 1042 of the bottom bar module 1040 may appropriately charge. For example, the charging position P_{CHRG} may be a position at which the solar cells 1042 of the bottom bar module 1040 may receive a maximum magnitude of solar power P_{SOLAR} between the lowered position P_{LOWER} and the raised position P_{RAISED}. The control circuit 1020 may be configured to control the covering material to the charging position P_{CHRG} at one or more predetermined times (e.g., when the space is vacant and/or over the weekends). In addition, the control circuit 1020 may be configured to analyze the solar data to set an upper limit position P_{UP-LIMIT} of the motorized window treatment. For example, the control circuit 1020 may be configured to determine a position between the lowered position P_{LOWER} and the raised position P_{RAISED} above which the solar cells 1042 of the bottom bar module 1040 may not receive an appropriate amount of sunlight and set that position as the upper limit position P_{UP-LIMIT}.

Further, the control circuit 1020 may be configured to analyze the solar data to identify one or more dead-bands (e.g., dead regions) between the lowered position P_{LOWER} and the raised position P_{RAISED} (e.g., positions of the covering material between which the solar cells 1042 of the bottom bar module 1040 may not receive an appropriate amount of sunlight, e.g., below a defined threshold). For example, each dead-band may be characterized by an upper dead-band limit position P_{DB-UL} and a lower dead-band limit position P_{DB-LL}. During normal operation, the control circuit 1020 may be configured to not maintain the present position P_{PRES} of the covering material within any of the dead regions between the lowered position P_{LOWER} and the raised position P_{RAISED}. For example, when a commanded position P_{CMD} of a received message falls between the upper dead-band limit position P_{DB-UL} and the lower dead-band limit position P_{DB-LL} of a dead-band, the control circuit 1020 may be configured to adjust the present position P_{PRES} of the covering material to the closet position outside of the respective dead region (e.g., to either and/or the upper dead-band limit position PDB-UL and the lower dead-band limit position P_{DB-LL} of the respective dead-band). In addition, the control circuit may be configured to adjust the present position P_{PRES} of the covering material to a position that is at least an offset amount Δ_{OFFSET} away from the respective dead-bands (e.g., either P_{DB-UL}+Δ_{OFFSET} or P_{DB-LL}−Δ_{OFFSET}).

In some examples, the motor drive unit 1010 may include electrical terminals 1037 that are configured to allow for an external power source to charge the energy storage element 1030 of the motor drive unit 1010. For example, the energy storage element 1030 of the motor drive unit 1010 may be charged (e.g., jump started) when the motorized window treatment 10 is first installed and the motor drive unit is first powered up. In addition, the energy storage element 1030 of the motor drive unit 1010 may be charged (e.g., recharged) when the energy storage element 1030 is in a condition in which the energy storage element 1030 is not able to properly charge from the energy storge element 1046 of the bottom bar module 1040 (e.g., if the solar cells 1042 are not receiving an appropriate amount of solar energy. In some examples, the electrical terminals 1037 may be a standard power supply connector, e.g., such as a universal serial bus (USB) connector. In some example, the motor drive unit 1010 (e.g., the energy storage element 1030) may be configured to receive power from an external power source via the electrical terminals 1037. For example, in the condition that the energy storage element 1030 is not able to properly charge from the energy storge element 1046 of the bottom bar module 1040, the motor drive unit 1010 (e.g., the energy storage element 1030) may be configured to receive power (e.g., continuously receive power) from an external power source, such as an external power supply and/or an external battery pack.

In some examples, the control circuit 1020 of the motor drive unit 1010 of the motorized window treatment 1000 may be configured to detect trends in storage level of the energy storage element 1030 (e.g., based on the magnitude of the first storage voltage V_{S-A}). For example, the control circuit 1020 may process the storage level (e.g., the first storage voltage V_{S-A}) of the energy storage element 1030 to determine a trend of any change in the storage level over time. For example, the control circuit 1020 may determine whether the storage level of the energy storage element 1030 is greater than or less than the storage level over a previous time period. Further, the control circuit 1020 may be configured to determine whether a rolling average of the storage level of a predetermined number of previous storage level measurements is increasing or decreasing to, for example, determine whether the energy storage element 1030 is starting to degrade (e.g., fail). In some examples, the control circuit 1020 may perform an action in response to a determination that the energy storage element 1030 is starting to degrade. For instance, the control circuit 1020 may send an alert to a mobile device and/or a system controller (e.g., indicating that the motorized window treatment system 1000 should be serviced). Alternatively or additionally, the control circuit 1020 may move the covering material to the raised position P_{RAISED} and start to shut down some of the internal components of the motorized window treatment 1000 (e.g., the communication circuit 1022). In response, a technician may change out the energy storage element 1030, charge the energy storage element 1030 (e.g., via the electrical terminals 1037 using a USB connector), and/or connect the energy storage element 1030 to an external power source, such as an external power supply and/or an external battery pack (e.g., via the electrical terminals 1037 using the USB connector).

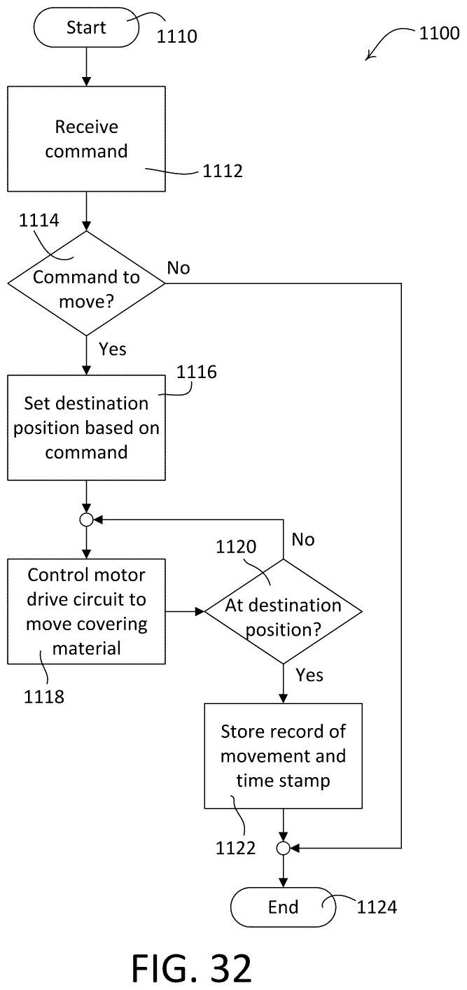

FIG. 32 is a flowchart of an example procedure 1100 for adjusting a present position P_{PRES} of a covering material of a motorized window treatment (e.g., the motorized window treatments of the embodiments shown in FIGS. 1-31). The procedure 1100 may be executed by a control circuit of a motor drive unit of the motorized window treatment (e.g., the control circuit 1020 of the motor drive unit 1010 shown in FIG. 31 and/or control circuits of the motor drive units of the motorized window treatments shown in FIGS. 1-31). For example, the control circuit may execute the procedure 1100 periodically starting at 1110. In addition, the control circuit may execute the procedure 1100 in response to receiving a message via a communication circuit at 1110.

At 1112, the control circuit of the motor drive unit may receive a command. For example, the control circuit may receive a message including a command via a communication circuit (e.g., the communication circuit 1122). The command may be, for example, a command to move the covering material (e.g., a shade movement command to adjust the present position P_{PRES} of the covering material). For example, the command may include a commanded position P_{CMD} to which the control circuit of the motor drive unit should control the present position P_{PRES} of the covering material. In addition, the command may include a command to raise or lower the present position P_{PRES} of the covering material, and the control circuit may be configured to adjust the present position P_{PRES} of the covering material by a predetermined amount AP in response to receiving the command. In some examples, the control circuit may be configured to start raising or lowering the covering material in response to receiving a message including a raise command or a lower command, respectively, and may stop raising or lowering the present position P_{PRES} of the covering material in response to receiving a message including a stop command. Further, the command in the message received at 1112 may not be a command to move the covering material, but may be a command to enter a mode (e.g., a configuration mode), a command to transmit status information of the motor drive unit, and/or other commands that are not movement commands. Additionally or alternatively, the command may be received in response to an actuation of one or more of the buttons of the motor drive unit (e.g., the button of the user interface circuit 1024). For example, the control circuit may be configured to raise or lower the present position P_{PRES} of the covering material by a predetermined amount AP in response to detecting an actuation of a first button or a second button, respectively, of the motor drive unit. In addition, the control circuit may be configured to start raising or lowering the covering material in response to detecting a first actuation of the first button or the second button, respectively, and may stop raising or lowering the present position P_{PRES} of the covering material in response to detecting a second subsequent actuation of the first button or the second button, respectively.

At 1114, the control circuit of the motor drive unit may be configured to determine if the command received at 1112 is a command to move the covering material (e.g., a shade movement command). When the command is not a command to move the covering material at 1114, the procedure 1100 may end at 1124. When the command is a command to move the covering material at 1114, the control circuit may at 1116 set a destination position P_{DE}ST for the covering material based on the command in the message received at 1112. For example, when the message includes a commanded position P_{CMD}, the control circuit may set the destination position P_{DE}ST equal to the commanded position P_{CMD} at 1116. In addition, when the message includes a raise command or a lower command, the control circuit may set the destination position P_{DE}ST to be a predetermined amount AP from the present position P_{PRES} before movement of the covering material starts at 1116 (e.g., P_{DEST}=P_{PRES}+AP when the command is a raise command or P_{DEST}=P_{PRES}−ΔP when the command is a lower command).

At 1118, the control circuit may control the motor drive circuit to rotate the motor to move the covering material. For example, the control circuit may be configured to generate at least one drive signal (e.g., the at least one drive signal V_{DR}) for controlling the motor drive circuit to control the rotational speed and the direction of rotation of the motor. At 1120, the control circuit of the motor drive unit may be configured to determine if the covering material is at the destination position P_{DE}ST. When the control circuit determines that the covering material is not at the destination position P_{DE}ST at 1120, the control circuit may continue to control the motor drive circuit to move the covering material towards the destination position P_{DE}ST at 1118. When the control circuit determines that the covering material is the destination position P_{DEST} at 1120, the control circuit may stop controlling the motor drive circuit to move the covering material and store a record of the movement of the covering material along with timing information (e.g., a time stamp indicating a time at which the movement occurred) at 1122, before the procedure 1100 ends at 1124.

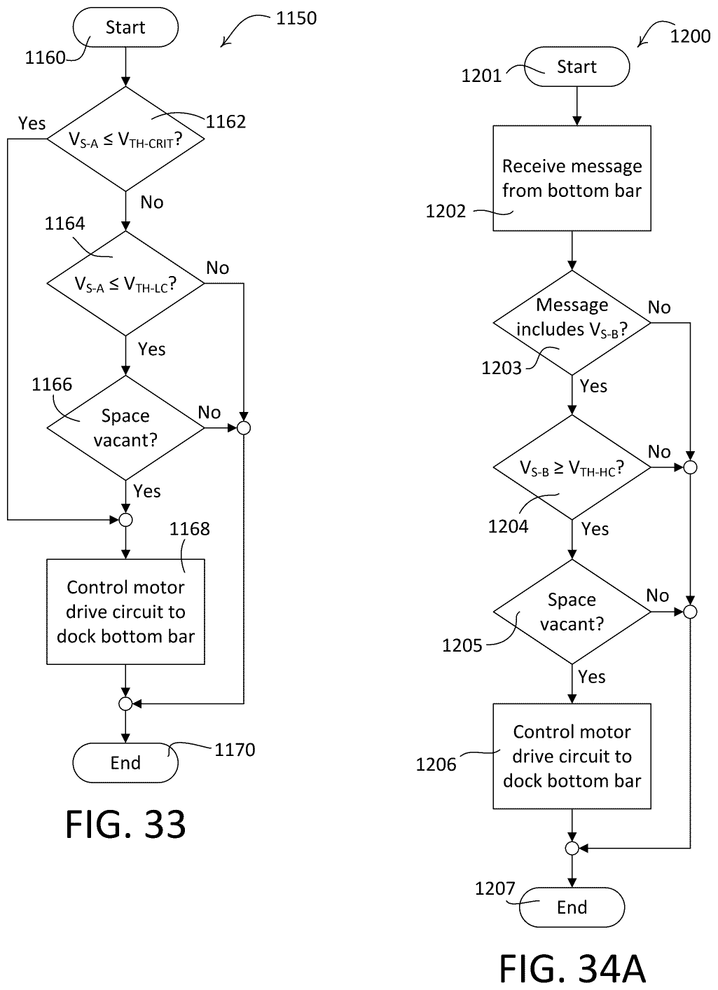

FIG. 33 is a flowchart of an example procedure 1150 for determining when to dock a bottom bar (e.g., the bottom bars 155, 240, 340, 440, 540, 640, 740, 840) of a motorized window treatment (e.g., the motorized window treatments of the embodiments shown in FIGS. 1-31). For example, the bottom bar may be connected to a bottom end of a covering material of the motorized window treatment. The procedure 1150 may be executed by a control circuit of a motor drive unit of the motorized window treatment (e.g., the control circuit 1020 of the motor drive unit 1010 shown in FIG. 31 and/or control circuits of the motor drive units shown in FIGS. 1-31). The motor drive unit may comprise a dock (e.g., the docks 280, 380, 480, 580, 680, 780, 880) that is configured to facilitate discharging of one or more energy storage elements of the bottom bar into one or more energy storage elements of the motor drive unit, for example, when the bottom bar is located adjacent to the dock (e.g., when the covering material is in the raised position P_{RAISED}).

During the procedure 1150, the control circuit may determine whether or not to dock the bottom bar in response to a magnitude of a supply voltage generated across the one or more storage element of the motor drive unit (e.g., the first storage voltage V_{S-A} produced across the energy storage element 1030 of the motor drive unit 1010). The control circuit may be configured to determine to dock the bottom bar when the magnitude of the first storage voltage V_{S-A} is less than (e.g., is less than or equal to) a low-charge threshold V_{TH-LC} and when (e.g., only when) the space is vacant. In addition, the control circuit may be configured to determine to dock the bottom bar when the magnitude of the first storage voltage V_{S-A} has dropped below a critical-charge threshold V_{TH-CRIT} (e.g., independent of whether the space is occupied or vacant). The critical-charge threshold V_{TH-CRIT} may be smaller than the low-charge threshold V_{TH-LC}. For example, the control circuit may execute the procedure 1150 periodically at 1160 to monitor the magnitude of the first storage voltage V_{S-A}. Further, it should be appreciated that in some examples, the control circuit may determine not to dock the bottom bar when the magnitude of the supply voltage generated across the one or more storage element of the motor drive unit is above an upper threshold (e.g., irrespective of whether other procedures may suggest that the bottom bar should be docked).

At 1162, the control circuit may determine if the magnitude of the first storage voltage VS-A is less than (e.g., less than or equal to) the critical-charge threshold V_{TH-CRIT}. If so, the control circuit may control a motor drive circuit of the motor drive unit (e.g., the motor drive circuit 1012) to dock the bottom bar (e.g., to adjust the present position P_{PRES} of the covering material to the raised position P_{RAISED}) at 1168, before the procedure 1150 ends at 1170. If the magnitude of the first storage voltage V_{S-A} is greater than the critical-charge threshold V_{TH-CRIT} at 1162, the control circuit may determine if the magnitude of the first storage voltage V_{S-A} is less than (e.g., less than or equal to) the low-charge threshold V_{TH-LC} at 1164. If the magnitude of the first storage voltage VS-A is greater than the low-charge threshold V_{TH-LC} at 1164, the procedure 1150 may end at 1170 (e.g., without docking the bottom bar).

If the magnitude of the first storage voltage VS-A is less than (e.g., less than or equal to) the low-charge threshold V_{TH-LC} at 1164, the control circuit may determine if the space is vacant at 1166. For example, the control circuit may be configured to determine whether the space is occupied or vacant in response to receiving a message indicating an occupancy condition or a vacancy condition in the space. If the magnitude of the first storage voltage VS-A is less than (e.g., less than or equal to) the low-charge threshold V_{TH-LC} at 1164 and the space is vacant at 1166, the control circuit may control the motor drive circuit of the motor drive unit to dock the bottom bar (e.g., to adjust the present position P_{PRES} of the covering material to the raised position P_{RAISED}) at 1168, before the procedure 1150 ends at 1170. If the magnitude of the first storage voltage VS-A is less than (e.g., less than or equal to) the low-charge threshold V_{TH-LC} at 1164 and the space is not vacant at 1166, the procedure 1150 may end at 1120 (e.g., without docking the bottom bar).

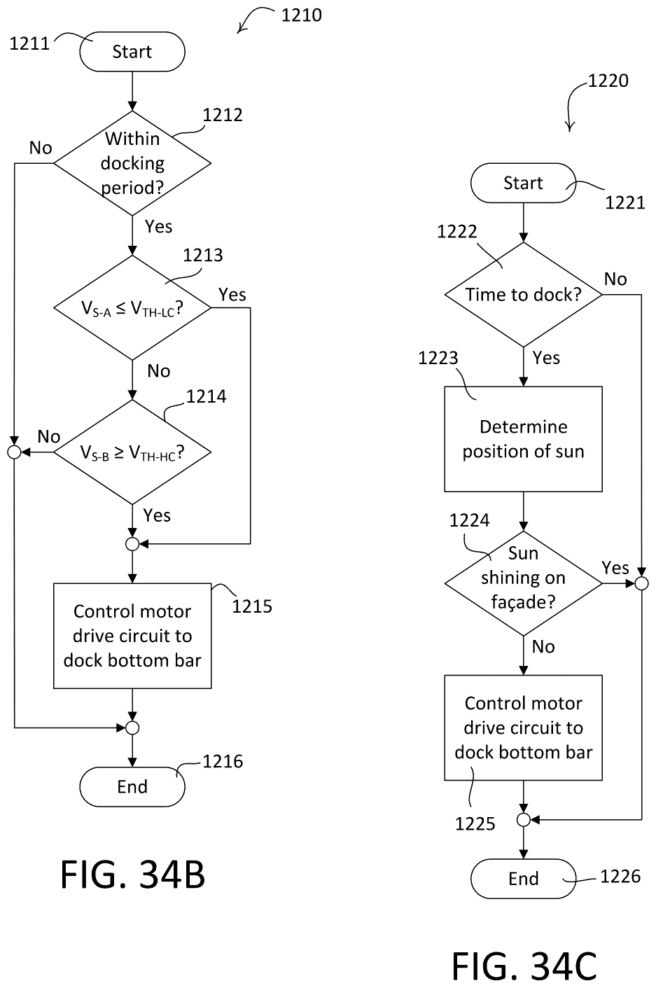

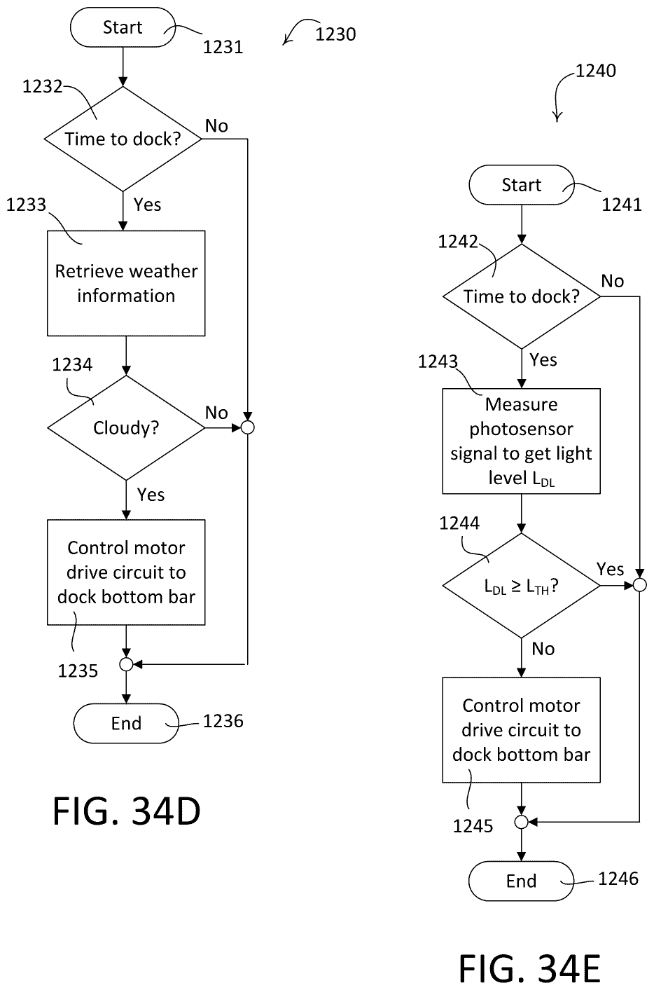

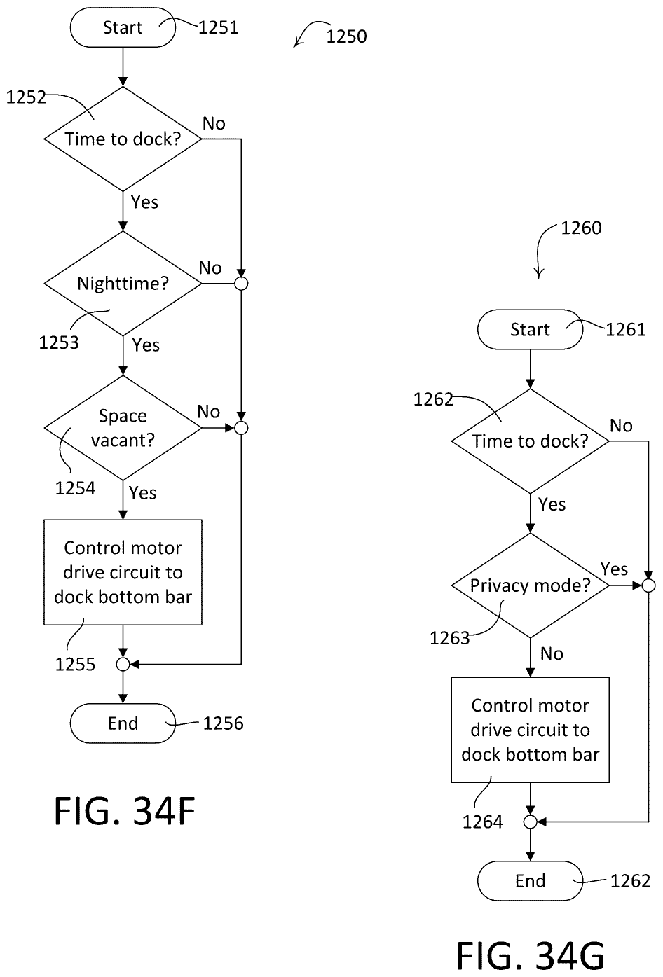

FIG. 34A is a flowchart of an example procedure 1200 for determining when to dock a bottom bar (e.g., the bottom bars 155, 240, 340, 440, 540, 640, 740, 840) of a motorized window treatment (e.g., the motorized window treatments of the embodiments shown in FIGS. 1-31). For example, the bottom bar may be connected to a bottom end of a covering material of the motorized window treatment. The procedure 1200 may be executed by a control circuit of a motor drive unit of the motorized window treatment (e.g., the control circuit 1020 of the motor drive unit 1010 shown in FIG. 31 and/or control circuits of the motor drive units of the motorized window treatments shown in FIGS. 1-31). The motor drive unit may comprise a dock (e.g., the docks 280, 380, 480, 580, 680, 780, 880) that is configured to facilitate discharging of one or more energy storage elements of the bottom bar into one or more energy storage elements of the motor drive unit, for example, when the bottom bar is located adjacent to the dock (e.g., when the covering material is in the raised position P_{RAISED}).

During the procedure 1200, the control circuit may determine whether or not to dock the bottom bar in response to a magnitude of a supply voltage generated across the one or more storage elements of the bottom bar (e.g., the second storage voltage V_{S-B} produced across the energy storage element 1046 of the bottom bar module 1040). The control circuit may be configured to determine to dock the bottom bar when the magnitude of the second storage voltage V_{S-B} is greater than (e.g., is greater than or equal to) a high-charge threshold V_{TH-HC} and when (e.g., only when) the space is vacant. The bottom bar module may be configured to transmit a message including an indication of the magnitude of the second storage voltage V_{S-B} to the motor drive unit. For example, the control circuit may execute the procedure 1200 periodically at 1201 to monitor the magnitude of the second storage voltage V_{S-B}. In addition, the control circuit may execute the procedure 1200 in response to receiving a message from the bottom bar module at 1201.

At 1202, the control circuit may receive a message from the bottom bar module. For example, the message may include an indication of the magnitude of the second storage voltage V_{S-B}. If the message includes the magnitude of the second storage voltage V_{S-B} at 1203, the control circuit may determine if the magnitude of the second storage voltage V_{S-B} is greater than (e.g., greater than or equal to) the high-charge threshold V_{TH-HC} at 1204. If the message does not include the magnitude of the second storage voltage V_{S-B} at 1203 or if the magnitude of the second storage voltage V_{S-B} is greater than (e.g., greater than or equal to) the high-charge threshold V_{TH-HC} at 1204, the procedure 1200 may end at 1207.

If the magnitude of the second storage voltage V_{S-B} is greater than (e.g., greater than or equal to) the high-charge threshold V_{TH-HC} at 1204, the control circuit may determine if the space is vacant at 1205. For example, the control circuit may be configured to determine whether the space is occupied or vacant in response to receiving a message indicating an occupancy condition or a vacancy condition in the space. If the magnitude of the second storage voltage V_{S-B} is greater than (e.g., greater than or equal to) the high-charge threshold V_{TH-HC} at 1204 and the space is vacant at 1205, the control circuit may control a motor drive circuit of the motor drive unit (e.g., the motor drive circuit 1014) to dock the bottom bar (e.g., to adjust the present position P_{PRES} of the covering material to the raised position P_{RAISED}) at 1206, before the procedure 1200 ends at 1207. If the magnitude of the second storage voltage V_{S-B} is greater than (e.g., greater than or equal to) the high-charge threshold V_{TH-LC} at 1204 and the space is not vacant at 1205, the procedure 1200 may end at 1207 (e.g., without docking the bottom bar).

Rather than transmitting a message that indicates the magnitude of the second storage voltage V_{S-B}, the bottom bar module may be configured to determine if the magnitude of the second storage voltage V_{S-B} is greater than (e.g., greater than or equal to) the high-charge threshold V_{TH-HC} and transmit a message indicating that the motor drive unit should dock the bottom bar when the magnitude of the second storage voltage V_{S-B} is greater than (e.g., greater than or equal to) the high-charge threshold V_{TH-HC}. In such an example, the control circuit of the motor drive unit may determine if the message includes an indication to dock the bottom bar at 1203 of the procedure 1200 and the determination of whether the magnitude of the second storage voltage V_{S-B} is greater than (e.g., greater than or equal to) the high-charge threshold V_{TH-HC} at 1204 may be omitted.

FIG. 34B is a flowchart of an example procedure 1210 for determining when to dock a bottom bar (e.g., the bottom bars 155, 240, 340, 440, 540, 640, 740, 840) of a motorized window treatment (e.g., the motorized window treatments of the embodiments shown in FIGS. 1-31). For example, the bottom bar may be connected to a bottom end of a covering material of the motorized window treatment. The procedure 1210 may be executed by a control circuit of a motor drive unit of the motorized window treatment (e.g., the control circuit 1220 of the motor drive unit 1010 shown in FIG. 31 and/or control circuits of the motor drive units of the motorized window treatments shown in FIGS. 1-31). The motor drive unit may comprise a dock (e.g., the docks 280, 380, 480, 580, 680, 780, 880) that is configured to facilitate discharging of one or more energy storage elements of the bottom bar into one or more energy storage elements of the motor drive unit, for example, when the bottom bar is located adjacent to the dock (e.g., when the covering material is in the raised position P_{RAISED}).

During the procedure 1210, the control circuit may determine whether or not to dock the bottom bar in response to a docking window (e.g., a docking time period), a magnitude of a supply voltage generated across the one or more energy storage elements of the motor drive unit (e.g., the first storage voltage V_{S-A} produced across the energy storage element 1030 of the motor drive unit 1010), a magnitude of a supply voltage generated across the one or more storage elements of the bottom bar (e.g., the second storage voltage V_{S-B} produced across the energy storage element 1046 of the bottom bar module 1040). The docking window may be a scheduled time that, for example, may be configured by the user. The docking window may occur periodically (e.g., at a docking interval), such as every day (e.g., every night at 3:00 am). The control circuit may be configured to determine to dock the bottom bar during the docking window when the magnitude of the first storage voltage V_{S-A} is less than (e.g., is less than or equal to) the low-charge threshold V_{TH-LC} or when the magnitude of the second storage voltage V_{S-B} is greater than (e.g., is greater than or equal to) the high-charge threshold V_{TH-HC}. The bottom bar module may be configured to transmit a message including an indication of the magnitude of the second storage voltage V_{S-B} to the motor drive unit. For example, the control circuit may periodically receive a message that indicates the magnitude of the second storage voltage V_{S-B}. The control circuit may start the procedure 1210 at 1211. The control circuit may execute the procedure 1210 periodically. In some examples, the control circuit may execute the procedure 1210 at a particular time of day (e.g., at the beginning of the docking time period and/or in response to receiving a message (e.g., a message indicating the beginning of the docking time period).

At 1212, the control circuit may determine whether the motorized window treatment is within the docking window (e.g., based on a timeclock of the control circuit and/or receiving a message indicating the beginning of the docking window). If the control circuit determines that the present time is not within the docking window, the control circuit may exit the procedure 1210. However, if the control circuit determines that the present time is within the docking window, the control circuit may determines whether the first storage voltage V_{S-A} of the energy storage elements in the motor drive unit is less than (e.g., is less than or equal to) the low-charge threshold V_{TH-LC} at 1213. If the control circuit determines that the first storage voltage V_{S-A} is less than the low-charge threshold V_{TH-LC} at 1213, the control circuit may control a motor drive circuit of the motor drive unit (e.g., the motor drive circuit 1012) to dock the bottom bar (e.g., to adjust the present position P_{PRES} of the covering material to the raised position P_{RAISED}) at 1215, before the procedure 1210 ends at 1216. As such, if the control circuit determines that the first storage voltage V_{S-A} is less than the low-charge threshold V_{TH-LC} during the docking window, the control circuit may dock the bottom bar (e.g., to charge the storage element of the motor drive unit when the first storage voltage level V_{S-A} is low during the scheduled docking window).

If the control circuit determines that the first storage voltage V_{S-A} is greater than the low-charge threshold V_{TH-LC} at 1213, the control circuit may determine whether the magnitude of the second storage voltage V_{S-B} of the energy storage elements in the bottom bar is greater than (e.g., is greater than or equal to) the high-charge threshold V_{TH-HC} at 1214. If the control circuit determines that the magnitude of the second storage voltage V_{S-B} is greater than the high-charge threshold V_{TH-HC} at 1214, the control circuit may control the motor drive circuit of the motor drive unit to dock the bottom bar at 1215, before the procedure 1210 ends at 1216. As such, if the control circuit determines that the magnitude of the second storage voltage V_{S-B} is greater than the high-charge threshold V_{TH-HC} during the docking window, the control circuit may dock the bottom bar (e.g., to charge the storage element of the motor drive unit and discharge the storage elements of the bottom bar during the scheduled docking window). However, if the control circuit determines that the magnitude of the second storage voltage V_{S-B} is less than the high-charge threshold V_{TH-HC} at 1214, the control circuit may exit the procedure 1210 at 1216 (e.g., without docking the bottom bar), for example, because there is little benefit to moving the docking the bottom bar if the first storage voltage V_{S-A} is greater than the low-charge threshold V_{TH-LC} and the second storage voltage V_{S-B} is less than the high-charge threshold VTH-HC.

FIG. 34C is a flowchart of an example procedure 1220 for determining when to dock a bottom bar (e.g., the bottom bars 155, 240, 340, 440, 540, 640, 740, 840) of a motorized window treatment (e.g., the motorized window treatments of the embodiments shown in FIGS. 1-31). For example, the bottom bar may be connected to a bottom end of a covering material of the motorized window treatment. The procedure 1220 may be executed by a control circuit of a motor drive unit of the motorized window treatment (e.g., the control circuit 1020 of the motor drive unit 1010 shown in FIG. 31 and/or control circuits of the motor drive units of the motorized window treatments shown in FIGS. 1-31). The motor drive unit may comprise a dock (e.g., the docks 280, 380, 480, 580, 680, 780, 880) that is configured to facilitate discharging of one or more energy storage elements of the bottom bar into one or more energy storage elements of the motor drive unit, for example, when the bottom bar is located adjacent to the dock (e.g., when the covering material is in the raised position P_{RAISED}).

During the procedure 1220, the control circuit may determine whether or not to dock the bottom bar based on the position of the sun. For example, the control circuit may determine to dock the bottom bar if the sun is not shining on a façade on which the motorized window treatment is installed, for instance, to take advance of instances where the solar cells are less likely to be missing out on collecting a relatively large amount of solar energy. The control circuit (e.g., and/or a system controller that is in communication with the control circuit) may be configured to calculate a predicted position of the sun at a plurality of discrete times in a day. The position of the sun in the sky may be defined by a solar altitude angle aₜ and a solar azimuth angle a_{S}. The control circuit may determine the solar altitude angle aₜ and the solar azimuth angle aₛ as functions of the date (e.g., a Julian date) and time (e.g., the standard time tₛ), as well as the position (e.g., longitude λ and latitude φ) of the building in which the window and/or motorized window treatment is located.

For example, the system controller and/or the control circuit may be configured to calculate the solar altitude angle aₜ and the solar azimuth angle aₛ using the following equations. The difference in a solar time tₛₒₗₐᵣ (e.g., a time as given by a sundial) and a standard time tₛ (e.g., a time as given by a clock) due to the obliquity of the Earth's axis of rotation may be defined by an equation of time ET. The equation of time ET can be determined as a function of the present Julian date J using, for example, the equation:

ET=0.1644·sin(A)−0.1273·cos(B), (Equation 1)

where A=[4π(J−81.6)]/365.25 and B=[2π·(J−2.5)]/365.25. The Julian date J may be a decimal number representing the present day in the year. For example, the Julian date J may equal one for January 1, two for January 2, three for January 3, and so on. The solar time tₛₒₗₐᵣ may be calculated as a function of the standard time tₛ, the equation of time ET, a standard meridian SM of the time zone of the location of the building, and the longitude λ, for example, using the equation:

tₛₒₗₐᵣ=tₛ+ET+[12·(SM−λ)]/π. (Equation 2)

The standard meridian SM may be determined from the time zone of the location of the building. Each time zone may have a unique standard meridian, which may define a particular line of latitude within the time zone. There may be approximately 15° between the standard meridians of adjacent time zones. The solar altitude angle aₛ and the solar azimuth angle a_{z} may be determined from a solar declination δ. The solar declination δ may define an angle of incidence of the rays of the sun on the equatorial plane of the Earth. The solar declination δ may be determined using, for example, the equation:

δ=0.4093·sin[2π·(J−81)/368]. (Equation 3)

The solar altitude angle aₜ at the standard time is may be calculated as a function of the solar time tₛₒₗₐᵣ, the solar declination δ, and the local latitude Φ using, for example, the equation:

aₜ=arc sin [sin(Φ)·sin(δ)−cos(Φ)·cos(δ)·cos(π·tₛₒₗₐᵣ/12)]. (Equation 4)

The solar azimuth angle aₛ at the standard time is may be calculated as a function of the solar time tₛₒₗₐᵣ, the solar declination δ, and the local latitude Φ using, for example, the equation:

aₛ=arc tan [−cos(δ)·sin(7·tₛₒₗₐᵣ/12)/C], (Equation 5)
where C=−[cos(φ)·sin(δ)+sin(φ)·cos(δ)·cos(π·tₛₒₗₐᵣ/12)].

An example of a motorized window treatment that is configured to determine the position of the sun is described in U.S. Patent Pub. No. 2021/0180399, which is hereby incorporated by reference in its entirety.

The procedure 1220 may start at 1221. At 1222, the control circuit may determine whether it is time to dock the bottom bar of the motorized window treatment. For example, the control circuit may determine whether it is time to dock the bottom bar using one or more of the methods described herein, such as based on the reception of an instruction to dock, a timeclock, a docking window or interval, the charge of the energy storage elements of the motor drive unit and/or the bottom bar, etc. If the control circuit determines that it is not time to dock, the procedure 1220 may exit at 1226. In some examples, the determination of whether or not to dock at 1222 may be omitted.

If the control circuit determines that it is time to dock, the control circuit may determine the position of the sun at 1223. For example, the control circuit may calculate the position of the sun based on a predicted position of the sun. Alternatively, the control circuit may receive an indication of the predicted position of the sun from a system controller. At 1224, the control circuit may determine whether the sun may be shining on a façade of the building of which the motorized window treatment is installed. Since there may be cloud cover or another obstruction between the façade and the sun, the predicted position of the sun may indicate whether there is potentially sun shining on the façade of the building of which the motorized window treatment is installed. For example, the control circuit may be configured to determine whether the sun may be shining on the façade of which the motorized window treatment is installed at 1223 by comparing the calculated solar altitude angle aₜ and/or the calculated solar azimuth angle aₛ to one or more thresholds to determine if the calculated solar altitude angle aₜ and/or the calculated solar azimuth angle aₛ are within ranges that indicate that the sun may be shining on the façade. If the control circuit determines that the sun may be shining on the façade, the procedure 1220 may exit at 1226.

If the control circuit determines that the sun is not shining on the façade at 1224, the control circuit may control the motor drive circuit to dock the bottom bar at 1225, before the procedure 1220 exits at 1226. For instance, the control circuit may control a motor drive circuit of the motor drive unit (e.g., the motor drive circuit 1012) to dock the bottom bar (e.g., to adjust the present position P_{PRES} of the covering material to the raised position P_{RAISED}) at 1225, before the procedure 1220 ends at 1226. As such, if the control circuit determines that the sun is not shining on the façade, the control circuit may dock the bottom bar because the solar cells of the bottom bar are unlikely to be receiving solar energy (e.g., or significant solar energy) from the sun at that moment in time. Therefore, docking the bottom bar when the sun is not shining on the façade will allow the bottom bar to dock when there is a lower likelihood or probability that the solar cells would be missing out on collecting a relatively large amount of solar energy.

FIG. 34D is a flowchart of an example procedure 1230 for determining when to dock a bottom bar (e.g., the bottom bars 155, 240, 340, 440, 540, 640, 740, 840) of a motorized window treatment (e.g., the motorized window treatments of the embodiments shown in FIGS. 1-31). For example, the bottom bar may be connected to a bottom end of a covering material of the motorized window treatment. The procedure 1230 may be executed by a control circuit of a motor drive unit of the motorized window treatment (e.g., the control circuit 1020 of the motor drive unit 1010 shown in FIG. 31 and/or control circuits of the motor drive units of the motorized window treatments shown in FIGS. 1-31). The motor drive unit may comprise a dock (e.g., the docks 280, 380, 480, 580, 680, 780, 880) that is configured to facilitate discharging of one or more energy storage elements of the bottom bar into one or more energy storage elements of the motor drive unit, for example, when the bottom bar is located adjacent to the dock (e.g., when the covering material is in the raised position P_{RAISED}).

During the procedure 1230, the control circuit may determine whether or not to dock the bottom bar based on weather information (e.g., temperature, cloud coverage, precipitation, barometric pressure, etc.). For example, the control circuit may determine to dock the bottom bar if it is cloudy, for instance, to take advance of instances where the solar cells are less likely to be missing out on collecting a relatively large amount of solar energy. The control circuit (e.g., and/or a system controller that is in communication with the control circuit) may be configured to determine the weather in the location of the motorized window treatment from an external source, such as a weather service (e.g., via the Internet), a weather application, and/or a weather application programming interface (API).

The procedure 1230 may start at 1231. At 1232, the control circuit may determine whether it is time to dock the bottom bar of the motorized window treatment. For example, the control circuit may determine whether it is time to dock the bottom bar using one or more of the methods described herein, such as based on the reception of an instruction to dock, a timeclock, a docking window or interval, the charge of the energy storage elements of the motor drive unit and/or the bottom bar, etc. If the control circuit determines that it is not time to dock, the procedure 1230 may exit at 1236. In some examples, the determination of whether or not to dock at 1232 may be omitted.

If the control circuit determines that it is time to dock, the control circuit may retrieve weather information at 1233. For example, the control circuit may retrieve the weather information (e.g., directly or indirectly, via a system controller) from a weather application. At 1234, the control circuit may determine whether it is cloudy at the location of the motorized window treatment. If the control circuit determines that it is not cloudy, the procedure 1230 may exit at 1236.

If the control circuit determines that it is cloudy at 1234, the control circuit may control the motor drive circuit to dock the bottom bar at 1235, before the procedure 1230 exits at 1236. For instance, the control circuit may control a motor drive circuit of the motor drive unit (e.g., the motor drive circuit 1014) to dock the bottom bar (e.g., to adjust the present position P_{PRES} of the covering material to the raised position P_{RAISED}) at 1235, before the procedure 1230 ends at 1236. As such, if the control circuit determines that it is cloudy at the location of the motorized window treatment, the control circuit may dock the bottom bar because the solar cells of the bottom bar are unlikely to be receiving solar energy (e.g., or significant solar energy) from the sun at that moment in time. Therefore, docking the bottom bar when it is cloudy will allow the bottom bar to dock when there is a lower likelihood or probability that the solar cells would be missing out on collecting a relatively large amount of solar energy.

FIG. 34E is a flowchart of an example procedure 1240 for determining when to dock a bottom bar (e.g., the bottom bars 155, 240, 340, 440, 540, 640, 740, 840) of a motorized window treatment (e.g., the motorized window treatments of the embodiments shown in FIGS. 1-31). For example, the bottom bar may be connected to a bottom end of a covering material of the motorized window treatment. The procedure 1240 may be executed by a control circuit of a motor drive unit of the motorized window treatment (e.g., the control circuit 1020 of the motor drive unit 1010 shown in FIG. 31 and/or control circuits of the motor drive units of the motorized window treatments shown in FIGS. 1-31). The motor drive unit may comprise a dock (e.g., the docks 280, 380, 480, 580, 680, 780, 880) that is configured to facilitate discharging of one or more energy storage elements of the bottom bar into one or more energy storage elements of the motor drive unit, for example, when the bottom bar is located adjacent to the dock (e.g., when the covering material is in the raised position P_{RAISED}).

During the procedure 1240, the control circuit may determine whether or not to dock the bottom bar based on feedback from a photosensor. For instance, in some examples, the motorized window treatment (e.g., the motor drive unit and/or the bottom bar) may include a photosensor that is configured to measure light and generate a signal indicating the amount of light. As such, the control circuit may receive an indication of the amount of light from the photosensor and determine a light level L_{DL}. The photosensor may be oriented such that it faces towards the window to measure the amount of light (e.g., sunlight) hitting the window (e.g., which may be an indicator of the amount of light directed towards the solar cells of the motorized window treatment). For example, the control circuit may determine to dock the bottom bar if there is less light, for instance, to take advance of instances where the solar cells are less likely to be missing out on collecting a relatively large amount of solar energy.

The procedure 1240 may start at 1241. At 1242, the control circuit may determine whether it is time to dock the bottom bar of the motorized window treatment. For example, the control circuit may determine whether it is time to dock the bottom bar using one or more of the methods described herein, such as based on the reception of an instruction to dock, a timeclock, a docking window or interval, the charge of the energy storage elements of the motor drive unit and/or the bottom bar, etc. If the control circuit determines that it is not time to dock, the procedure 1240 may exit at 1246. In some examples, the determination of whether or not to dock at 1242 may be omitted.

If the control circuit determines that it is time to dock, the control circuit may measure the signal from the photosensor to determine the light level L_{DL} at 1243. For example, the photosensor may be oriented such that it faces towards the window, and as such, the light level L_{DL} may indicate the amount of light (e.g., sunlight) hitting the window (e.g., which may be an indicator of the amount of light directed towards the solar cells of the motorized window treatment). At 1244, the control circuit may determine whether the light level L_{DL} is greater than or equal to a threshold light level L_{TH}. If the control circuit determines that the light level L_{DL} is greater than or equal to the threshold light level L_{TH}, the procedure 1240 may exit at 1246.

If the control circuit determines that the light level L_{DL} is less than the threshold light level L_{TH} at 1244, the control circuit may control the motor drive circuit to dock the bottom bar at 1245, before the procedure 1240 exits at 1246. For instance, the control circuit may control a motor drive circuit of the motor drive unit (e.g., the motor drive circuit 1012) to dock the bottom bar (e.g., to adjust the present position P_{PRES} of the covering material to the raised position P_{RAISED}) at 1245, before the procedure 1240 ends at 1246. As such, if the control circuit determines that the light level L_{DL} is less than the threshold light level L_{TH}, the control circuit may dock the bottom bar because the solar cells of the bottom bar are unlikely to be receiving solar energy (e.g., or significant solar energy) from the sun at that moment in time. Therefore, docking the bottom bar when the photosensor measures lower light levels will allow the bottom bar to dock when there is a lower likelihood or probability that the solar cells would be missing out on collecting a relatively large amount of solar energy.

FIG. 34F is a flowchart of an example procedure 1250 for determining when to dock a bottom bar (e.g., the bottom bars 155, 240, 340, 440, 540, 640, 740, 840) of a motorized window treatment (e.g., the motorized window treatments of the embodiments shown in FIGS. 1-31). For example, the bottom bar may be connected to a bottom end of a covering material of the motorized window treatment. The procedure 1250 may be executed by a control circuit of a motor drive unit of the motorized window treatment (e.g., the control circuit 1020 of the motor drive unit 1010 shown in FIG. 31 and/or control circuits of the motor drive units of the motorized window treatments shown in FIGS. 1-31). The motor drive unit may comprise a dock (e.g., the docks 280, 380, 480, 580, 680, 780, 880) that is configured to facilitate discharging of one or more energy storage elements of the bottom bar into one or more energy storage elements of the motor drive unit, for example, when the bottom bar is located adjacent to the dock (e.g., when the covering material is in the raised position P_{RAISED}).

During the procedure 1250, the control circuit may determine whether or not to dock the bottom bar based on whether it is nighttime and/or the space is vacant. The control circuit may determine it is nighttime based on a timeclock (e.g., nighttime may be defined as between an hour range, such as between 9 pm and 5 am). The control circuit may determine the space is vacant based on feedback from one or more occupancy and/or vacancy sensors (e.g., directly or indirectly by way of a system controller). The control circuit may determine to dock the bottom bar if it is nighttime and the space is vacant, for instance, because nobody is in the space (e.g., it will cause less disruption to the user) and to take advance of instances where the solar cells are less likely to be missing out on collecting a relatively large amount of solar energy.

The procedure 1250 may start at 1251. At 1252, the control circuit may determine whether it is time to dock the bottom bar of the motorized window treatment. For example, the control circuit may determine whether it is time to dock the bottom bar using one or more of the methods described herein, such as based on the reception of an instruction to dock, a timeclock, a docking window or interval, the charge of the energy storage elements of the motor drive unit and/or the bottom bar, etc. If the control circuit determines that it is not time to dock, the procedure 1250 may exit at 1256. In some examples, the determination of whether or not to dock at 1252 may be omitted.

If the control circuit determines that it is time to dock, the control circuit may determine whether it is nighttime at 1253. For example, the control circuit may determine that it is nighttime based on a timeclock and/or based on a message received from a system controller. In some examples, the control circuit may determine that it is nighttime when it is between an hour range, such as between 9 pm and 5 am, and/or based on times of sunset and sunrise for the location of the motorized window treatment and at the particular time of the year (e.g., when the timeclock is an astronomical timeclock). If the control circuit determines that it is not nighttime, the procedure 1250 may exit at 1256.

If the control circuit determines that it is nighttime at 1253, the control circuit may determine whether the space is vacant at 1254. For example, the control circuit may receive an occupied command and/or a vacant command from an occupancy sensor (e.g., directly, or indirectly via a system controller). In some examples, the occupancy sensor may be located on the bottom bar. Alternatively or additionally, the control circuit may be configured to determine that the space is vacant based on data received from one or more calendar programs (e.g., no meeting is scheduled in the space at that time). If the control circuit determines that the space is not vacant, the procedure 1250 may exit at 1256.

If the control circuit determines that the space is vacant at 1254, the control circuit may control the motor drive circuit to dock the bottom bar at 1255, before the procedure 1250 exits at 1256. For instance, the control circuit may control a motor drive circuit of the motor drive unit (e.g., the motor drive circuit 1012) to dock the bottom bar (e.g., to adjust the present position P_{PRES} of the covering material to the raised position P_{RAISED}) at 1255, before the procedure 1250 ends at 1256. As such, if the control circuit determines that it is nighttime and that the space is vacant, the control circuit may dock the bottom bar because the movement of the bottom bar will not bother the user (e.g., in the case of a commercial building) and the solar cells of the bottom bar are unlikely to be receiving solar energy (e.g., or significant solar energy) from the sun at that moment in time.

FIG. 34G is a flowchart of an example procedure 1260 for determining when to dock a bottom bar (e.g., the bottom bars 155, 240, 340, 440, 540, 640, 740, 840) of a motorized window treatment (e.g., the motorized window treatments of the embodiments shown in FIGS. 1-31). For example, the bottom bar may be connected to a bottom end of a covering material of the motorized window treatment. The procedure 1260 may be executed by a control circuit of a motor drive unit of the motorized window treatment (e.g., the control circuit 1020 of the motor drive unit 1010 shown in FIG. 31 and/or control circuits of the motor drive units of the motorized window treatments shown in FIGS. 1-31). The motor drive unit may comprise a dock (e.g., the docks 280, 380, 480, 580, 680, 780, 880) that is configured to facilitate discharging of one or more energy storage elements of the bottom bar into one or more energy storage elements of the motor drive unit, for example, when the bottom bar is located adjacent to the dock (e.g., when the covering material is in the raised position P_{RAISED}).

During the procedure 1260, the control circuit may determine whether or not to dock the bottom bar based on whether the motorized window treatment is in privacy mode. The motorized window treatment may be configured to enter a privacy mode where, for example, the covering material will remain in the lowered position P_{LOWERED}. The privacy mode may be defined by a timeclock schedule (e.g., the privacy mode may be activated and deactivated based on the timeclock schedule). For example, the control circuit may determine that it is nighttime based on a timeclock and/or based on a message received from a system controller. For instance, privacy mode may be defined by one or more time periods (e.g., a time period during the morning, such as between 6-8 am, and a time period at night, such as between 8-10 pm). In some examples, the time periods defined by the privacy mode may be based on sunrise and/or sunset times for the location of the motorized window treatment and at the particular time of the year (e.g., via an astronomical timeclock). When in the privacy mode, the control circuit of the motor drive unit may ensure that the covering material is in the lowered position P_{LOWERED} to ensure that the user has privacy. In some examples, during the privacy mode, the control circuit may disable certain docking movements and/or procedures to ensure that the covering material does not move from the lowered position P_{LOWERED} (e.g., unless a direct command from the user is received). The control circuit may determine not to dock the bottom bar if the motorized window treatment is in privacy mode to, for example, ensure that the covering material remains in the lowered position P_{LOWERED}.

The procedure 1260 may start at 1261. At 1262, the control circuit may determine whether it is time to dock the bottom bar of the motorized window treatment. For example, the control circuit may determine whether it is time to dock the bottom bar using one or more of the methods described herein, such as based on a timeclock, a docking window or interval, the charge of the energy storage elements of the motor drive unit and/or the bottom bar, etc. If the control circuit determines that it is not time to dock, the procedure 1260 may exit at 1265. In some examples, the determination of whether or not to dock at 1262 may be omitted.

If the control circuit determines that it is time to dock, the control circuit may determine whether it is in privacy mode at 1263. The privacy mode may be defined by a timeclock schedule. For instance, privacy mode may be defined by one or more time periods (e.g., a time period during the morning, such as between 6-8 am, and a time period at night, such as between 8-10 pm). In some examples, the time periods defined by the privacy mode may be based on sunrise and/or sunset times for the location of the motorized window treatment and at the particular time of the year (e.g., via astronomical timeclock).

If the control circuit determines that it is not in privacy mode at 1263, the control the motor drive circuit to dock the bottom bar at 1264, before the procedure 1260 exits at 1265. For instance, the control circuit may control a motor drive circuit of the motor drive unit (e.g., the motor drive circuit 1012) to dock the bottom bar (e.g., to adjust the present position P_{PRES} of the covering material to the raised position P_{RAISED}) at 1264, before the procedure 1260 ends at 1265. If the control circuit determines that it is in privacy mode at 1263, the procedure 1260 may exit at 1265. As such, even though the control circuit determines that it is time to dock at 1262, the control circuit will not dock if the control circuit determines that it is in privacy mode at 1263.

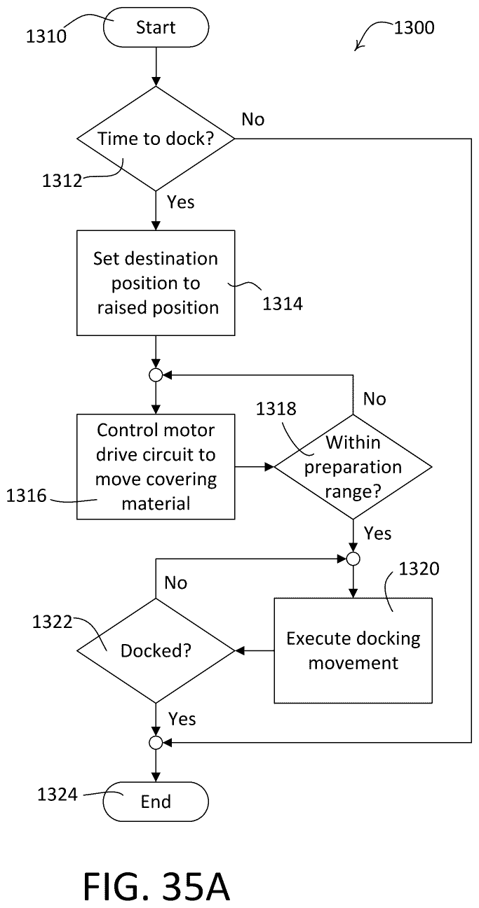

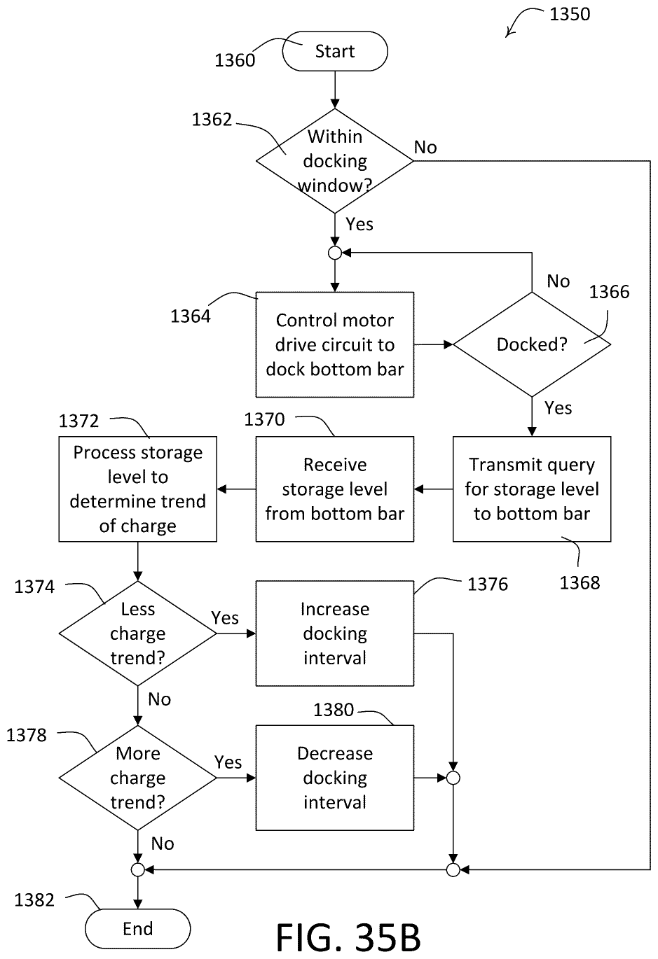

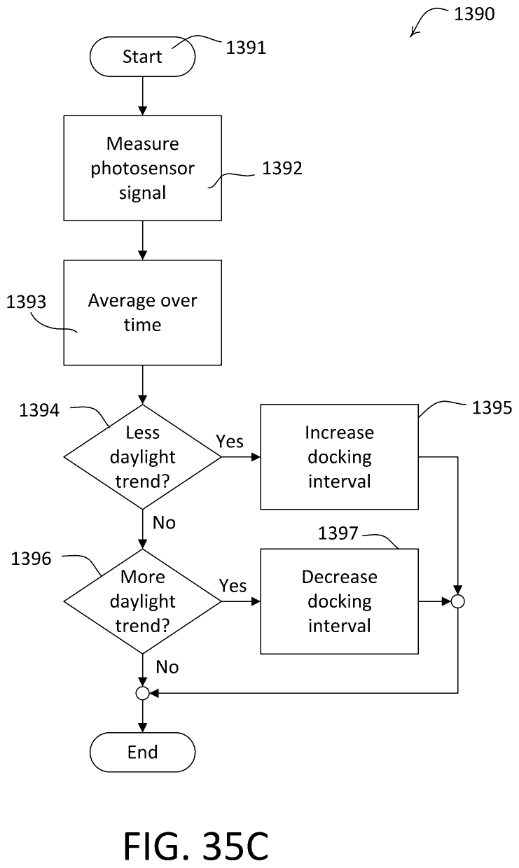

FIG. 35A is a flowchart of an example procedure 1300 for docking a bottom bar (e.g., the bottom bars 155, 240, 340, 440, 540, 640, 740, 840) of a motorized window treatment (e.g., the motorized window treatments of the embodiments shown in FIGS. 1-31). For example, the bottom bar may be connected to a bottom end of a covering material of the motorized window treatment. The procedure 1300 may be executed by a control circuit of a motor drive unit of the motorized window treatment (e.g., the control circuit 1020 of the motor drive unit 1010 shown in FIG. 31 and/or control circuits of the motor drive units of the motorized window treatments shown in FIGS. 1-31). The motor drive unit may be configured to control a present position P_{PRES} of the covering material. The motor drive unit may comprise a dock (e.g., the docks 280, 380, 480, 580, 680, 780, 880) that is configured to facilitate discharging of one or more energy storage elements of the bottom bar into one or more energy storage elements of the motor drive unit, for example, when the bottom bar is located adjacent to the dock (e.g., when the covering material is in the raised position P_{RAISED}). For example, the control circuit may execute the procedure 1300 periodically at 1310 to determine if the bottom bar should be docked (e.g., should control the present position P_{PRES} of the covering material to the raised position P_{RAISED}).

At 1312, the control circuit of the motor drive unit may be configured to determine if the motor drive unit should presently dock the bottom bar. For example, the control circuit may be configured to determine that the bottom bar should be docked when the space in which the motorized window treatment is installed is vacant and the magnitude of a first storage voltage V_{S-A} produced across an energy storage element of the motor drive unit is less than a low-charge threshold V_{TH-LC}, and/or the space is occupied and the magnitude of the first storage voltage V_{S-A} produced across the energy storage element of the motor drive unit is less than a critical-charge threshold V_{TH-CRIT} (e.g., as shown in FIG. 33). In addition, the control circuit may determine to that the bottom bar should be docked when the magnitude of a second storage voltage V_{S-A} produced across an energy storage element of the bottom bar module is greater than a high-charge threshold V_{TH-HC} (e.g., as shown in FIG. 34A). Further, the control circuit of the motor may be configured to determine that the bottom bar should be docked in response to the present day of the week and/or the time of the day. When the control circuit determines that the motor drive unit should not presently dock the bottom bar at 1312, the procedure 1300 may end at 1324.

When the control circuit determines that the motor drive unit should presently dock the bottom bar at 1312, the control circuit may set a destination position P_{DEST} to the raised position P_{RAISED} at 1314 and control the motor drive circuit to rotate the motor to move the covering material at 1316. For example, the control circuit may be configured to generate at least one drive signal (e.g., the at least one drive signal V_{DR}) for controlling the motor drive circuit to control the rotational speed and the direction of rotation of the motor at 1316.

In some examples, even if the control circuit determines that the motor drive unit should dock the bottom bar at 1312, the control circuit may skip the docking event. For example, the control circuit may skip the docking event if the magnitude of the first storage voltage V_{S-A} produced across the energy storage element of the motor drive unit is above a charge threshold (e.g., the energy storage element of the motor drive unit has sufficient charge). Further, in some examples, even if the control circuit determines that the motor drive unit should dock the bottom bar at 1312, the control circuit may send a message (e.g., via email, text, an alert via a mobile app, etc.) to a user, and wait to dock until a confirmation is received from the user that the motor drive unit should dock the bottom bar.

At 1318, the control circuit of the motor drive unit may determine if the present position P_{PRES} of is within a docking preparation range. For example, the docking preparation range may extend a predetermined distance from the raised position P_{RAISE}. When the covering material is not within the docking preparation range 1318, the control circuit may continue to control the motor drive circuit to rotate the motor to move the covering material at 1316. When the covering material is within the docking preparation range at 1318, the control circuit may control the motor through a docking movement (e.g., a docking sequence) at 1320. For example, the control circuit may ramp down the rotational speed at which the motor is rotating as the bottom bar nears the dock as part of the docking movement.

At 1322, the control circuit of the motor drive unit may determine if the bottom bar is docked. For example, the control circuit may be configured to determine if the bottom bar is docked by determining if electrical connections of the dock of the motor drive unit are electrically connected to the electrical connections of the bottom bar module at 1322. For example, the control circuit may be configured to determine that the bottom bar is docked by detecting that the second supply voltage V_{S-B} is present at the electrical connection of the dock (e.g., the electrical connections 1038). When the control circuit determines that the bottom bar is not presently docked at 1322, the control circuit may continue to control the motor through the docking movement at 1320. When the control circuit determines that the bottom bar is presently docked at 1322, the procedure 1300 may end at 1324.

FIG. 35B is a flowchart of an example procedure 1350 for docking a bottom bar (e.g., the bottom bars 155, 240, 340, 440, 540, 640, 740, 840) of a motorized window treatment (e.g., the motorized window treatments of the embodiments shown in FIGS. 1-31). For example, the bottom bar may be connected to a bottom end of a covering material of the motorized window treatment. The procedure 1350 may be executed by a control circuit of a motor drive unit of the motorized window treatment (e.g., the control circuit 1020 of the motor drive unit 1010 shown in FIG. 31 and/or control circuits of the motor drive units of the motorized window treatments shown in FIGS. 1-31). The motor drive unit may be configured to control a present position P_{PRES} of the covering material. The motor drive unit may comprise a dock (e.g., the docks 280, 380, 480, 580, 680, 780, 880) that is configured to facilitate discharging of one or more energy storage elements of the bottom bar into one or more energy storage elements of the motor drive unit, for example, when the bottom bar is located adjacent to the dock (e.g., when the covering material is in the raised position P_{RAISED}). For example, the control circuit may execute the procedure 1350 periodically at 1360 to determine if a docking interval should be increased or decreased. The docking interval may indicate a scheduled time or interval of time at the conclusion of which the control circuit is configured to dock the bottom bar. In some examples, the docking interval may indicate the beginning of a docking window during which the window treatment may dock. The docking interval may be configured by the user and/or stored in memory of the motorized window treatment. The docking interval could be set to end on a periodic basis, such as at a particular time every day (e.g., every night at 3:00 am). The procedure 1350 may be used in embodiments where the there is no wireless communication between the motor drive unit and bottom bar, and docking is performed at a scheduled time (e.g., according to the docking interval). The procedure 1350 may be implemented to ensure that the energy storage elements of the bottom bar and/or of the motor drive unit do not overcharge (e.g., to extend the life of the energy storage elements).

At 1362, the control circuit of the motor drive unit may be configured to determine whether it is the end of the docking interval based on a timeclock (e.g., whether it is time for the control circuit to dock the bottom bar). In some examples, the control circuit may consider other factors when determining whether to dock the bottom bar (e.g., as described with reference to FIGS. 33 and 34A). If the control circuit determines that it is not the end of the docking interval, the control circuit may return to 1362 and continue to monitor the timeclock to determine whether it is the end of the docking interval. If the control circuit determines that it is the end of the docking interval, the control circuit may control the motor drive circuit of the motor drive unit (e.g., the motor drive circuit 1012) to dock the bottom bar (e.g., to adjust the present position P_{PRES} of the covering material to the raised position P_{RAISED}) at 1366.

At 1366, the control circuit of the motor drive unit may be configured to determine if the bottom bar is docked. When the control circuit determines that the bottom bar is not docked at 1366, the control circuit may continue to control the motor drive circuit to move the covering material towards the raised position P_{RAISED} to dock the bottom bar at 1364. When the control circuit determines that the bottom bar is docked at 1366, the control circuit may transmit a query message at 1368 that includes the magnitude of the second storage voltage V_{S-B} generated across the energy storage element of the bottom bar. The control circuit may transmit the query message via a wired communication link (e.g., via the electrical connections 1038, 1048 and/or via separate electrical connections on the dock). At 1370, the control circuit may receive the storage level of the energy storage element of the bottom bar (e.g., the magnitude of the second storage voltage V_{S-B}).

At 1372, the control circuit may process the storage level of the energy storage element of the bottom bar to determine a trend of any change in the storage level over time. For example, the control circuit may determine whether the storage level of the energy storage element of the bottom bar is greater than or less than the storage level the last time the bottom bar docked. Further, the control circuit may be configured to determine whether a rolling average of the storage level of a predetermined number of previous storage level measurements is increasing or decreasing to, for example, determine whether the motor drive unit would benefit from more frequent or less frequent docking events.

At 1374, the control circuit may determine whether the determined trend of the storage level indicates that the motor drive unit would benefit from less frequent charging at 1374. As an example, the control circuit may determine that the trend indicates that the motor drive unit would benefit from less frequent charging when the trend indicates that the storage level is decreasing as compared to prior docking events (e.g., the trend is a “less charge” trend). Since the storage level is decreasing, the control circuit (e.g., the motor drive unit) is not receiving as much charge for each docking event as it could if it were to dock less frequently. As such, if the control circuit determines that the trend indicates that the motor drive unit would benefit from less frequent charging at 1374, the control circuit may increase the docking interval at 1376, and the procedure 1350 may exit at 1382.

If the control circuit determine that the trend does not indicate that the motor drive unit would benefit from less frequent charging at 1374, the control circuit may determine whether the trend indicates that the motor drive unit would benefit from more frequent charging at 1378. As an example, the control circuit may determine that the trend indicates that the motor drive unit would benefit from more frequent charging when the trend indicates that the storage level is increasing as compared to prior docking events (e.g., the trend is a “more charge” trend). Since the energy storage element of the bottom bar has a limit charge capacity and since the storage level is increasing, the control circuit (e.g., the motor drive unit) could be receiving charge more often if the bottom bar were to dock more frequently. As such, if the control circuit determines that the trend indicates that the motor drive unit would benefit from more frequent charging at 1378, the control circuit may decrease the docking interval at 1380, and the procedure 1350 may exit at 1382.

FIG. 35C is a flowchart of an example procedure 1390 for docking a bottom bar (e.g., the bottom bars 155, 240, 340, 440, 540, 640, 740, 840) of a motorized window treatment (e.g., the motorized window treatments of the embodiments shown in FIGS. 1-31). For example, the bottom bar may be connected to a bottom end of a covering material of the motorized window treatment. The procedure 1390 may be executed by a control circuit of a motor drive unit of the motorized window treatment (e.g., the control circuit 1020 of the motor drive unit 1010 shown in FIG. 31 and/or control circuits of the motor drive units of the motorized window treatments shown in FIGS. 1-31. The motor drive unit may be configured to control a present position P_{P}Es of the covering material. The motor drive unit may comprise a dock (e.g., the docks 280, 380, 480, 580, 680, 780, 880) that is configured to facilitate discharging of one or more energy storage elements of the bottom bar into one or more energy storage elements of the motor drive unit, for example, when the bottom bar is located adjacent to the dock (e.g., when the covering material is in the raised position P_{RAISED}). For example, the control circuit may execute the procedure 1390 periodically, at 1391, to determine if a docking interval should be increased or decreased. The docking interval may indicate a scheduled time or interval of time at the conclusion of which the control circuit is configured to dock the bottom bar (e.g., during the procedure 1210 of FIG. 34B and/or the procedure 1350 of FIG. 35B). The docking interval may be configured by the user and/or stored in memory of the motorized window treatment. The docking interval could be set to end on a periodic basis, such as at a particular time every day (e.g., every night at 3:00 am). The procedure 1390 may be used in embodiments where the there is no wireless communication between the motor drive unit and hembar, and docking is performed at a scheduled time (e.g., according to the docking interval).

The procedure 1390 may begin at 1391, At 1392, the control circuit may measure a photosensor signal. As described herein, the motor drive unit may include a photosensor circuit (e.g., the sensor circuit 1054) coupled to the control circuit. For example, the photosensor circuit may be configured to generate a signal that indicates an ambient light level L_{AMB} in the space in which the motorized window treatment is located. The control circuit of the bottom bar module may be configured to transmit a message including the ambient light level L_{AMB} indicated by the sensor circuit to the motor drive unit (e.g., when docked). At 1393, the control circuit may be configured to determine an average amount of ambient light measurement by the photosensor circuit. For example, the control circuit may determine an average, a rolling average, etc.

At 1394, the control circuit may determine whether the trend indicates that the bottom bar (e.g., the solar cells coupled to the bottom bar) is exposed to less sunlight than before. As an example, the control circuit may determine that the trend indicates that the bottom bar is exposed to more sunlight when the average of the ambient light measurement of the photosensor circuit is increasing over time, and that the trend indicates that the bottom bar is exposed to less sunlight when the average of the ambient light measurement of the photosensor circuit is decreasing over time. If the control circuit determines that the trend indicates that the bottom bar is exposed to less sunlight at 1394, the control circuit may increase the docking interval at 1395, and the procedure 1390 may exit.

If the control circuit determines that the trend does not indicate that the bottom bar is exposed to less sunlight at 1394, the control circuit may determine whether the trend indicates that the bottom bar is exposed to more sunlight at 1396. If the control circuit determines that the trend indicates that the bottom bar is not exposed to more sunlight at 1396 (e.g., the trend has not changed), the procedure 1390 may exit. If the control circuit determines that the trend indicates that the bottom bar is exposed to more sunlight at 1396, the control circuit may decrease the docking interval at 1395, and the procedure 1390 may exit. Accordingly, the control circuit may determine that the trend indicates that the bottom bar would benefit from less frequent docking when the trend indicates that the bottom bar is exposed to less sunlight than before (e.g., the trend is a “less daylight” trend). Since the solar cells of the bottom bar may be receiving less sunlight, the control circuit may control the bottom bar to dock less frequently. Conversely, the control circuit may determine that the trend indicates that the bottom bar would benefit from more frequent docking when the trend indicates that the bottom bar is exposed to more sunlight than before (e.g., the trend is a “more daylight” trend). Since the solar cells of the bottom bar may be receiving more sunlight, the control circuit may control the bottom bar to dock more frequently.

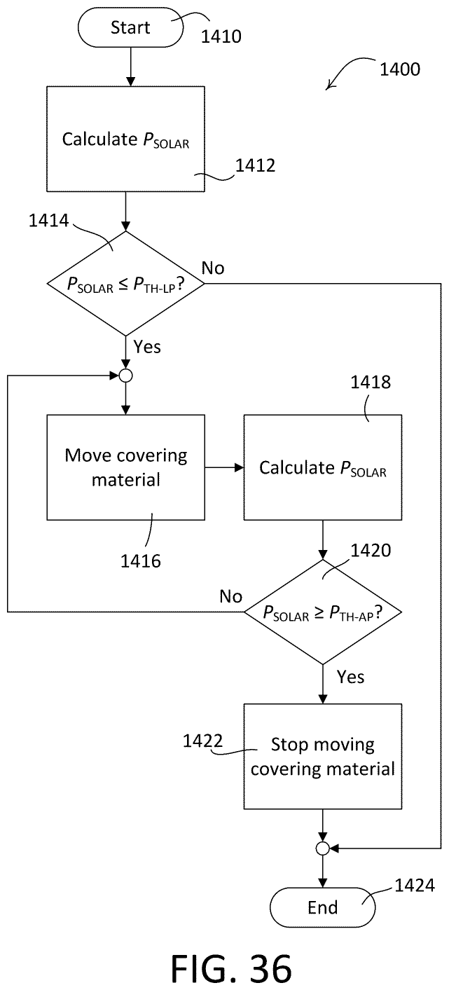

FIG. 36 is a flowchart of an example procedure 1400 for adjusting a present position P_{PRES} of a covering material of a motorized window treatment (e.g., the motorized window treatments of the embodiments shown in FIGS. 1-31) in response to a solar power P_{SOLAR} being received by one or more solar cells (e.g., the solar cells 270, 370, 470, 570a, 570b, 570c) of the motorized window treatment. For example, the solar cells may be located on a bottom bar (e.g., the bottom bar module 1040) of the motorized window treatment, and the bottom bar may be connected to a bottom end of the covering material of the motorized window treatment. The bottom bar may comprise a bottom bar module having a solar cell management circuit configured to charge an energy storage element of the bottom bar (e.g., the energy storage element 1046). The procedure 1400 may be executed by a control circuit of a motor drive unit of the motorized window treatment (e.g., the control circuit 1020 of the motor drive unit 1010 shown in FIG. 31 and/or control circuits of the motor drive units of the motorized window treatments shown in FIGS. 1-31). For example, the control circuit may execute the procedure 1400 periodically at 1410 to monitor the solar power P_{SOLAR} being received by one or more solar cells.

At 1412, the control circuit may be configured to calculate the solar power P_{SOLAR} being received by one or more solar cells. For example, the control circuit may be configured to calculate the solar power P_{SOLAR} as a function of a magnitude of a photovoltaic output voltage V_{PV} of the one or more solar cells, a magnitude of a storage voltage of an energy storage element of the bottom bar (e.g., the second storage voltage V_{S-B}), and/or a duty cycle DC_{SCM} of the solar cell management circuit of the bottom bar (e.g., which may be received in one or more message from the bottom bar module). At 1414, the control circuit may determine if the magnitude of the solar power P_{SOLAR} is less than (e.g., less than or equal to) a low-power threshold P_{TH-LP}. When the magnitude of the solar power P_{SOLAR} is greater than the low-power threshold P_{TH-LP} at 1414, the procedure 1400 may end at 1424.

When the magnitude of the solar power P_{SOLAR} is less than (e.g., less than or equal to) the low-power threshold P_{TH-LP} at 1414, the control circuit may start moving the covering material at 1416 to adjust the present position P_{PRES} of the covering material. For example, the control circuit may be configured to adjust the present position P_{PRES} of the covering material in a direction (e.g., either raise or lower) that may move the bottom bar into direct sunlight, which may be determined from the solar data. At 1418, the control circuit may be configured to calculate the solar power P_{SOLAR} being received by one or more solar cells at the new present position P_{PRES} of the covering material (e.g., an adjusted position of the covering material as compared to when the solar power P_{SOLAR} was calculated at 1412). At 1420, the control circuit may determine if the magnitude of the solar power P_{SOLAR} is greater than (e.g., greater than or equal to) an acceptable-power threshold P_{TH-AP}. When the magnitude of the solar power P_{SOLAR} is less than the acceptable-power threshold P_{TH-AP} at 1420, the control circuit may continue to move the covering material at 1416 to adjust the present position P_{PRES} of the covering material and to calculate the solar power P_{SOLAR} being received by one or more solar cells at 1418. When the magnitude of the solar power P_{SOLAR} is greater than (e.g., greater than or equal to) the acceptable-power threshold P_{TH-AP} at 1420, the control circuit may stop moving the covering material at 1422 and the procedure 1400 may end at 1424.

While the motor drive unit (e.g., the motor drive unit 250, 350, 450, 460, 750) having the dock (e.g., the docks 280, 380, 480, 580, 680, 780, 880 shown in FIGS. 1-31) has been shown with the bottom bar having solar cells, the motor drive unit could also be used with motorized window treatments without solar cells in order to charge an energy storage element (e.g., the energy storage element 1046) in the bottom bar (e.g., in the bottom bar module 1040), rather than charging an energy storage element (e.g., the energy storage element 1030) in the motor drive unit from solar energy collected by one or more solar cells, for example, as described herein. In such a system, the bottom bar may not have any solar cells (e.g., the bottom bar module 1040 may simply include the control circuit 1050, the communication circuit 1052, and/or the sensor circuits 1054). For example, the motor drive unit may be configured to dock the bottom bar to charge the energy storage element of the bottom bar from the energy storage element of the motor drive unit. The control circuit 1050 of the bottom bar module 1040 may be configured to collect data from the sensor circuits 1054 and report the data to the motor drive unit 1010. For example, the control circuit 1050 of the bottom bar module 1040 may be configured to collect solar data from a photosensor of the sensor circuits 1054 and report the solar data to the motor drive unit 1010.

What is claimed is:

1. A motorized window treatment configured to be mounted to a structure, the motorized window treatment comprising:
at least one solar cell;
a mounting bracket configured to be mounted to the structure;
a window treatment assembly supported by the mounting bracket, the window treatment assembly comprising a covering material that extends from a top end to a bottom end and is operable between a raised position and a lowered position, the window treatment assembly further comprising a bottom bar attached to the bottom end of the covering material, the bottom bar comprising a first energy storage element electrically coupled to the solar cell;
a motor drive unit comprising a motor configured to adjust the covering material between the raised position and the lowered position; and
a dock configured to be electrically coupled to the motor drive unit, the dock supported by the mounting bracket;
wherein the bottom bar is configured to be positioned adjacent to the dock when the covering material is in the raised position, such that the first energy storage element of the bottom bar is configured to discharge through the dock into a second energy storage element that is configured to power the motor drive unit.

2. The motorized window treatment of claim 1, wherein the mounting bracket comprises two or more electrical contacts configured to electrically connect the motor drive unit to the dock.

3. The motorized window treatment of claim 2, wherein the mounting bracket comprises the dock, and wherein the at least one solar cell is attached to the bottom bar.

4. The motorized window treatment of claim 1, wherein the dock comprises first and second electrical contacts and the bottom bar comprises first and second electrical contacts, the first and second electrical contacts of the dock configured to be electrically connected to the first and second electrical contacts of the bottom bar, respectively, when the covering material is in the raised position.

5. The motorized window treatment of claim 4, wherein the motor drive unit comprises first and second electrical contacts, wherein the first electrical contact of the dock comprises a first end comprising a first hook and a second end comprising a first clip, and wherein the second electrical contact of the dock comprises a first end comprising a second hook and a second end comprising a second clip;
wherein the hook of the first electrical contact of the dock is configured to be electrically connected to the first electrical contact of the bottom bar when the covering material is in the raised position, and the hook of the second electrical contact of the dock is configured to be electrically connected to the second electrical contact of the bottom bar when the covering material is in the raised position; and
wherein the first clip of the first electrical contact of the dock is configured to be electrically connected to the first electrical contact of the motor drive unit, and the second clip of the second electrical contact of the dock is configured to be electrically connected to the second electrical contact of the motor drive unit.

6. The motorized window treatment of claim 5, wherein the motor drive unit comprises a printed circuit board comprising the first and second electrical contacts, wherein the first electrical contact of the motor drive unit comprises a first electrical pad and the second electrical contact of the motor drive unit comprises a second electrical pad, and wherein the first clip of the first electrical contact of the dock is configured to be electrically connected to the first electrical pad of the motor drive unit, and the second clip of the second electrical contact of the dock is configured to be electrically connected to the second electrical pad of the motor drive unit.

7. The motorized window treatment of claim 4, wherein the dock comprises a first and second electrical contacts and the bottom bar comprises an end cap comprising first and second electrical contacts that are electrically connected to the first energy storage element, wherein the first and second electrical contacts of the dock are configured to be electrically connected to the first and second electrical contacts of the bottom bar when the covering material is in the raised position.

8. The motorized window treatment of claim 7, wherein the end cap comprises an inner edge and an outer edge, and wherein the first electrical contact of the end cap extends at least partially around the inner edge of the end cap and the second electrical contact of the end cap extends at least partially around the outer edge of the end cap.

9. The motorized window treatment of claim 8, wherein the inner edge of the end cap and the outer edge of the end cap remain exposed outside of a housing of the end cap when the end cap is installed at a first end of the bottom bar.

10. The motorized window treatment of claim 7, wherein the motor drive unit comprises first and second electrical contacts, wherein the first and second electrical contacts of the dock each comprises a respective first end comprising a hook and a respective second end comprising a clip;
wherein the hook of the first electrical contact of the dock is configured to be electrically connected to the first electrical contact of the bottom bar when the covering material is in the raised position, and the hook of the second electrical contact of the dock is configured to be electrically connected to the second electrical contact of the bottom bar when the covering material is in the raised position

11. The motorized window treatment of claim 1, wherein the bottom bar comprises a pocket, wherein the dock comprises a base portion that is configured to be disposed in the pocket and to be electrically coupled to the bottom bar when disposed in the pocket.

12. The motorized window treatment of claim 11, wherein the base portion comprises a face, wherein the dock comprises first and second electrical contacts located on the face. and the pocket comprises a wall, wherein the bottom bar comprises first and second electrical contacts located on the wall, and wherein the first and second electrical contacts of the dock are configured to be electrically coupled to the first and second electrical contacts of the bottom bar when the base portion is disposed in the pocket.

13. The motorized window treatment of claim 12, wherein the face comprises a flange portion that is tapered and the pocket comprises a guiding member configured to contact the flange portion and guide a contact surface of the base portion toward the wall.

14. The motorized window treatment of claim 13, wherein the guiding member has a first width, wherein a body of the base portion comprises an offset portion substantially perpendicular to the contact surface, the offset portion having a second width, wherein the first width is larger than the second width.

15. The motorized window treatment of claim 12, wherein the first and second electrical contacts of the bottom bar are electrically connected to the first energy storage element, and wherein the first and second electrical contacts of the bottom bar are configured to be electrically connected to the first and second electrical contacts of the dock when the covering material is in the raised position.

16. The motorized window treatment of claim 11, wherein the dock comprises an arm that extends from the mounting bracket, and wherein the base portion comprises a face and an offset portion, wherein the offset portion offsets the face from the arm of the dock.

17. The motorized window treatment of claim 16, wherein the base portion is configured to be adjustably coupled to the arm via one or more fasteners.

18. The motorized window treatment of claim 17, wherein the arm of the dock comprises a slot, and wherein the base portion is configured to be coupled to the arm when the one or more fasteners are disposed in the slot.

19. The motorized window treatment of claim 18, wherein a position of the base portion of the dock is configured to adjusted along the arm via the slot.

20. The motorized window treatment of claim 1, wherein the bottom bar comprises a plurality of support members, wherein the dock comprises a plurality of slots, each of the plurality of support members configured to be disposed in a slot of the plurality of slots, and the bottom bar configured to be electrically coupled to the dock when each of the plurality of support members is disposed in a respective slot of the plurality of slots.

21. The motorized window treatment of claim 20, wherein the dock comprises a plurality of first electrical contacts, each electrical contact of the plurality of first electrical contacts disposed in at least one of the plurality of slots, wherein the bottom bar comprises a plurality of second electrical contacts, wherein each support member of the plurality of support members comprises a second electrical contact of the plurality of second electrical contacts, each of the plurality of first electrical contacts configured to be electrically coupled to a respective second electrical contact of the plurality of second electrical contacts when the covering material is in the raised position.

22. The motorized window treatment of claim 21, wherein each of the plurality of first electrical contacts comprises a partial loop.

23. The motorized window treatment of claim 21, wherein the plurality of first electrical contacts of the dock are biased outward away from a front surface of an arm of the dock.

24. The motorized window treatment of claim 21, wherein the plurality of first electrical contacts of the dock are biased towards a rear surface of a base portion of the dock.

25. The motorized window treatment of claim 21, wherein a first support member of the plurality of support members is comprised in an end cap of the bottom bar, and wherein one or more of the plurality of second electrical contacts is comprised in the end cap of the bottom bar.

26. The motorized window treatment of claim 25, wherein each of the plurality of slots is at least partially defined by a flange portion comprising a taper configured to contact a respective support member of the plurality of support members and guide the respective support member of the plurality of support members into a respective slot of the plurality of slots.

27. The motorized window treatment of claim 21, wherein the plurality of first electrical contacts comprises four electrical contacts, and the plurality of second electrical contacts comprises four electrical contacts.

28. The motorized window treatment of claim 21, wherein the bottom bar comprises a plurality of support members, and wherein the plurality of second electrical contacts of the bottom bar are located on the plurality of support members.

29. The motorized window treatment of claim 21, wherein the plurality of support members extend across a recess of a housing of the bottom bar.

30. The motorized window treatment of claim 1, further comprising a fastener, wherein the dock comprises a slot, and wherein the fastener is configured to be disposed in the slot, and wherein the dock is configured to move with respect to the mounting bracket and the fastener is configured to move within the slot.

31. The motorized window treatment of claim 1, wherein the dock comprises a first plurality of electrical contacts and the bottom bar comprises a second plurality of second electrical contacts, the first plurality of electrical contacts configured to be electrically connected to the second plurality of electrical contacts when the covering material is in the raised position.

32. The motorized window treatment of claim 31, wherein the dock comprises an arm and a base portion connected to the arm, and wherein the first plurality of electrical contacts are disposed on the arm.

33. The motorized window treatment of claim 32, wherein the bottom bar comprises an end cap comprising an inner edge, and wherein at least one of the second plurality of electrical contacts extends at least partially around the inner edge.

34. The motorized window treatment of claim 33, wherein the motor drive unit is configured to connect to the arm, wherein the first plurality of electrical contacts are disposed in a cavity of the arm, and wherein the first plurality of electrical contacts are configured to be electrically connected to the motor drive unit via a tunnel extending from the cavity to the motor drive unit.

35. The motorized window treatment of claim 31, wherein the dock comprises an arm and a base portion connected to the arm, and wherein the first plurality of electrical contacts are disposed on the base portion.

36. The motorized window treatment of claim 35, wherein the bottom bar comprises a housing comprising a first end and a second end, and wherein the second plurality of electrical contacts are disposed on the housing.

37. The motorized window treatment of claim 36, wherein the motor drive unit is configured to connect to the arm, wherein the first plurality of electrical contacts are disposed in a cavity of the base portion, and wherein the first plurality of electrical contacts are configured to be electrically connected to the motor drive unit via a tunnel extending from the cavity to the motor drive unit.

38. The motorized window treatment of claim 37, wherein the base portion comprises a base cover, and wherein the cavity is disposed in the base cover.

39. The motorized window treatment of claim 35, wherein the first plurality of electrical contacts are disposed on a face of the base portion.

40. The motorized window treatment of claim 39, wherein the base portion comprises an arm that extends from the mounting bracket and an offset portion, wherein the face is offset from a front surface of the arm by the offset portion.

41. A bracket for supporting a motorized window treatment, the motorized window treatment comprising a window treatment assembly having a covering material and a bottom bar at a bottom end of the covering material, the window treatment assembly further comprising a motor drive unit, the bracket comprising:
an attachment member configured to support an end portion of the motor drive unit of the window treatment assembly of the motorized window treatment; and
a dock comprising a first pair of electrical contacts configured to be electrically coupled to a second pair of electrical contacts of the bottom bar of the window treatment assembly;
wherein the first pair of electrical contacts of the dock are configured to be electrically connected to the motor drive unit when the end portion of the motor drive unit is supported by the attachment member of the bracket.

42. The bracket of claim 41, wherein a first electrical contact of the first pair of electrical contacts is configured to deliver power from the bottom bar to the motor drive unit, and wherein a second electrical contact of the first pair of electrical contacts is configured to enable communication between the bottom bar and the motor drive unit.

43. The bracket of claim 41, wherein the dock comprises an arm and a base connected to the arm, and wherein the first pair of electrical contacts are disposed on the arm.

44. The bracket of claim 43, wherein the attachment member is configured to extend from the bracket, wherein the first pair of electrical contacts are disposed within the attachment member, and wherein the first pair of electrical contacts are configured to be electrically connected to the motor drive unit via one or more channels extending through the bracket.

45. The bracket of claim 42, wherein the dock comprises an arm extending from the bracket and a base portion connected to the arm, and wherein the first pair of electrical contacts are disposed on the base portion.

46. The bracket of claim 42, wherein the attachment member is configured to extend from the bracket, wherein the first pair of electrical contacts are disposed within the attachment member, and wherein one or more channels extending through the bracket that enable the first pair of electrical contacts to be electrically connected to the motor drive unit.

47. The bracket of claim 41, wherein the dock comprises first and second electrical contacts and the bottom bar comprises first and second electrical contacts, the first and second electrical contacts of the dock configured to be electrically connected to the first and second electrical contacts of the bottom bar, respectively, when the covering material is in a raised position.

48. The bracket of claim 47, wherein the motor drive unit comprises first and second electrical contacts, wherein the first electrical contact of the dock comprises a first end comprising a first hook and a second end comprising a first clip, and wherein the second electrical contact of the dock comprises a first end comprising a second hook and a second end comprising a second clip;
wherein the hook of the first electrical contact of the dock is configured to be electrically connected to the first electrical contact of the bottom bar when the covering material is in the raised position, and the hook of the second electrical contact of the dock is configured to be electrically connected to the second electrical contact of the bottom bar when the covering material is in the raised position; and
wherein the first clip of the first electrical contact of the dock is configured to be electrically connected to the first electrical contact of the motor drive unit, and the second clip of the second electrical contact of the dock is configured to be electrically connected to the second electrical contact of the motor drive unit.

49. The bracket of claim 47, wherein the dock comprises a first and second electrical contacts and the bottom bar comprises an end cap comprising a first and second electrical contacts that are electrically connected to an energy storage element of the bottom bar, wherein the first and second electrical contacts of the dock are configured to be electrically connected to the first and second electrical contacts of the bottom bar when the covering material is in the raised position.

50. The bracket of claim 41, wherein the bottom bar comprises a pocket, wherein the dock comprises a base portion that is configured to be disposed in the pocket and to be electrically coupled to the bottom bar when disposed in the pocket.

51. The bracket of claim 41, wherein the bottom bar comprises a plurality of support members, wherein the dock comprises a plurality of slots, each of the plurality of support members configured to be disposed in a slot of the plurality of slots, and the bottom bar configured to be electrically coupled to the dock when each of the plurality of support members is disposed in a respective slot of the plurality of slots.

52. The bracket of claim 41, wherein the dock comprises an arm and a base portion connected to the arm, and wherein the first pair of electrical contacts are disposed on the base portion.

53. The bracket of claim 52, wherein the first pair of electrical contacts are disposed on a face of the base portion.

54. The bracket of claim 53, wherein the base portion comprises an arm that extends from the first mounting bracket and an offset portion, wherein the face is offset from a front surface of the arm by the offset portion.

55. A motorized window treatment configured to be mounted to a structure, the motorized window treatment comprising:
first mounting bracket configured to be mounted to the structure; and
a window treatment assembly supported by the first mounting bracket, the window treatment assembly comprising a covering material that extends from a top end to a bottom end and is operable between a raised position and a lowered position, the window treatment assembly further comprising a bottom bar attached to the bottom end of the covering material, the bottom bar comprising a housing comprising a first end and a second end, an end cap located at the first end of the housing, and a first pair of electrical contacts disposed on the end cap at the first end of the housing; and
a motor drive unit comprising a motor configured to adjust the covering material between the raised position and the lowered position; and
a dock supported by the first mounting bracket, the dock comprising a second pair of electrical contacts configured to be electrically connected to the first pair of electrical contacts of the bottom bar when the covering material is in the raised position.

56. The motorized window treatment of claim 55, wherein the bottom bar comprises a first energy storage element, and wherein the bottom bar is configured to be positioned adjacent to the dock when the covering material is in the raised position, such that the first pair of electrical contacts of the bottom bar are electrically connected to the second pair of electrical contacts of the dock and the first energy storage element of the bottom bar is configured to discharge through the dock into a second energy storage element that is configured to power the motor drive unit.

57. The motorized window treatment of claim 55, wherein the dock comprises a base portion and an arm that extends from the baes portion, and wherein the second pair of electrical contacts is located on the base portion.

58. The motorized window treatment of claim 55, wherein the end cap comprises an inner edge and an outer edge, and wherein a first one of the second pair electrical contacts extends at least partially around the inner edge of the end cap and a second one of the second pair of electrical contacts extends at least partially around the outer edge of the end cap.

59. The motorized window treatment of claim 55, wherein the dock is integral with the first mounting bracket.

60. The motorized window treatment of claim 55, wherein the dock comprises a base portion and an arm that extends perpendicular to the arm, and wherein the first pair of electrical contacts are disposed on the arm or the base portion.

61. A motorized window treatment configured to be mounted to a structure, the motorized window treatment comprising:
first and mounting brackets configured to be mounted to the structure; and
a window treatment assembly supported by the first and second mounting bracket, the window treatment assembly comprising a covering material that extends from a top end to a bottom end and is operable between a raised position and a lowered position, the window treatment assembly further comprising a bottom bar attached to the bottom end of the covering material;
a motor drive unit comprising a motor configured to adjust the covering material between the raised position and the lowered position; and
a dock having a base portion comprising electrical contacts configured to be electrically coupled to the motor drive unit, the base portion configured to move with respect to the first mounting bracket;
wherein the bottom bar is configured to be positioned adjacent to the base portion of the dock when the covering material is in the raised position.

62. The motorized window treatment of claim 61, wherein the window treatment assembly comprises a fastener, wherein the dock comprises an arm having a slot, and wherein the fastener is configured to be disposed in the slot such that the base is configured to move with respect to the first mounting bracket via the slot.

63. The motorized window treatment of claim 61, wherein the bottom bar comprises a first energy storage element, and wherein the bottom bar is configured to be positioned adjacent to the base portion when the covering material is in the raised position, such that the first energy storage element of the bottom bar is configured to discharge through the dock into a second energy storage element that is configured to power the motor drive unit.

64. A motorized window treatment configured to be mounted to a structure, the motorized window treatment comprising:
at least one solar cell;
a window treatment assembly comprising a covering material that extends from a top end to a bottom end and is operable between a raised position and a lowered position, the window treatment assembly further comprising a bottom bar attached to the bottom end of the covering material, the bottom bar comprising a first energy storage element electrically coupled to the solar cell, and wherein the bottom bar comprises a first electrical contact and a second electrical contact that are electrically connected to the first energy storage element;
a motor drive unit comprising first and second electrical contacts and a motor, wherein the motor is configured to adjust the covering material between the raised position and the lowered position;
a second energy storage element configured to power the motor; and
a dock configured to be electrically coupled to the motor drive unit, wherein the dock comprises first and second electrical contacts, wherein the first electrical contact of the dock comprises a first end comprising a first hook and a second end comprising a first clip, and wherein the second electrical contact of the dock comprises a first end comprising a second hook and a second end comprising a second clip;
wherein the first clip of the first electrical contact of the dock is configured to be electrically connected to the first electrical contact of the motor drive unit, and the second clip of the second electrical contact of the dock is configured to be electrically connected to the second electrical contact of the motor drive unit; and
wherein the hook of the first electrical contact of the dock is configured to be electrically connected to the first electrical contact of the bottom bar when the covering material is in the raised position, and the hook of the second electrical contact of the dock is configured to be electrically connected to the second electrical contact of the bottom bar when the covering material is in the raised position, such that the first energy storage element of the bottom bar is configured to discharge through the dock into the second energy storage element.

65. The motorized window treatment of claim 64, wherein the motor drive unit comprises a printed circuit board comprising the first and second electrical contacts, wherein the first electrical contact comprises a first electrical pad and the second electrical contact comprises a second electrical pad, and wherein the first clip of the first electrical contact of the dock is configured to be electrically connected to the first electrical pad of the motor drive unit, and the second clip of the second electrical contact of the dock is configured to be electrically connected to the second electrical pad of the motor drive unit.

66. The motorized window treatment of claim 64, wherein the bottom bar comprises an end cap comprising the first and second electrical contacts that are electrically connected to the first energy storage element, and wherein the at least one solar cell is attached to the bottom bar.

67. The motorized window treatment of claim 66, wherein the end cap comprises an inner edge and an outer edge, and wherein the first electrical contact of the end cap extends at least partially around the inner edge of the end cap and the second electrical contact of the end cap extends at least partially around the outer edge of the end cap.

68. The motorized window treatment of claim 67, wherein the inner edge of the end cap and the outer edge of the end cap remain exposed outside of a housing of the end cap when the end cap is installed at a first end of the bottom bar.

69. A motorized window treatment configured to be mounted to a structure, the motorized window treatment comprising:
at least one solar cell;
a window treatment assembly comprising a covering material that extends from a top end to a bottom end and is operable between a raised position and a lowered position, the window treatment assembly further comprising a bottom bar attached to the bottom end of the covering material, the bottom bar comprising a first energy storage element electrically coupled to the solar cell;
a motor drive unit comprising a motor configured to adjust the covering material between the raised position and the lowered position; and
a dock configured to be electrically coupled to the motor drive unit;
wherein the bottom bar comprises a pocket, wherein the dock comprises a base portion that is configured to be disposed in the pocket, and wherein the base portion is configured to be electrically coupled to the bottom bar when the base portion is disposed in the pocket, such that the first energy storage element of the bottom bar is configured to discharge through the dock into a second energy storage element that is configured to power the motor drive unit.

70. The motorized window treatment of claim 69, wherein the base portion comprises a face, wherein the dock comprises a first and second electrical contacts located on the face, and the pocket comprises a wall, wherein the bottom bar comprises first and second electrical contacts located on the wall, and wherein the first and second electrical contacts on the face of the dock are configured to be electrically coupled to the first and second electrical contacts on the wall of the bottom bar when the base portion is disposed in the pocket.

71. The motorized window treatment of claim 70, wherein the face comprises a flange portion that is tapered and the pocket comprises a guiding member configured to contact the flange portion and guide a contact surface of the base portion toward the wall as the base portion is disposed in the pocket.

72. The motorized window treatment of claim 71, wherein the guiding member has a first width, wherein a body of the base portion comprises an offset portion substantially perpendicular to the contact surface, the offset portion having a second width, wherein the first width is larger than the second width.

73. The motorized window treatment of claim 70, wherein the first and second electrical contacts of the bottom bar are electrically connected to the first energy storage element, and wherein the first and second electrical contacts of the bottom bar are configured to be electrically connected to the first and second electrical contacts of the dock when the covering material is in the raised position.

74. The motorized window treatment of claim 69, wherein the dock comprises an arm configured to extends from a mounting bracket configured to support the window treatment assembly, and wherein the base portion comprises a face and an offset portion, wherein the offset portion offsets the face from the arm of the dock.

75. The motorized window treatment of claim 74, wherein the base portion is configured to be adjustably coupled to the arm via one or more fasteners to align the base portion with bottom bar.

76. The motorized window treatment of claim 75, wherein the arm of the dock comprises a slot, and wherein the base portion is configured to be coupled to the arm when the fastener is disposed in the slot.

77. The motorized window treatment of claim 76, wherein a position of the base portion of the dock is configured to adjusted along the arm via the slot.

78. The motorized window treatment of claim 69, wherein the dock configured to be electrically coupled to the motor drive unit via the second energy storage element.

79. A motorized window treatment configured to be mounted to a structure, the motorized window treatment comprising:
at least one solar cell;
a window treatment assembly comprising a covering material that extends from a top end to a bottom end and is operable between a raised position and a lowered position, the window treatment assembly further comprising a bottom bar attached to the bottom end of the covering material, the bottom bar comprising a first energy storage element electrically coupled to the solar cell;
a motor drive unit comprising a motor configured to adjust the covering material between the raised position and the lowered position; and
a dock configured to be electrically coupled to the motor drive unit; and
wherein the bottom bar comprises a plurality of support members, wherein the dock comprises a plurality of slots, each of the plurality of support members configured to be disposed in a slot of the plurality of slots, and wherein the bottom bar configured to be electrically coupled to the dock when each of the plurality of support members is disposed in a respective slot of the plurality of slots, such that the first energy storage element of the bottom bar is configured to discharge through the dock into a second energy storage element configured to power the motor drive unit.

80. The motorized window treatment of claim 79, wherein the dock comprises a plurality of first electrical contacts, each electrical contact of the plurality of first electrical contacts disposed in at least one of the plurality of slots, wherein the bottom bar comprises a plurality of second electrical contacts, wherein each support member of the plurality of support members comprises at least one of the second electrical contacts of the plurality of second electrical contacts, each of the plurality of first electrical contacts configured to be electrically coupled to a respective second electrical contact of the plurality of second electrical contacts when the covering material is in the raised position.

81. The motorized window treatment of claim 80, wherein each of the plurality of first electrical contacts comprises a partial loop.

82. The motorized window treatment of claim 80, wherein the plurality of first electrical contacts of the dock are biased outward away from the dock.

83. The motorized window treatment of claim 80, wherein the plurality of first electrical contacts of the dock are biased towards a rear surface of a base portion of the dock.

84. The motorized window treatment of claim 80, wherein a first support member of the plurality of support members is comprised in an end cap of the bottom bar, and wherein one or more of the plurality of second electrical contacts is comprised in the end cap of the bottom bar.

85. The motorized window treatment of claim 84, wherein each of the plurality of slots is at least partially defined by a flange portion comprising a taper configured to contact a respective support member of the plurality of support members and guide the support member of the plurality of support members into a respective slot of the plurality of slots.

86. The motorized window treatment of claim 80, wherein the plurality of first electrical contacts comprises four electrical contacts, and the plurality of second electrical contacts comprises four electrical contacts.

87. The motorized window treatment of claim 80, wherein the bottom bar comprises a plurality of support members, and wherein the plurality of second electrical contacts of the bottom bar are located on the plurality of support members.

88. The motorized window treatment of claim 80, wherein the plurality of support members that extend across a recess of a housing of the bottom bar.

89. The motorized window treatment of claim 79, wherein the dock configured to be electrically coupled to the motor drive unit via the second energy storage element.

90. The motorized window treatment of claim 79, wherein the dock is configured to be adjustable relative to the structure to align the base portion with bottom bar.

91. A motorized window treatment configured to be mounted to a structure, the motorized window treatment comprising:
at least one solar cell;
a window treatment assembly comprising a covering material that extends from a top end to a bottom end and is operable between a raised position and a lowered position, the window treatment assembly further comprising a bottom bar attached to the bottom end of the covering material, the bottom bar comprising a first energy storage element electrically coupled to the solar cell;
a motor drive unit comprising a motor configured to adjust the covering material between the raised position and the lowered position;
a dock comprising a slot, wherein the dock is configured to be electrically coupled to the motor drive unit; and
a fastener configured to be disposed in the slot, and wherein the dock is configured to move with respect to a mounting bracket and the fastener is configured to move within the slot; and
wherein the bottom bar is configured to be positioned adjacent to the dock when the covering material is in the raised position, such that the first energy storage element of the bottom bar is configured to discharge through the dock into a second energy storage element configured to power the motor drive unit; and
wherein the dock being configured to move align the bottom bar with dock as the dock is raised.

92. The motorized window treatment of claim 91, wherein the dock comprises a first plurality of electrical contacts and the bottom bar comprises a second plurality of second electrical contacts, the first plurality of electrical contacts configured to be electrically connected to the second plurality of electrical contacts when the covering material is in the raised position.

93. The motorized window treatment of claim 91, wherein the dock configured to be electrically coupled to the motor drive unit via the second energy storage element.

94. A motorized window treatment configured to be mounted to a structure, the motorized window treatment comprising:
a bracket configured to be mounted to the structure, the bracket comprising an arm that extends from the structure;
at least one solar cell;
a window treatment assembly supported by the arm of the mounting bracket, the window treatment assembly comprising a covering material that extends from a top end to a bottom end and is operable between a raised position and a lowered position, the window treatment assembly further comprising a bottom bar attached to the bottom end of the covering material, the bottom bar comprising a first energy storage element electrically coupled to the solar cell;
a motor drive unit comprising a motor configured to adjust the covering material between the raised position and the lowered position; and
a dock located on the arm of the bracket and comprising a first plurality of electrical contacts disposed on the arm;
wherein the bottom bar comprises a second plurality of second electrical contacts, and wherein the first plurality of electrical contacts configured to be electrically connected to the second plurality of electrical contacts when the covering material is in the raised position, such that the first energy storage element of the bottom bar is configured to discharge through the dock into a second energy storage element configured to power the motor drive unit.

95. The motorized window treatment of claim 94, wherein the bottom bar comprises an end cap comprising an inner edge, and wherein at least one of the second plurality of electrical contacts extends at least partially around the inner edge.

96. The motorized window treatment of claim 95, wherein the motor drive unit is configured to be connected to the arm, wherein the first plurality of electrical contacts are disposed in a cavity of the arm, and wherein the first plurality of electrical contacts are configured to be electrically connected to the motor drive unit via a tunnel or channel or trench extending from the cavity to a location on the arm that is proximate the motor drive unit when the motor dive unit is connected to the arm.

97. A motorized window treatment configured to be mounted to a structure, the motorized window treatment comprising:
a bracket configured to be mounted to the structure, the bracket comprising an arm that extends from the structure and a base portion that extends at an angle from the arm;
first and second mounting brackets configured to be mounted to the structure;
at least one solar cell;
a window treatment assembly supported by the arm of the mounting bracket, the window treatment assembly comprising a covering material that extends from a top end to a bottom end and is operable between a raised position and a lowered position, the window treatment assembly further comprising a bottom bar attached to the bottom end of the covering material, the bottom bar comprising a first energy storage element electrically coupled to the solar cell;
a motor drive unit comprising a motor configured to adjust the covering material between the raised position and the lowered position; and
a dock located on the base of the bracket and comprising a first plurality of electrical contacts disposed on the base portion;
wherein the bottom bar comprises a second plurality of second electrical contacts, and wherein the first plurality of electrical contacts configured to be electrically connected to the second plurality of electrical contacts when the covering material is in the raised position, such that the first energy storage element of the bottom bar is configured to discharge through the dock into a second energy storage element that is configured to power the motor drive unit.

98. The motorized window treatment of claim 97, wherein the bottom bar comprises a housing comprising a first end and a second end, and wherein the second plurality of electrical contacts are disposed on the housing.

99. The motorized window treatment of claim 98, wherein the motor drive unit is configured to be connected to the arm, wherein the first plurality of electrical contacts are disposed in a cavity of the base portion, and wherein the first plurality of electrical contacts are configured to be electrically connected to the motor drive unit via a tunnel or channel or trench extending from the cavity to a location on the arm proximate the motor drive unit when the motor drive unit is connected to the arm.

100. The motorized window treatment of claim 99, wherein the base portion comprises a base cover, and wherein the cavity is disposed in the base cover.

101. The motorized window treatment of claim 97, wherein the first plurality of electrical contacts are disposed on a face of the base portion.

102. The motorized window treatment of claim 101, wherein the base portion comprises an arm that extends from the first mounting bracket and an offset portion, wherein the face is offset from a front surface of the arm by the offset portion.

103. The motorized window treatment of claim 97, wherein the base portion is configured to mount the mounting bracket to the structure.
